(19) United States
(12) Patent Application Publication
(10) Pub. No.: US 2025/0206196 A1
(43) Pub. Date: Jun. 26, 2025

(54) SEAT MOUNTING STRUCTURE

(71) Applicant: TS TECH CO., LTD., Asaka-shi, Saitama (JP)

(72) Inventors: Akira MIYOSHI, Shioya-gun, Tochigi (JP); Tsukasa MEGURO, Shioya-gun, Tochigi (JP); Yoshihiro TOMITA, Shioya-gun, Tochigi (JP)

(21) Appl. No.: 18/847,120

(22) PCT Filed: Mar. 31, 2023
(86) PCT No.: PCT/JP2023/013667

§ 371 Date: Sep. 13, 2024

Related U.S. Application Data
(60) Provisional application No. 63/327,027, filed on Apr. 4, 2022.
(60) Provisional application No. 63/362,687, filed on Apr. 8, 2022.
(60) Provisional application No. 63/363,715, filed on Apr. 28, 2022.
(60) Provisional application No. 63/363,838, filed on Apr. 29, 2022.
(60) Provisional application No. 63/376,492, filed on Sep. 21, 2022.

(30) Foreign Application Priority Data
Mar. 22, 2023 (JP) 2023-045406
Mar. 28, 2023 (JP) 2023-052396
Mar. 28, 2023 (JP) 2023-052400
Mar. 28, 2023 (JP) 2023-052402

(51) Int. Cl. B60N 2/005; B60N 2/02; B60N 2/06; B60N 2/12; B60R 16/033; B62D 25/20

(52) U.S. Cl. CPC B60N 2/005; B60R 16/033; B62D 25/20; B60N 2/02246; B60N 2/067; B60N 2/12

(57) ABSTRACT

A seat mounting structure includes: right and left side sills; a central member; a plurality of cross members; a floor joined to the right and left side sills, a plurality of right battery connection parts joined to the right side sill; a plurality of left battery connection parts joined the left side sill; a plurality of central battery connection parts joined to the central member; a plurality of right batteries joined to the right battery connection parts and the central battery connection parts; a plurality of left batteries joined to the left battery connection parts and the central battery connection parts; and a seat mounted on an upper surface of the floor via a seat support part, wherein the seat support part is provided between the right battery connection parts and the central battery connection parts or between the left battery connection parts and the central battery connection parts.

### TECHNICAL FIELD

The present invention relates to a seat mounting structure.

### BACKGROUND ART

Patent Document 1 discloses a battery storage structure of an electric automobile. The batteries are accommodated in a battery frame. The battery frame is provided under the floor panel of the car and is joined to the side sills and the cross members.

Patent Document 2 discloses a structure for mounting a seat to the car body. A seat support part that supports the seat is connected to the floor member and side sills that extend in the front-rear direction in the car.

### PRIOR ART DOCUMENT(S)

### Patent Document(s)

Patent Document 1: JPH8-276752A
Patent Document 2: JPH4-81372A

### SUMMARY OF THE INVENTION

### Task to be Accomplished by the Invention

When it is attempted to install the battery storage structure of Patent Document 1 and the seat mounting structure of Patent Document 2 in a single car, the battery frame and the seat support part are both connected to the side sills. Therefore, it is necessary to avoid interference between the connection parts of the battery frame with the side sills and the connection parts of the seat support part with the side sills.

In view of the foregoing background, an object of the present invention is to provide a seat mounting structure which avoids interference between the battery connection parts and the seat support part.

### Means to Accomplish the Task

To achieve the above object, one aspect of the present invention provides a seat mounting structure, comprising: a right side sill (3A) and a left side sill (3B) that extend in a front-rear direction; a central member (4) extending in the front-rear direction between the right side sill and the left side sill; a plurality of cross members (7) provided to be spaced from each other in the front-rear direction and each extending laterally and joined to the central member, the right side sill, and the left side sill; a floor (9) provided on the central member and the plurality of cross members and joined to the right side sill and the left side sill; a plurality of right battery connection parts (23A) joined to the right side sill; a plurality of left battery connection parts (23B) joined to the left side sill; a plurality of central battery connection parts (23C) joined to the central member; a plurality of right batteries (12A) extending laterally and joined to the right battery connection parts and the central battery connection parts; the plurality of left batteries (12B) extending laterally and joined to the left battery connection parts and the central battery connection parts; and a seat (41) mounted on an upper surface of the floor via a seat support part (51), wherein the seat support part is provided between the right battery connection parts and the central battery connection parts or between the left battery connection parts and the central battery connection parts.

According to this aspect, the seat support part is provided between the right battery connection parts and the central battery connection parts or between the left battery connection parts and the central battery connection parts. Therefore, a seat mounting structure which avoids interference between the battery connection parts and the seat support part can be provided.

In the above aspect, preferably, the seat support part comprises a first rail (52) joined to the floor and a first slider (53) slidably supported by the first rail and joined to the seat, and the first rail crosses at least three of the cross members.

According to this aspect, the seat can be made slidable relative to the floor. Also, since the first rail is joined to the floor to cross three of the cross members, the first rail becomes hard to bend.

In the above aspect, preferably, the first rail is received in a recessed groove (11) provided on the floor and extending in the front-rear direction.

According to this aspect, arrangement of the first rail on the floor is easy.

In the above aspect, preferably, the floor comprises a lower floor panel (9B) extending along a bottom portion of the recessed groove and an upper floor panel (9A) extending along an upper portion of the recessed groove.

According to this aspect, the floor can have a double-floor structure. Also, since the upper floor panel extends along the upper portion of the recessed groove, it is possible to ensure a wide leg space for the occupant seated on the seat.

In the above aspect, preferably, at least one of left and right end portions of the seat is disposed above the plurality of right battery connection parts or the plurality of central battery connection parts.

According to this aspect, it is possible to provide a seat having a long length in the left-right direction.

In the above aspect, preferably, a front end portion of the seat support part is disposed more rearward than front end portions of the right batteries and the left batteries.

According to this aspect, the right batteries and the left batteries are arranged over a wide range.

In the above aspect, preferably, the right battery connection parts, the left battery connection parts, and the central battery connection parts comprise hooks (29) for supporting the right batteries and the left batteries.

According to this aspect, the right batteries and the left batteries can be supported by the hooks.

In the above aspect, preferably, an article (42) is mounted on the floor via a pair of article support parts (61), the pair of article support parts are respectively disposed on both sides of the plurality of central battery connection parts with respect to a left-right direction, and one of the article support parts is provided between the seat support part and the plurality of central battery connection parts with respect to the left-right direction.

According to this aspect, it is possible to provide article support parts for supporting the article. Also, interference between the battery connection parts and the article support parts can be avoided.

In the above aspect, preferably, the pair of article support parts each include a second rail (62) joined to the floor and a second slider (63) slidably supported by the second rail and joined to the article, and the second rail crosses at least three of the cross members.

According to this aspect, the article can be made slidable relative to the floor. Also, since the second rail is joined to the floor to cross three of the cross members, the second rail becomes hard to bend.

In the above aspect, preferably, each of front end portions of the pair of article support parts is disposed more rearward than front end portions of the right batteries and the left batteries.

According to this aspect, the right batteries and the left batteries are arranged over a wide range.

Patent Document 3 (JP2003-146120A) discloses a slide rail device for allowing two seats provided on the car to slidingly move forward and rearward. The slide rail device includes a rail extending on the floor of the car in the front-rear direction and a first slider and a second slider slidably provided on the rail. The first slider is movable from the front end portion to the central portion of the rail, while the second slider is movable from the rear end portion to the central portion of the rail. The first slider and the second slider each have a seat supported thereon.

The rail of the slide rail device in Patent Document 3 extends long in the front-rear direction of the car to support two seats on the floor. Therefore, the rail is easier to bend in a lap portion which corresponds to a region in which the movable range of the first slider and the movable range of the second slider overlap than in the both end portions thereof. Consequently, there is a problem that the first slider and the second slider cannot slidingly move in the lap portion smoothly.

In view of the foregoing background, an object of the present invention is to provide a slide rail device in which the first slider and the second slider can slidingly move in the lap portion smoothly.

To achieve the above object, one aspect of the present invention provides a slide rail device (110), comprising: a rail (111); a first slider (112) slidably provided on the rail and supporting a first seat (102); and a second slider (112) slidably provided on the rail and supporting a second seat (102), wherein the rail has a lap portion (111B) which corresponds to a lap region (LR) in which a movable range (R1) of the first slider and a movable range (R2) of the second slider overlap, and the lap portion has a higher stiffness than both end portions of the rail with respect to a longitudinal direction.

According to this aspect, the lap portion becomes hard to bend. Therefore, in the slide rail device, the first slider and the second slider can slidingly move in the lap portion smoothly.

In the above aspect, preferably, at least one of the first slider and the second slider is driven by an electric motor (136).

According to this aspect, the seat driven by the electric motor can be slidably provided on the rail.

In the above aspect, preferably, the lap portion is provided with a reinforcement structure (123) that enhances a stiffness of the lap portion.

According to this aspect, due to the provision of the reinforcement structure, the lap portion can be made hard to bend.

In the above aspect, preferably, the lap portion is made of a heat-treated steel plate.

According to this aspect, the heat treatment can enhance the hardness and toughness of the lap portion.

In the above aspect, preferably, the lap portion is provided in a central portion of the rail with respect to the longitudinal direction.

According to this aspect, the stiffness of the central portion of the rail with respect to the longitudinal direction can be enhanced.

In the above aspect, preferably, the rail comprises: a rail bottom wall (114) extending in a direction perpendicular to the longitudinal direction; a pair of rail outer side walls (115) extending upward from both end portions of the rail bottom wall, a pair of rail upper walls (116) extending in directions toward each other from upper ends of the pair of rail outer side walls; and rail inner side walls (117) respectively extending downward from inner ends of the pair of rail upper walls, wherein the reinforcement structure is provided along at least one of upper surfaces of the pair of rail upper walls, outer side surfaces of the pair of rail outer side walls, and inner surfaces of the rail inner side walls.

According to this aspect, the rail can be reinforced from two directions. Therefore, the stiffness of the lap portion can be reliably enhanced.

In the above aspect, preferably, the rail is provided with protrusions (122) protruding from the rail inner side walls in directions toward each other, and the reinforcement structure is provided on surfaces of the protrusions that oppose each other.

According to this aspect, the stiffness of the lap portion can be further enhanced.

To achieve the above object, another aspect of the present invention provides a slide rail device (110), comprising: a rail (111); a first slider (112) slidably provided on the rail and supporting a first seat (102); and a second slider (112) slidably provided on the rail and supporting a second seat (102), wherein the rail has a lap portion (111B) corresponding to a lap region (LR) in which a movable range of the first slider and a movable range of the second slider overlap, the rail is provided with engagement holes (159) arranged in a longitudinal direction, at least one of the first slider and the second slider is provided, in a rotatable manner, with a screw member (138, 139) extending in the longitudinal direction and engaging with the engagement holes, at least one of the first slider and the second slider slidingly moves relative to the rail when the screw member is rotated by an electric motor (136), and the engagement holes in the lap portion are formed such that a gap between the screw member and each engagement hole at an engagement part is greater for the engagement holes in the lap portion than for the engagement holes in both end portions of the rail with respect to the longitudinal direction.

According to this aspect, the degree of engagement of the first slider and the second slider with the engagement holes can be reduced in the lap portion. Therefore, the first slider and the second slider can slidingly move in the lap portion smoothly.

In the above aspect, preferably, a length in the longitudinal direction or an up-down direction of the engagement holes provided in the lap portion is longer than a length in the longitudinal direction or the up-down direction of the engagement holes provided in the both end portions.

According to this aspect, due to the change in the size of the engagement holes, the first slider and the second slider can slidingly move in the lap portion smoothly.

In the above aspect, preferably, a length in an up-down direction of the engagement holes provided in the lap portion becomes longer from an outer side to an inner side of the lap portion with respect to a width direction.

According to this aspect, due to the change in shape of the engagement holes, the first slider and the second slider can slidingly move in the lap portion smoothly.

In a car including a battery described in Patent Document 4 (JP2019-202744A), a battery pack for accommodating the battery is provided under the floor panel. On the upper surface side of the floor panel, a driver seat and a passenger seat are provided via floor cross members.

A car described in Patent Document 5 (JP2010-18226A) includes a floor panel joined to a pair of side sills and a pair of cross members provided on an upper surface of the floor panel. Also, a pair of slide rails are fixed to the upper surfaces of the cross members so as to extend in the front-rear direction of the car. Further, slide sliders fixed to the car seat are provided in the slide rails. Due to these, the car seat is slidable in the front-rear direction of the car.

When a battery is disposed under the floor panel and the car seat including various rails is disposed on the floor panel, the load of the battery may cause the floor panel to bend, and moreover, may cause the various rails to bend. This hinders smooth movement of the car seat.

In view of the foregoing background, an object of the present invention is to provide a mounting structure for a car seat in which the movement of the car seat is smooth.

To achieve the above object, the present invention provides a mounting structure for car seats (401) in a car (404) provided with a battery (402), the mounting structure comprising: a pair of left and right side sills (408); a floor (409) joined to the left and right side sills; a battery unit (413) disposed under the floor and joined to the left and right side sills; and multiple seats (401) provided on the floor via a slide rail device (420), wherein the floor comprises an upper floor panel (410) and a lower floor panel (411) that face each other, and multiple beams (412) provided between the upper floor panel and the lower floor panel, the slide rail device comprises a rail (421) provided on the upper floor panel and multiple sliders (422) movably supported by the rail and joined to the respective seats, and the rail is disposed to straddle the multiple beams as seen from above.

According to this aspect, the upper floor panel is joined to the lower floor panel via the multiple beams. Thereby, the floor becomes hard to bend downward. Namely, the upper floor panel becomes hard to bend downward even when the load of the battery unit acts on the floor via the left and right side sills. This also makes the rail hard to bend, and the movement of the seats becomes smooth.

In the above aspect, a spacing (L1) between the multiple beams may be shorter than a length (L2) of each of the multiple sliders.

According to this aspect, no matter what positions the seats are in, a part of each slider overlaps with at least one beam as seen from above. Accordingly, due to the beams overlapping with the sliders, the upper floor panel becomes hard to bend downward even when a downward force such as the load of the seats or the load of the occupants acts on the floor via the seats. This also makes the rail hard to bend, and the movement of the seats becomes smooth.

In the above aspect, for mutually adjacent ones of the sliders, at least one beam may be disposed in a section from a front end of one of the sliders to a rear end of another of the sliders as seen in a side view.

According to this aspect, no matter what positions the seats are in, a part of each slider overlaps with at least one beam as seen from above. Accordingly, due to the beams overlapping with the sliders, the upper floor panel becomes hard to bend downward even when a downward force such as the load of the seats or the load of the occupants acts on the floor via the seats. This also makes the rail hard to bend, and the movement of the seats becomes smooth.

In the above aspect, for mutually adjacent ones of the sliders, at least one beam may be disposed in a section from a rear end of one of the sliders to a rear end of another of the sliders as seen in a side view.

According to this aspect, no matter what positions the seats are in, a part of each slider overlaps with at least one beam as seen from above. Accordingly, due to the beams overlapping with the sliders, the upper floor panel becomes hard to bend downward even when a downward force such as the load of the seats or the load of the occupants acts on the floor via the seats. This also makes the rail hard to bend, and the movement of the seats becomes smooth.

In the above aspect, for mutually adjacent ones of the beams, the floor may be provided with multiple coupling members (432) that couple one of the beams to another of the beams.

According to this aspect, the multiple coupling members improve the stiffness of the corresponding beams. Therefore, the upper floor panel more effectively becomes hard to bend downward even when the load of the battery unit acts on the floor via the left and right side sills. This suppresses bending of the rail. Thus, the movement of the seats becomes smooth.

In the above aspect, preferably, the beams may comprise a first beam (412A) extending in a front-rear direction and multiple second beams (412B) extending leftward and rightward from the first beam.

According to this aspect, the first beam forms a load path in the front-rear direction. This improves the bending stiffness in the front-rear direction. Therefore, the damage to the floor due to car collision is suppressed. Since the upper floor panel is also supported by the multiple second beams, the upper floor panel becomes hard to bend downward. Namely, the upper floor panel becomes hard to bend downward even when the load of the battery unit acts on the floor via the left and right side sills. This suppresses bending of the rail. Thus, the movement of the seats becomes smooth.

In the above aspect, the slide rail devices may be provided to be laterally spaced from each other and, as seen from above, the first beam may be provided in a position overlapping with a space between the left slide rail device and the right slide rail device.

According to this aspect, the first beam forms a load path in the front-rear direction. This more effectively improves the bending stiffness in the front-rear direction.

In the above aspect, for mutually adjacent ones of the second beams, the floor may be provided with multiple coupling members (432) that couple one of the second beams to another of the second beams.

According to this aspect, the multiple coupling members ensure the stiffness of the corresponding second beams. Therefore, the load of the battery unit acting on the upper floor panel is suppressed, and moreover, bending of the upper floor panel is more effectively suppressed. Thus, the movement of the seats becomes smooth.

To achieve the above object, the present invention provides a mounting structure for a car seat in a car (404) provided with a battery (402), the mounting structure comprising: a pair of left and right side sills (408); a floor (409) joined to the left and right side sills; a battery unit (413) disposed under the floor and joined to the left and right side sills; and multiple seats (401) provided on the floor via a slide rail device (420), wherein the floor comprises a panel member (440) joined to each of the left and right side sills and a reinforcement member (442) provided on the panel member, the slide rail device comprises a rail (421) and multiple sliders (422) movably supported by the rail and joined to the respective seats, and the rail is disposed on the reinforcement member.

According to this aspect, the reinforcement member becomes hard to bend downward even when the load of the battery unit acts on the floor via the left and right side sills. This also makes the rail hard to bend, and the movement of the seats becomes smooth.

In the above aspect, the reinforcement member may be provided with multiple void parts (447).

According to this aspect, the reinforcement member is lightweighted.

Conventionally, in a vehicle seat composed of a seat cushion and a seatback, a technology for causing the seat cushion having a front end portion pivotably supported to pivot such that the rear end portion is lifted up and the seat body is brought into a forward leaning posture to create a wide space behind the seat body.

In a vehicle seat of Patent Document 6 (JP2021-167162A), round rod-shaped engagement strikers are individually fixed to upper portions of left and right rails for allowing the seat body to slidably move forward and rearward. A lock device provided in the rear end portion of the seat body engages with the engagement strikers so that, unless a release operation is performed, the seat body is held so as not to be brought into the forward leaning posture.

It is convenient if the vehicle seat is configured to be capable of securing a wide space behind the seat body as necessary. However, in other times, particularly, in cases such as when a person is seated on the seat body, it is required for the seat body to be firmly held so as not to lean forward.

Therefore, improvement of the support stiffness of the engagement strikers for retaining the seat body is demanded.

The present invention has been made in view of the above circumstances, and an object thereof is to provide a vehicle seat capable of improving the support stiffness of an engagement striker.

To achieve the above object, the present invention provides a vehicle seat in which a seat body comprising a seatback serving as a backrest and a seat cushion serving as a seating part can be switched between a use position in which a person to be seated can be seated on the seat body and a movement position that is moved from the use position, the vehicle seat comprising: a lower rail fixed to a floor of a vehicle; an upper rail movably supported by the lower rail; a lock device which is provided on the seat body for switching between the use position and the movement position; and a striker provided on a side of the upper rail to be engaged with and released from the lock device when switching between the use position and the movement position, wherein the lower rail, the upper rail, and the striker are provided as pairs on both sides with respect to a direction intersecting with a moving direction of the upper rail, the pair of strikers extend in directions toward each other, and the vehicle seat is provided with a coupling member that couples the pair of strikers to each other.

In the above aspect, the coupling member is configured as a separate member from the strikers.

In the above aspect, the coupling member has a closed cross-sectional shape.

In the above aspect, the coupling member has a cylindrical shape.

In the above aspect, the pair of strikers are respectively provided on the upper rails via striker support brackets that support at least parts thereof in an extension direction.

In the above aspect, the coupling member is also coupled to the pair of striker support brackets.

In the above aspect, the striker support brackets have raised parts, and the strikers are joined to lower sides of the raised parts.

### Effect of the Invention

To achieve the above object, one aspect of the present invention provides a seat mounting structure, comprising: a right side sill (3A) and a left side sill (3B) that extend in a front-rear direction; a central member (4) extending in the front-rear direction between the right side sill and the left side sill; a plurality of cross members (7) provided to be spaced from each other in the front-rear direction and each extending laterally and joined to the central member, the right side sill, and the left side sill; a floor (9) provided on the central member and the plurality of cross members and joined to the right side sill and the left side sill; a plurality of right battery connection parts (23A) joined to the right side sill; a plurality of left battery connection parts (23B) joined to the left side sill; a plurality of central battery connection parts (23C) joined to the central member; a plurality of right batteries (12A) extending laterally and joined to the right battery connection parts and the central battery connection parts; the plurality of left batteries (12B) extending laterally and joined to the left battery connection parts and the central battery connection parts; and a seat (41) mounted on an upper surface of the floor via a seat support part (51), wherein the seat support part is provided between the right battery connection parts and the central battery connection parts or between the left battery connection parts and the central battery connection parts.

According to this aspect, the seat support part is provided between the right battery connection parts and the central battery connection parts or between the left battery connection parts and the central battery connection parts. Therefore, a seat mounting structure which avoids interference between the battery connection parts and the seat support part can be provided.

In the above aspect, preferably, the seat support part comprises a first rail (52) joined to the floor and a first slider (53) slidably supported by the first rail and joined to the seat, and the first rail crosses at least three of the cross members.

According to this aspect, the seat can be made slidable relative to the floor. Also, since the first rail is joined to the floor to cross three of the cross members, the first rail becomes hard to bend.

In the above aspect, preferably, the first rail is received in a recessed groove (11) provided on the floor and extending in the front-rear direction.

According to this aspect, arrangement of the first rail on the floor is easy.

In the above aspect, preferably, the floor comprises a lower floor panel (9B) extending along a bottom portion of the recessed groove and an upper floor panel (9A) extending along an upper portion of the recessed groove.

According to this aspect, the floor can have a double-floor structure. Also, since the upper floor panel extends along the upper portion of the recessed groove, it is possible to ensure a wide leg space for the occupant seated on the seat.

In the above aspect, preferably, at least one of left and right end portions of the seat is disposed above the plurality of right battery connection parts or the plurality of central battery connection parts.

According to this aspect, it is possible to provide a seat having a long length in the left-right direction.

In the above aspect, preferably, a front end portion of the seat support part is disposed more rearward than front end portions of the right batteries and the left batteries.

According to this aspect, the right batteries and the left batteries are arranged over a wide range.

In the above aspect, preferably, the right battery connection parts, the left battery connection parts, and the central battery connection parts comprise hooks (29) for supporting the right batteries and the left batteries.

According to this aspect, the right batteries and the left batteries can be supported by the hooks.

In the above aspect, preferably, an article (42) is mounted on the floor via a pair of article support parts (61), the pair of article support parts are respectively disposed on both sides of the plurality of central battery connection parts with respect to a left-right direction, and one of the article support parts is provided between the seat support part and the plurality of central battery connection parts with respect to the left-right direction.

According to this aspect, it is possible to provide article support parts for supporting the article. Also, interference between the battery connection parts and the article support parts can be avoided.

In the above aspect, preferably, the pair of article support parts each include a second rail (62) joined to the floor and a second slider (63) slidably supported by the second rail and joined to the article, and the second rail crosses at least three of the cross members.

According to this aspect, the article can be made slidable relative to the floor. Also, since the second rail is joined to the floor to cross three of the cross members, the second rail becomes hard to bend.

In the above aspect, preferably, each of front end portions of the pair of article support parts is disposed more rearward than front end portions of the right batteries and the left batteries.

According to this aspect, the right batteries and the left batteries are arranged over a wide range.

To achieve the above object, one aspect of the present invention provides a slide rail device (110), comprising: a rail (111); a first slider (112) slidably provided on the rail and supporting a first seat (102); and a second slider (112) slidably provided on the rail and supporting a second seat (102), wherein the rail has a lap portion (111B) which corresponds to a lap region (LR) in which a movable range (R1) of the first slider and a movable range (R2) of the second slider overlap, and the lap portion has a higher stiffness than both end portions of the rail with respect to a longitudinal direction.

According to this aspect, the lap portion becomes hard to bend. Therefore, in the slide rail device, the first slider and the second slider can slidingly move in the lap portion smoothly.

In the above aspect, preferably, at least one of the first slider and the second slider is driven by an electric motor (136).

According to this aspect, the seat driven by the electric motor can be slidably provided on the rail.

In the above aspect, preferably, the lap portion is provided with a reinforcement structure (123) that enhances a stiffness of the lap portion.

According to this aspect, due to the provision of the reinforcement structure, the lap portion can be made hard to bend.

In the above aspect, preferably, the lap portion is made of a heat-treated steel plate.

According to this aspect, the heat treatment can enhance the hardness and toughness of the lap portion.

In the above aspect, preferably, the lap portion is provided in a central portion of the rail with respect to the longitudinal direction.

According to this aspect, the stiffness of the central portion of the rail with respect to the longitudinal direction can be enhanced.

In the above aspect, preferably, the rail comprises: a rail bottom wall (114) extending in a direction perpendicular to the longitudinal direction; a pair of rail outer side walls (115) extending upward from both end portions of the rail bottom wall, a pair of rail upper walls (116) extending in directions toward each other from upper ends of the pair of rail outer side walls; and rail inner side walls (117) respectively extending downward from inner ends of the pair of rail upper walls, wherein the reinforcement structure is provided along at least one of upper surfaces of the pair of rail upper walls, outer side surfaces of the pair of rail outer side walls, and inner surfaces of the rail inner side walls.

According to this aspect, the rail can be reinforced from two directions. Therefore, the stiffness of the lap portion can be reliably enhanced.

In the above aspect, preferably, the rail is provided with protrusions (122) protruding from the rail inner side walls in directions toward each other, and the reinforcement structure is provided on surfaces of the protrusions that oppose each other.

According to this aspect, the stiffness of the lap portion can be further enhanced.

To achieve the above object, another aspect of the present invention provides a slide rail device (110), comprising: a rail (111); a first slider (112) slidably provided on the rail and supporting a first seat (102); and a second slider (112) slidably provided on the rail and supporting a second seat (102), wherein the rail has a lap portion (111B) corresponding to a lap region (LR) in which a movable range of the first slider and a movable range of the second slider overlap, the rail is provided with engagement holes (159) arranged in a longitudinal direction, at least one of the first slider and the second slider is provided, in a rotatable manner, with a screw member (138, 139) extending in the longitudinal direction and engaging with the engagement holes, at least one of the first slider and the second slider slidingly moves relative to the rail when the screw member is rotated by an electric motor (136), and the engagement holes in the lap portion are formed such that a gap between the screw member and each engagement hole at an engagement part is greater for the engagement holes in the lap portion than for the engagement holes in both end portions of the rail with respect to the longitudinal direction.

According to this aspect, the degree of engagement of the first slider and the second slider with the engagement holes can be reduced in the lap portion. Therefore, the first slider and the second slider can slidingly move in the lap portion smoothly.

In the above aspect, preferably, a length in the longitudinal direction or an up-down direction of the engagement holes provided in the lap portion is longer than a length in the longitudinal direction or the up-down direction of the engagement holes provided in the both end portions.

According to this aspect, due to the change in the size of the engagement holes, the first slider and the second slider can slidingly move in the lap portion smoothly.

In the above aspect, preferably, a length in an up-down direction of the engagement holes provided in the lap portion becomes longer from an outer side to an inner side of the lap portion with respect to a width direction.

According to this aspect, due to the change in shape of the engagement holes, the first slider and the second slider can slidingly move in the lap portion smoothly.

To achieve the above object, the present invention provides a mounting structure for car seats (401) in a car (404) provided with a battery (402), the mounting structure comprising: a pair of left and right side sills (408); a floor (409) joined to the left and right side sills; a battery unit (413) disposed under the floor and joined to the left and right side sills; and multiple seats (401) provided on the floor via a slide rail device (420), wherein the floor comprises an upper floor panel (410) and a lower floor panel (411) that face each other, and multiple beams (412) provided between the upper floor panel and the lower floor panel, the slide rail device comprises a rail (421) provided on the upper floor panel and multiple sliders (422) movably supported by the rail and joined to the respective seats, and the rail is disposed to straddle the multiple beams as seen from above.

According to this aspect, the upper floor panel is joined to the lower floor panel via the multiple beams. Thereby, the floor becomes hard to bend downward. Namely, the upper floor panel becomes hard to bend downward even when the load of the battery unit acts on the floor via the left and right side sills. This also makes the rail hard to bend, and the movement of the seats becomes smooth.

In the above aspect, a spacing (L1) between the multiple beams may be shorter than a length (L2) of each of the multiple sliders.

According to this aspect, no matter what positions the seats are in, a part of each slider overlaps with at least one beam as seen from above. Accordingly, due to the beams overlapping with the sliders, the upper floor panel becomes hard to bend downward even when a downward force such as the load of the seats or the load of the occupants acts on the floor via the seats. This also makes the rail hard to bend, and the movement of the seats becomes smooth.

In the above aspect, for mutually adjacent ones of the sliders, at least one beam may be disposed in a section from a front end of one of the sliders to a rear end of another of the sliders as seen in a side view.

According to this aspect, no matter what positions the seats are in, a part of each slider overlaps with at least one beam as seen from above. Accordingly, due to the beams overlapping with the sliders, the upper floor panel becomes hard to bend downward even when a downward force such as the load of the seats or the load of the occupants acts on the floor via the seats. This also makes the rail hard to bend, and the movement of the seats becomes smooth.

In the above aspect, for mutually adjacent ones of the sliders, at least one beam may be disposed in a section from a rear end of one of the sliders to a rear end of another of the sliders as seen in a side view.

According to this aspect, no matter what positions the seats are in, a part of each slider overlaps with at least one beam as seen from above. Accordingly, due to the beams overlapping with the sliders, the upper floor panel becomes hard to bend downward even when a downward force such as the load of the seats or the load of the occupants acts on the floor via the seats. This also makes the rail hard to bend, and the movement of the seats becomes smooth.

In the above aspect, for mutually adjacent ones of the beams, the floor may be provided with multiple coupling members (432) that couple one of the beams to another of the beams.

According to this aspect, the multiple coupling members improve the stiffness of the corresponding beams. Therefore, the upper floor panel more effectively becomes hard to bend downward even when the load of the battery unit acts on the floor via the left and right side sills. This suppresses bending of the rail. Thus, the movement of the seats becomes smooth.

In the above aspect, preferably, the beams may comprise a first beam (412A) extending in a front-rear direction and multiple second beams (412B) extending leftward and rightward from the first beam.

According to this aspect, the first beam forms a load path in the front-rear direction. This improves the bending stiffness in the front-rear direction. Therefore, the damage to the floor due to car collision is suppressed. Since the upper floor panel is also supported by the multiple second beams, the upper floor panel becomes hard to bend downward. Namely, the upper floor panel becomes hard to bend downward even when the load of the battery unit acts on the floor via the left and right side sills. This suppresses bending of the rail. Thus, the movement of the seats becomes smooth.

In the above aspect, the slide rail devices may be provided to be laterally spaced from each other and, as seen from above, the first beam may be provided in a position overlapping with a space between the left slide rail device and the right slide rail device.

According to this aspect, the first beam forms a load path in the front-rear direction. This more effectively improves the bending stiffness in the front-rear direction.

In the above aspect, for mutually adjacent ones of the second beams, the floor may be provided with multiple coupling members (432) that couple one of the second beams to another of the second beams.

According to this aspect, the multiple coupling members ensure the stiffness of the corresponding second beams. Therefore, the load of the battery unit acting on the upper floor panel is suppressed, and moreover, bending of the upper floor panel is more effectively suppressed. Thus, the movement of the seats becomes smooth.

To achieve the above object, the present invention provides a mounting structure for a car seat in a car (404) provided with a battery (402), the mounting structure comprising: a pair of left and right side sills (408); a floor (409) joined to the left and right side sills; a battery unit (413) disposed under the floor and joined to the left and right side sills; and multiple seats (401) provided on the floor via a slide rail device (420), wherein the floor comprises a panel member (440) joined to each of the left and right side sills and a reinforcement member (442) provided on the panel member, the slide rail device comprises a rail (421) and multiple sliders (422) movably supported by the rail and joined to the respective seats, and the rail is disposed on the reinforcement member.

According to this aspect, the reinforcement member becomes hard to bend downward even when the load of the battery unit acts on the floor via the left and right side sills. This also makes the rail hard to bend, and the movement of the seats becomes smooth.

In the above aspect, the reinforcement member may be provided with multiple void parts (447).

According to this aspect, the reinforcement member is lightweighted.

In the present invention, since the pair of strikers are coupled to each other by the coupling member, the load received from the seat body can be distributed to the two strikers, and it is possible to improve the support stiffness of each striker.

Also, even in the case where each striker extends out in a cantilever manner, since the coupling member couples the strikers to each other, the pair of strikers are supported in a both-end supported manner, and the support stiffness can be improved.

In the present invention, since the coupling member is configured as a separate member from the strikers, it is possible to mount the coupling member to the existing strikers in a reinforcing manner. Also, since the coupling member is a separate member, it is easy to adjust the arrangement when mounting, and this is advantageous in securing a space.

In the present invention, since the coupling member has a closed cross-sectional shape, it is possible to reduce the weight while improving the support stiffness of the pair of strikers.

In the present invention, since the coupling member has a cylindrical shape, a high stiffness can be obtained in any radial direction about the coupling member, and it is possible to improve the support stiffness of the pair of strikers.

In the present invention, the pair of strikers are respectively provided on the upper rails via striker support brackets. Therefore, by choosing the shape and structure suitable for mounting to the upper rails, it is possible to improve the support stiffness of the pair of strikers.

Further, by making the striker support brackets to be separable from the upper rails, changing of the mounting position of the strikers, replacement of the strikers, etc. become easy to perform.

In the present invention, since the coupling member is also coupled to the pair of striker support brackets, it is possible to further improve the support stiffness of the pair of strikers.

In the present invention, the strikers are joined to the lower sides of the raised parts of the striker support brackets. Thus, since the strikers are joined to positions where the stiffness of the striker support brackets is enhanced by the raised parts, it is possible to further improve the support stiffness of the pair of strikers.

Further, since the striker support brackets cover the strikers from above, it is possible to effectively improve the support stiffness against an upward load on the strikers.

### BRIEF DESCRIPTION OF THE DRAWINGS

FIG. 1 is a top view of a car to which a seat mounting structure according to the first embodiment is applied;

FIG. 2 is a sectional view of the car to which the seat mounting structure according to the first embodiment is applied;

FIG. 3 is a side view of seats and seat support parts;

FIG. 4 is a side view of a console box and an article support part;

FIG. 5 is a top view of a car to which a seat mounting structure according to the second embodiment is applied;

FIG. 6 is a top view of a car to which a seat mounting structure according to the third embodiment is applied;

FIG. 7 is a top view of a car to which a slide rail device according to the fourth embodiment is applied;

FIG. 8 is a side view of the slide rail device according to the fourth embodiment;

FIG. 9 is a sectional view of a front end portion of a rail;

FIG. 10 is a sectional view of a lap portion of the rail;

FIG. 11 is a sectional view of electric slide rails and a coupling member;

FIG. 12 is a perspective view of a slider with a part being broken away;

FIG. 13 is a sectional view of the electric slide rail;

FIG. 14 is a perspective view of a screw assembly with a first bracket being omitted;

FIG. 15 is a perspective view showing engagement of first and second screw members with first and second screw engaging portions;

FIG. 16 is a perspective view showing engagement of the first and second screw members with the first and second screw engaging portions in a slide rail device according to the fifth embodiment;

FIG. 17 is a top view of a car to which a slide rail device according to the sixth embodiment is applied;

FIG. 18 is a side view of the slide rail device according to the sixth embodiment;

FIG. 19 is a sectional view showing a joint between a rotating device and a slide rail device according to the seventh embodiment;

FIG. 20 is another sectional view showing the joint between the rotating device and the slide rail device according to the seventh embodiment;

FIG. 21 is a sectional view showing a joining between a rotating device and a slide rail device according to the eighth embodiment;

FIG. 22 is another sectional view showing the joining between the rotating device and the slide rail device according to the eighth embodiment;

FIG. 23 is a perspective view showing a seat mounting structure according to the ninth embodiment;

FIG. 24 is a side view showing a movement of the seat according to the ninth embodiment relative to the rail;

FIG. 25 is a perspective view showing a seat mounting structure according to the tenth embodiment;

FIG. 26 is a side view showing a seat mounting structure according to the eleventh embodiment;

FIG. 27 is a perspective view showing a seat mounting structure according to the twelfth embodiment;

FIG. 28 is a perspective view showing a seat mounting structure according to the thirteenth embodiment;

FIG. 29 is a perspective view showing a seat mounting structure according to the fourteenth embodiment;

FIG. 30 is a perspective view showing a seat mounting structure according to the fifteenth embodiment;

FIG. 31 is a perspective view showing a seat mounting structure according to the sixteenth embodiment;

FIG. 32 is a perspective view of a vehicle seat according to an embodiment when a seat body is in a use position;

FIG. 33 is a side view of the vehicle seat in the use position;

FIG. 34 is a perspective view of the vehicle seat in a movement position;

FIG. 35 is a side view of the vehicle seat in the movement position;

FIG. 36 is a perspective view of the vehicle seat in the movement position as viewed from a direction different from FIG. 32;

FIG. 37 is a plan view of the vehicle seat in the use position;

FIG. 38 is a sectional view taken along line A-A in FIG. 37;

FIG. 39 is a perspective view of a part around left and right strikers;

FIG. 40 is a sectional view taken along line B-B in FIG. 39;

FIG. 41 is a side view of a lock device;

FIG. 42 is an exploded perspective view of the lock device;

FIG. 43 is a perspective view showing another example of a support structure for the strikers;

FIG. 44 is a perspective view showing the strikers and other striker support brackets; and

FIG. 45 is a bottom view of the strikers and the other striker support brackets.

### MODE(S) FOR CARRYING OUT THE INVENTION

### First Embodiment

In the following, a mounting structure for a car seat (hereinafter referred to as a seat) according to the present invention will be described with reference to the drawings. In this embodiment, the mounting structure is applied to an electric automobile (car) that is driven by electric power supplied from a battery unit. In the following description, the travel direction of the car is defined as a front-rear direction, and the left, right, up, and down directions are defined accordingly.

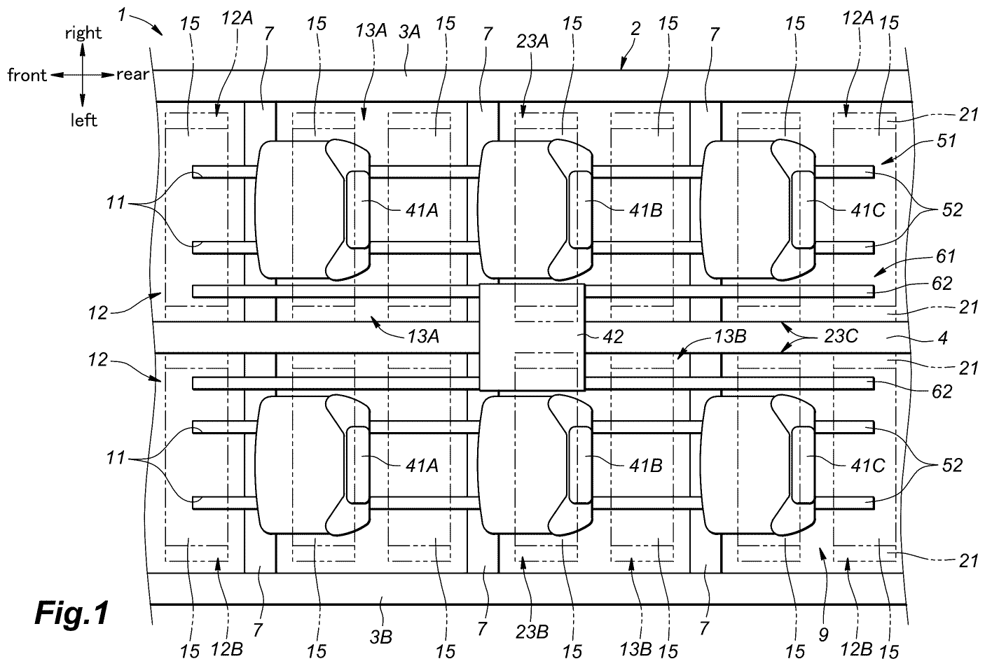

In the following, a structure of a car body 2 constituting a car 1 will be first described. As shown in FIG. 1, the car body 2 is composed of a car body frame including a right side sill 3A and a left side sill 3B extending in the front-rear direction and a central member 4.

The right side sill 3A and the left side sill 3B are disposed to be spaced from each other in lower portions of the left and right side portions of the car 1. The central member 4 extends in the front-rear direction between the right side sill 3A and the left side sill 3B. In the present embodiment, the central member 4 is provided in a central portion of the car body 2 with respect to the left-right direction. The right side sill 3A, the central member 4, and the left side sill 3B are coupled to each other by multiple cross members 7 extending laterally.

The multiple cross members 7 are disposed at predetermined intervals in the front-rear direction. The cross members 7 are joined to side portions of the right side sill 3A, the central member 4, and the left side sill 3B. A floor panel (hereinafter referred to as a floor 9) defining a lower edge of the car cabin is joined to upper surfaces of the right side sill 3A, the central member 4, and the left side sill 3B.

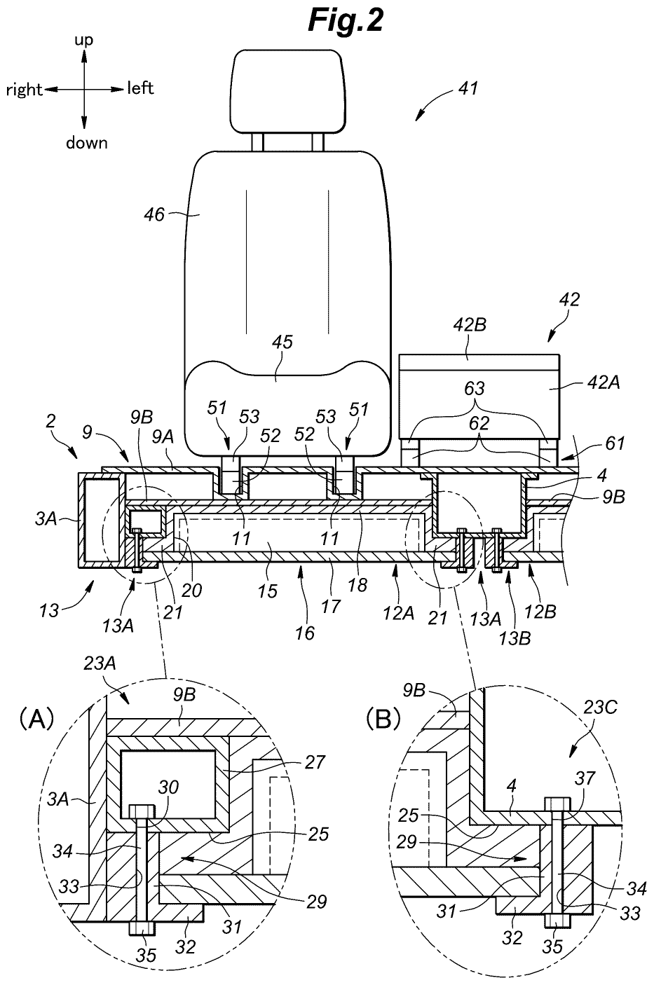

As shown in FIG. 2, the floor 9 includes an upper floor panel 9A and a lower floor panel 9B provided below the upper floor panel 9A. Each of the upper floor panel 9A and the lower floor panel 9B is formed of a metal plate and has surfaces facing substantially in the up-down direction. Thus, the floor 9 constitutes a double-floor structure.

As shown in FIGS. 1 and 2, the upper floor panel 9A is joined to the upper surfaces of the right side sill 3A and the left side sill 3B at side edges thereof. The upper floor panel 9A is also joined to the upper surface of the central member 4 at a central portion thereof with respect to the left-right direction. A part of the upper floor panel 9A between the right side sill 3A and the central member 4 with respect to the left-right direction is formed with a pair of left and right recessed grooves 11. A part of the upper floor panel 9A between the left side sill 3B and the central member 4 with respect to the left-right direction is also formed with a pair of left and right recessed grooves 11.

Each of the pair of recessed grooves 11 is a bottomed groove that is recessed downward from the upper surface of the upper floor panel 9A. Each of the pair of recessed grooves 11 extends in the front-rear direction and crosses three cross members 7 as seen in top view.

In the right side part of the car 1, the lower floor panel 9B laterally connects the right side sill 3A and the central member 4. In the left side part of the car 1, the lower floor panel 9B laterally connects the left side sill 3B and the central member 4. Preferably, the lower floor panel 9B is joined to the side surfaces of the right side sill 3A, the central member 4, and the left side sill 3B at side edges thereof.

The lower floor panel 9B is disposed such that the upper surface thereof is spaced from the lower surface of the upper floor panel 9A by a predetermined spacing in the up-down direction. The lower floor panel 9B preferably extends along bottom portions of the pair of left and right recessed grooves 11. Below the lower floor panel 9B, a battery unit 12 and a battery support structure 13 for supporting the battery unit 12 are provided.

The battery unit 12 includes multiple right batteries 12A provided in a right side part of the car body 2 and multiple left batteries 12B disposed in a left side part of the car body 2. The multiple right batteries 12A are arranged in the front-rear direction. The multiple left batteries 12B are also arranged in the front-rear direction. The right batteries 12A and the left batteries 12B have the same configuration, and thus, in the following, description will be made of only the right batteries 12A, and the description of the left batteries 12B will be omitted.

Each of the multiple right batteries 12A includes at least one battery cell 15 and a battery case 16 accommodating the battery cell(s) 15 as one body.

In the present embodiment, the battery cell 15 is composed of a lithium-ion battery. Motors (not shown in the drawings) installed in the car 1 are driven by the electric power supplied from the battery cells 15, and the car 1 travels.

The battery case 16 is formed of a sheet metal. The battery case 16 includes a battery plate 17 and a battery cover 18.

The battery plate 17 has a plate shape having a substantially flat surface on the upper side. The battery cell(s) 15 is/are placed on the upper surface of the battery plate 17.

The battery cover 18 includes an accommodation part 20 defining a recess that is recessed upward and flange parts 21 extending to the left and right from an edge part of the accommodation part 20. The battery cover 18 may include additional flange parts 21 extending out forward and rearward from the edge part of the accommodation part 20. Each of the lower surfaces of the flange parts 21 has a substantially flat shape. The battery cover 18 is disposed and fixed such that the lower surfaces of the flange parts 21 contact the upper surface of the battery plate 17. Thereby, an accommodation space for accommodating the battery cells 15 is defined between the battery cover 18 and the battery plate 17. In the present embodiment, two battery cells 15 are arranged one behind the other in the accommodation space of the battery cover 18.

The battery unit 12 is supported on the car body 2 via the battery support structure 13. In the following, the battery support structure 13 for supporting the battery unit 12 will be described in detail.

The battery support structure 13 includes right battery support structures 13A for supporting the right batteries 12A and left battery support structures 13B for supporting the left batteries 12B. In the present embodiment, a plurality of right battery support structures 13A arranged in the front-rear direction and a plurality of left battery support structures 13B arranged in the front-rear direction are provided corresponding to the right batteries 12A and the left batteries 12B, respectively.

Each right battery support structure 13A is composed of a right battery connection part 23A (FIG. 2 (A)) provided on the right side sill 3A and a central battery connection part 23C (FIG. 2 (B)) provided on the central member 4. Each left battery support structure 13B is composed of a left battery connection part 23B provided on the left side sill 3B and a central battery connection part 23C provided on the central member 4.

In the present embodiment, the right battery support structures 13A and the left battery support structures 13B have bilaterally symmetric configurations with respect to an axis extending in the front-rear direction on the center of the car body 2 with respect to the left-right direction. Therefore, in the following, description will be made of only the right battery support structures 13A, and the description of the left battery support structures 13B will be omitted.

The right battery connection part 23A engages with the flange part 21 provided on the right edge of the right batteries 12A and connects the flange part 21 to the right side sill 3A. Specifically, the right battery connection part 23A, alone or in cooperation with the right side sill 3A, forms an accommodation recess 25 for accommodating the flange part 21 provided on the right edge of the right battery 12A. The accommodation recess 25 is preferably formed to extend in the front-rear direction. To form the accommodation recess 25, the right battery connection part 23A includes a connection frame 27 and a hook 29.

The connection frame 27 is formed of a sheet metal and extends in the front-rear direction. In the present embodiment, the connection frame 27 is formed to be tubular and has a rectangular cross-sectional shape. The connection frame 27 is joined, at the outboard surface with respect to the car width direction (namely, the right surface) thereof, to the inboard surface with respect to the car width direction (namely, the left surface) of the right side sill 3A. The connection frame 27 is also joined, at the upper surface thereof, to the lower surface of the lower floor panel 9B. The lower surface of the connection frame 27 is provided with a frame hole 30 vertically penetrating therethrough. The hook 29 is provided under the connection frame 27.

The hook 29 is formed of a metal block member and has an L-shaped cross-sectional shape. The hook 29 includes a first member 31 extending in the up-down direction and a second member 32 connected to the lower end of the first member 31. The first member 31 is provided with a hook hole 33 vertically penetrating therethrough.

In the present embodiment, the hook 29 is disposed such that the first member 31 extends vertically along the left surface of the right side sill 3A and the second member 32 extends leftward from the lower end of the first member 31. A bolt 34 is inserted in the hook hole 33.

The bolt 34 vertically penetrates the first member 31. The upper end portion of the bolt 34 is inserted in the frame hole 30 and reaches the inside of the connection frame 27. A nut 35 is mounted on the lower end portion of the bolt 34. Due to the bolt 34 and the nut 35 provided as above, the hook 29 is fastened to the connection frame 27. In the fastened state of the hook 29, the upper end portion of the first member 31 is in contact with the lower surface of the connection frame 27. Thereby, the right battery connection part 23A is provided with the accommodation recess 25 that is formed by the lower surface of the connection frame 27 and the first member 31 and the second member 32 of the hook 29, and is recessed rightward.

The central battery connection part 23C engages with the flange part 21 provided on the left edge of the right battery 12A and connects the flange part 21 to the central member 4. Specifically, the central battery connection part 23C, alone or in cooperation with the central member 4, forms an accommodation recess 25 for accommodating the flange part 21 provided on the left edge of the right battery 12A. The accommodation recess 25 is preferably formed to extend in the front-rear direction. To form the accommodation recess 25, the central battery connection part 23C includes a hook 29.

In the present embodiment, the hook 29 of the central battery connection part 23C has the same configuration as the hook 29 of the right battery connection part 23A. In the central battery connection part 23C, the hook 29 is disposed such that the first member 31 extends vertically along the rightward-facing side surface (hereinafter referred to as the right surface) of the central member 4 and the second member 32 extends rightward from the lower end of the first member 31. A bolt 34 is inserted in the hook hole 33 of the hook 29. The upper end portion of the bolt 34 is inserted in a through hole 37 formed in the lower surface of the central member 4 and reaches the inside of the central member 4. Due to the bolt 34 provided as above and the nut 35 provided at the lower end of the bolt 34, the hook 29 is fastened to the central member 4. In the fastened state of the hook 29, the upper end portion of the first member 31 is in contact with the lower surface of the central member 4. Thereby, the central battery connection part 23C is provided with the accommodation recess 25 that is formed by the lower surface of the central member 4 and the first member 31 and the second member 32 of the hook 29, and is recessed leftward.

When the right battery 12A is supported by the right battery support structure 13A, the left and right flange parts 21 of the battery cover 18 are respectively accommodated in the left and right accommodation recesses 25. The worker should place the flange part 21 on the right side of the battery cover 18 on the second member 32 of the hook 29 of the right battery connection part 23A. Simultaneously, the worker should place the flange part 21 on the left side of the battery cover 18 on the second member 32 of the hook 29 of the central battery connection part 23C. Thereby, the right battery 12A is joined to the car body 2.

The worker may slidingly insert the battery cover 18 in the front-rear direction such that the left and right flange parts 21 of the battery cover 18 are respectively accommodated in the left and right accommodation recesses 25. In this case, preferably, the second member 32 of the hook 29 is provided with a through hole vertically penetrating therethrough, and the flange part 21 and the hook 29 are joined with a bolt. Thereby, forward and rearward movement of the flange part 21 is preferably restricted.

Next, the seats 41 and a console box 42 as an interior component (article), which are installed in the car 1, will be described.

As shown in FIG. 1, the floor 9 is provided with multiple seats 41. In the present embodiment, the floor 9 is provided with a total of six seats 41 arranged in two rows in the lateral direction and in three rows in the front-rear direction. The multiple seats 41 include first-row seats 41A used as a driver's seat or a front passenger seat, two second-row seats 41B respectively provided behind the two first-row seats 41A, and two third-row seats 41C respectively provided behind the two second-row seats 41B. Each seat 41 has the same configuration, and thus, will be described in the following by being denoted by the same reference sign.

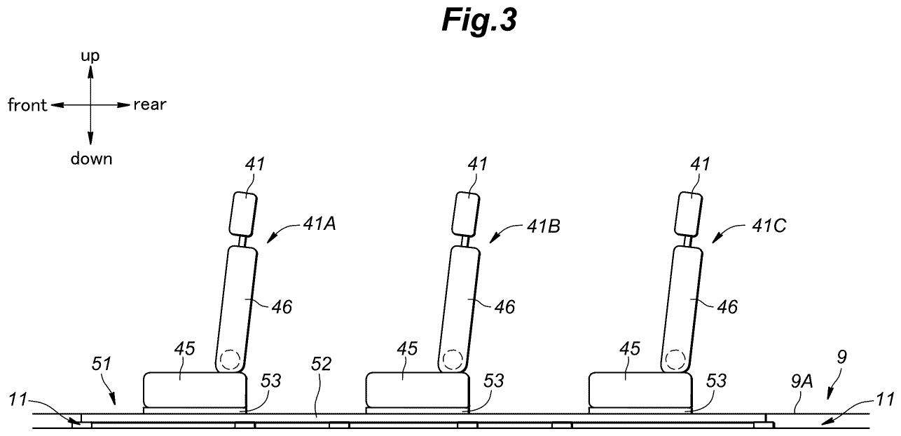

As shown in FIG. 3, each seat 41 has a seat cushion 45 and a seatback 46 extending upward from a rear portion of the seat cushion 45. The seatback 46 is pivotably connected to the seat cushion 45. Between the seat cushion 45 and the floor 9, a seat support part 51 is provided.

In the present embodiment, each seat support part 51 is composed of a slide rail device for moving the seat 41 forward and rearward relative to the floor 9. In the present embodiment, two seat support parts 51 are provided on the floor 9 to be laterally spaced from each other. One of the two seat support parts 51 corresponds to the driver's seat and is provided between the right battery connection parts 23A and the central battery connection parts 23C in top view. The other of the two seat support parts 51 corresponds to the front passenger seat and is provided between the left battery connection parts 23B and the central battery connection parts 23C in top view. Since the two seat support parts 51 have the same configuration, the seat support part 51 corresponding to the driver's seat will be described in detail in the following.

The seat support part 51 includes at least one first rail 52 and first sliders 53 slidably engaged with the first rail 52 and joined to the seats 41. Due to the first sliders 53 moving relative to the first rail 52, the seats 41 move relative to the floor 9.

In the present embodiment, a pair of first rails 52 are provided to be laterally spaced from each other and are joined to the upper floor panel 9A. The first rails 52 each extend in the front-rear direction. Three first sliders 53 are engaged with each of the left and right first rails 52. The three first sliders 53 are joined to the driver's seat, the second-row seat 41B, and the third-row seat 41C, respectively, in order from the front. Thereby, the seat support part 51 joins three seats 41 to the floor 9.

The pair of first rails 52 are respectively received in the pair of recessed grooves 11. Namely, the pair of first rails 52 cross at least three cross members 7 as seen in top view. Each of the front end portions of the first rails 52 is preferably positioned more rearward than the front end portion of the right batteries 12A in top view. Each of the rear end portions of the first rails 52 is preferably positioned more forward than the rear end portion of the right batteries 12A in top view.

Each first slider 53 is disposed above the upper floor panel 9A and may be provided outside the recessed groove 11. Alternatively, at least a part of each first slider 53 may be disposed inside the recessed groove 11. At least an upper portion of each first slider 53 is preferably disposed higher than the upper floor panel 9A. Thereby, the interference between each seat cushion 45 and the upper floor panel 9A can be avoided.

As shown in FIG. 1, a console box 42 is provided in a central portion of the car 1 with respect to the left-right direction between the two seat support parts 51.

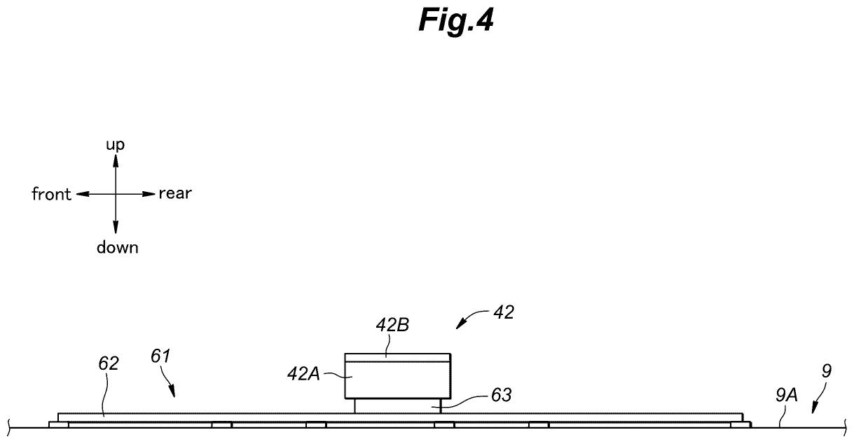

As shown in FIG. 4, the console box 42 constitutes an accommodation box for accommodating an article therein. The console box 42 includes a main body 42A that is open upward and a lid 42B connected to the main body 42A to open and close the main body 42A. Between the main body 42A and the floor 9, a pair of article support parts 61 are provided.

In the present embodiment, the pair of article support parts 61 are constituted of a slide rail device for moving the console box 42 forward and rearward relative to the floor 9. The pair of article support parts 61 are disposed on both sides of the central battery connection parts 23C with respect to the left-right direction as seen in top view. At least one of the pair of article support parts 61 is preferably provided between the seat support part 51 and the central battery connection part 23C with respect to the left-right direction.

Each of the article support parts 61 includes a second rail 62 joined to the upper floor panel 9A and a second slider 63 slidably engaged with the second rail 62 and joined to the console box 42. With the second slider 63 moving relative to the second rail 62, the console box 42 moves relative to the floor 9.

In the present embodiment, the second rail 62 is joined to the upper surface of the upper floor panel 9A. The second rail 62 extends in the front-rear direction.

The second rail 62 crosses at least three cross members 7 as seen in top view. Therefore, even though the second rail 62 extends long in the front-rear direction, the second rail 62 can be made hard to bend due to the stiffness of the cross members 7. Thus, it is possible to enhance the stiffness of the second rail 62 for mounting the console box 42.

The front end portion of the second rail 62 is preferably positioned more rearward than the front end portions of the right batteries 12A and the left batteries 12B in top view. The rear end portion of the second rail 62 is preferably positioned more forward than the rear end portions of the right batteries 12A and the left batteries 12B in top view. In this way, the right batteries 12A and the left batteries 12B are provided over a wide range in the front-rear direction with respect to the second rail 62.

Next, the effects of the seat mounting structure according to the present invention will be described.

The seat support parts 51 are provided between the right battery connection parts 23A and the central battery connection parts 23C and between the left battery connection parts 23B and the central battery connection parts 23C in the left-right direction. Thereby, the interference of the seat support parts 51 with the right battery connection parts 23A, the central battery connection parts 23C, and the left battery connection parts 23B can be avoided.

Further, the pair of article support parts 61 are disposed on the both sides of the plurality of central battery connection parts 23C in the left-right direction. Therefore, the interference of the article support parts 61 with the right battery connection parts 23A, the central battery connection parts 23C, and the left battery connection parts 23B can be avoided. Also, since each of the pair of article support parts 61 is provided between the seat support part 51 and the plurality of central battery connection parts 23C in the left-right direction, each seat 41 and the console box 42 can slidingly move relative to the floor 9 without being restricted by each other.

Further, since the first rails 52 are received in the recessed grooves 11, positioning work when disposing the first rails 52 on the upper floor panel 9A is easy.

Further, the floor 9 constitutes a double-floor structure including the lower floor panel 9B and the upper floor panel 9A. Therefore, it is possible to ensure a wide leg space for the occupant seated on the seat 41.

### Second Embodiment

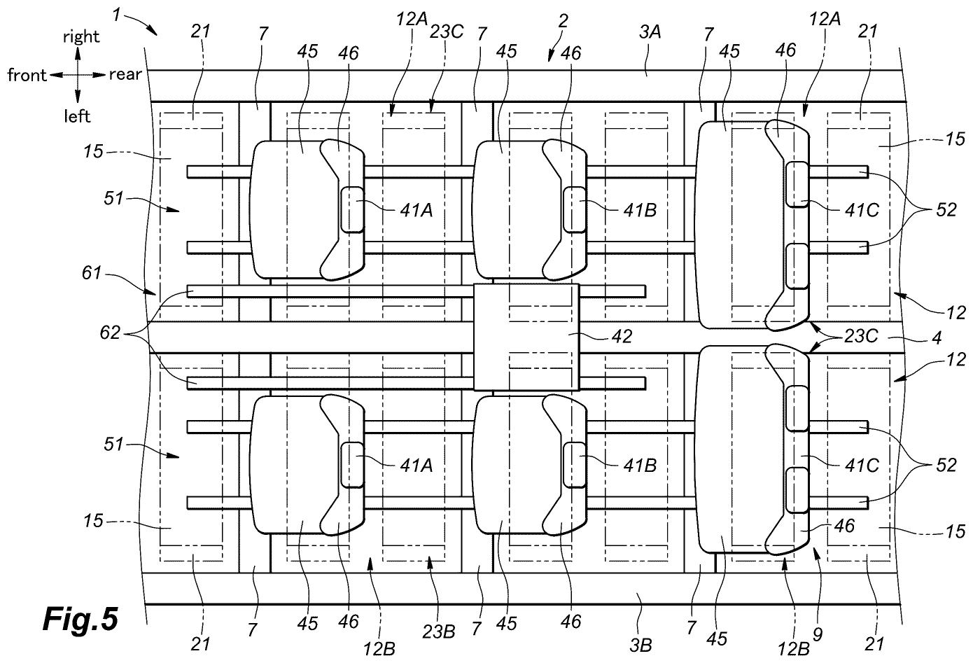

As shown in FIG. 5, in the seat mounting structure according to the second embodiment, the left end portions of the seatback 46 and the seat cushion 45 of the third-row seat 41C are positioned above the central battery connection part 23C. The first-row seat 41A and the second-row seat 41B have a configuration similar to that of the seats 41 of the first embodiment. The article support parts 61 extend in the front-rear direction in a region corresponding to the first-row seat 41A and the second-row seat 41B. Namely, the console box 42 is movable forward and rearward in the region corresponding to the first-row seat 41A and the second-row seat 41B. According to this configuration, it is possible to configure the seat 41 to have a large width in the left-right direction.

Note that in the second embodiment, the console box 42 does not have to be provided in the car 1. In this case, similarly to the third-row seat 41C, the first-row seat 41A and the second-row seat 41B also may be configured to be large in the width direction.

### Third Embodiment

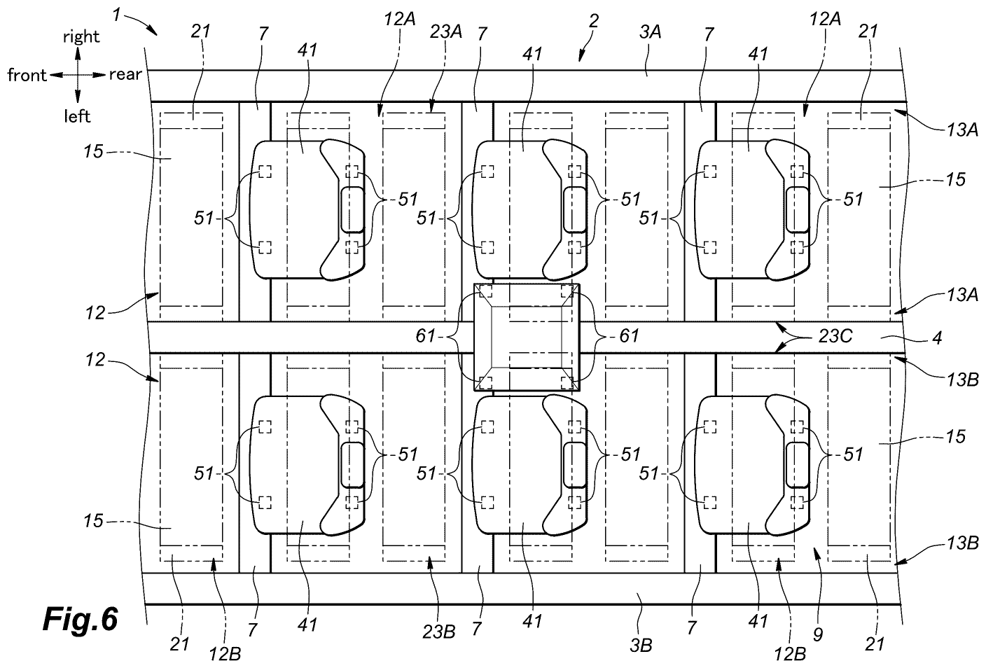

As shown in FIG. 6, in the seat mounting structure according to the third embodiment, the seat support parts 51 and the article support parts 61 do not include slide rail devices. The seat support parts 51 are composed of leg parts joining the seats 41 to the floor 9 to be unable to slide. The article support parts 61 also are composed of leg parts joining the console box 42 to the floor 9 to be unable to slide. According to this configuration, the seats 41 and the console box 42 can be joined to the floor 9 with a simple configuration.

Concrete embodiments have been described in the foregoing, but the present invention can be modified in various ways without being limited to the above embodiments. The console box 42 may be joined to the floor 9 with a single article support part 61. The article support part 61 may support an armrest or a table instead of the console box 42.

### Fourth Embodiment

In the following, an embodiment in which a slide rail device according to the present invention is applied to a car will be described with reference to the drawings. In this description, the front-rear direction, the left-right direction, and the up-down direction are defined based on the travel direction of the car.

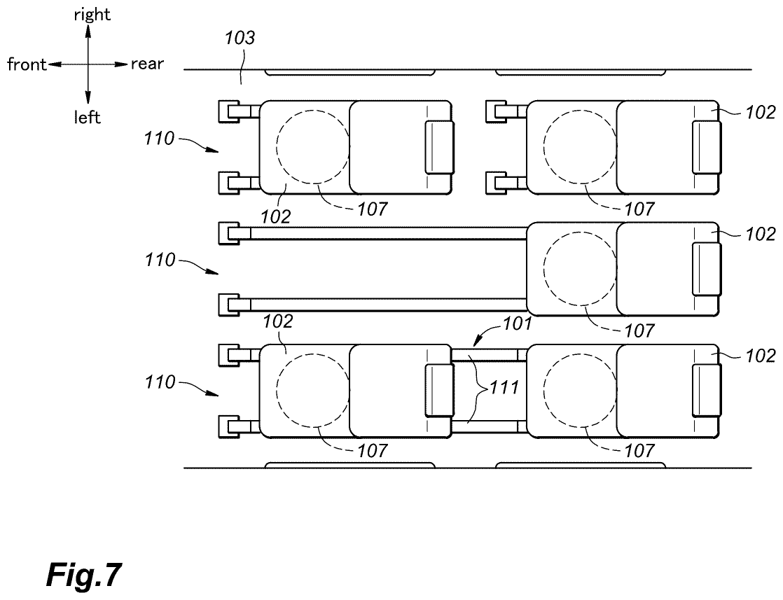

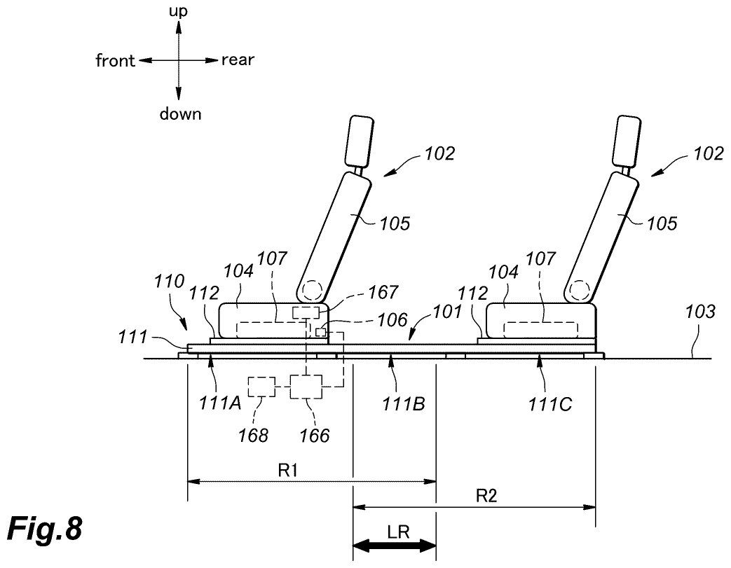

As shown in FIGS. 7 and 8, the car includes a floor 103 defining a lower portion of the car cabin. The floor 103 is provided with multiple vehicle seats 102. The multiple vehicle seats 102 include first-row seats used as a driver's seat and a front passenger seat, second-row seats provided behind the first-row seats, and a center seat. Each seat 102 has the same configuration, and thus, will be described in the following by being denoted by the same reference sign.

Each seat 102 includes a seat cushion 104 for supporting the buttocks of the occupant and a seatback 105 extending upward from a rear portion of the seat cushion 104 to support the back of the occupant.

In the present embodiment, a distance sensor 106 is provided at the rear end of the seat cushion 104 of each first-row seat. The distance sensor 106 is preferably composed of a ToF (Time of Flight) sensor module which includes a light source and a detector and detects the distance by acquiring a time required for the light emitted from the light source to reach the detector. The distance sensor 106 is connected to a control device 166.

Each seat cushion 104 is further provided with a rotating device 107 for rotating the seat 102 relative to the floor 103. The rotating device 107 rotates the seat 102 about a vertical axis extending vertically relative to the floor 103.

Between the seat cushion 104 and the floor 103, a slide rail device 110 is provided.

Each slide rail device 110 is joined to the floor 103 and extends in the front-rear direction. In the present embodiment, three slide rail devices 110 are provided to be laterally spaced from each other. The slide rail device 110 provided in a right side part of the car extends behind the driver's seat and supports the second-row seat. The slide rail device 110 provided in a left side part of the car extends from a front portion to a rear portion of the floor 103 and supports the first seat (the seat 102) used as the front passenger seat and the second seat (the seat 102) used as the second-row seat provided behind the front passenger seat. The slide rail device 110 provided in a central portion of the car extends from a front portion to a rear portion of the floor 103 and supports the center seat. In the following, description will be made of the slide rail device 110 provided in a left side part of the car.

The slide rail device 110 includes an electric slide rail 101. The electric slide rail 101 includes a rail 111 extending in the front-rear direction and sliders 112 slidably engaged with the rail 111 and supporting the seats 102. Due to the sliders 112 moving relative to the rail 111, the seats 102 move relative to the floor 103. In the present embodiment, the extension direction of the rail 111 coincides with the front-rear direction of the car, but the extension direction of the rail 111 does not have to coincide with the front-rear direction of the car. Namely, the extension direction of the rail 111 does not limit the mounting direction in the car. Also, in the present embodiment, a pair of electric slide rails 101 are provided to be laterally spaced from each other. Since the left and right electric slide rails 101 have the same configuration, one of the electric slide rails 101 will be described in the following.

The rail 111 is joined to the floor 103. The rail 111 extends in the front-rear direction from a front end portion 111A to a rear end portion 111C. In the present embodiment, two sliders 112 are provided one behind the other on the rail 111. In the following, the slider 112 provided at the front is defined as a first slider, and the slider 112 provided at the rear is defined as a second slider. The first slider is configured to be movable from the front end portion 111A of the rail 111 to the central portion of the same in the front-rear direction. The second slider is configured to be movable from the rear end portion 111C of the rail 111 to the central portion of the same in the front-rear direction.

In the following, a region in which the movable range R1 of the first slider and the movable range R2 of the second slider overlap is defined as a lap region LR, and a part of the rail 111 corresponding to the lap region LR is defined as a lap portion 111B. Namely, the rail 111 includes the front end portion 111A in which the first slider is movable, the rear end portion 111C in which the second slider is movable, and the lap portion 111B which is provided between the front end portion 111A and the rear end portion 111C and in which the first slider and the second slider are movable. In the present embodiment, the lap portion 111B coincides with the central portion of the rail 111. Since the front end portion 111A and the rear end portion 111C of the rail 111 have the same configuration, the front end portion 111A and the lap portion 111B of the rail 111 will be described in the following, and the description of the rear end portion 111C will be omitted.

### <Front End Portion>

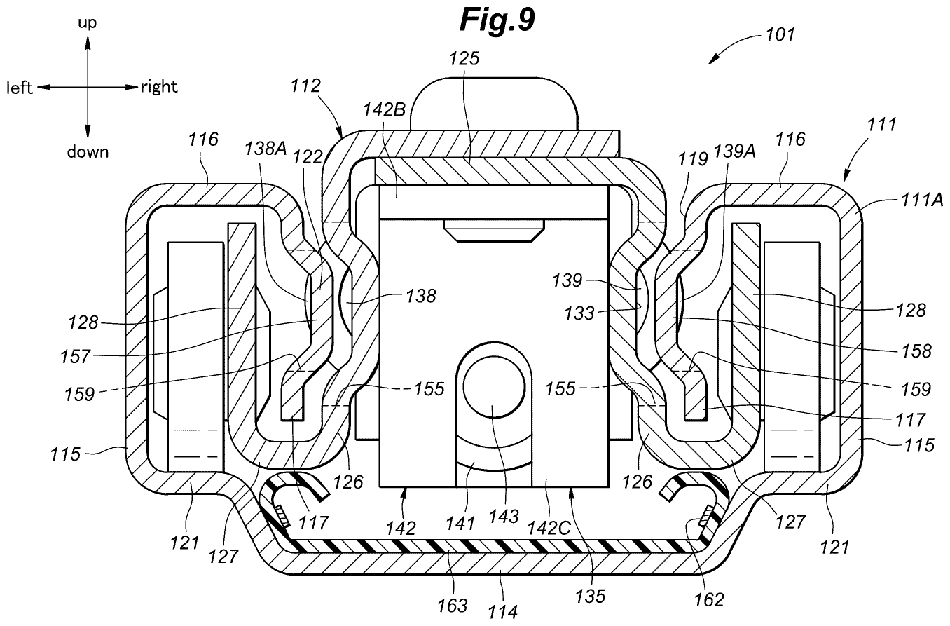

As shown in FIG. 9, the rail 111 has a channel-shaped cross section. Specifically, the rail 111 includes a rail bottom wall 114 having vertically facing surfaces, left and right rail outer side walls 115 extending upward from the left and right edges of the rail bottom wall 114 and having laterally facing surfaces, left and right rail upper walls 116 extending from the upper ends of the left and right rail outer side walls 115 in directions toward each other and having vertically facing surfaces, and left and right rail inner side walls 117 respectively extending downward from the inner ends of the left and right rail upper walls 116 and having laterally facing surfaces. The left and right rail inner side walls 117 correspond to the first side wall and the second side wall of the claims.

The rail bottom wall 114, the left and right rail outer side walls 115, the left and right rail upper walls 116, and the left and right rail inner side walls 117 each extend in the front-rear direction. The left and right rail outer side walls 115 extend parallel to each other and perpendicular to the rail bottom wall 114 and so do the left and right rail inner side walls 117. The lower ends of the left and right rail inner side walls 117 are spaced from the rail bottom wall 114. The rail 111 has, in the upper portion thereof, a rail opening 119 extending in the front-rear direction. The rail opening 119 is defined by the left and right rail inner side walls 117. The rail 111 is preferably formed by press forming a metal plate. The left and right edge portions of the rail bottom wall 114 may have step portions 121 that are raised upward. The left and right step portions 121 extend in the front-rear direction, and their upper surfaces are formed to be flat.

The left and right rail inner side walls 117 are respectively formed with protrusions 122 that protrude in directions toward each other and extend in the front-rear direction. Each of the left and right protrusions 122 is preferably formed to have an arc-shaped or trapezoidal cross section. Each protrusion 122 is preferably disposed at a vertically intermediate portion of the corresponding rail inner side wall 117. The upper end portions and the lower end portions of the left and right rail inner side walls 117 are disposed on the laterally outer sides of the corresponding protrusions 122.

### <Lap Portion>

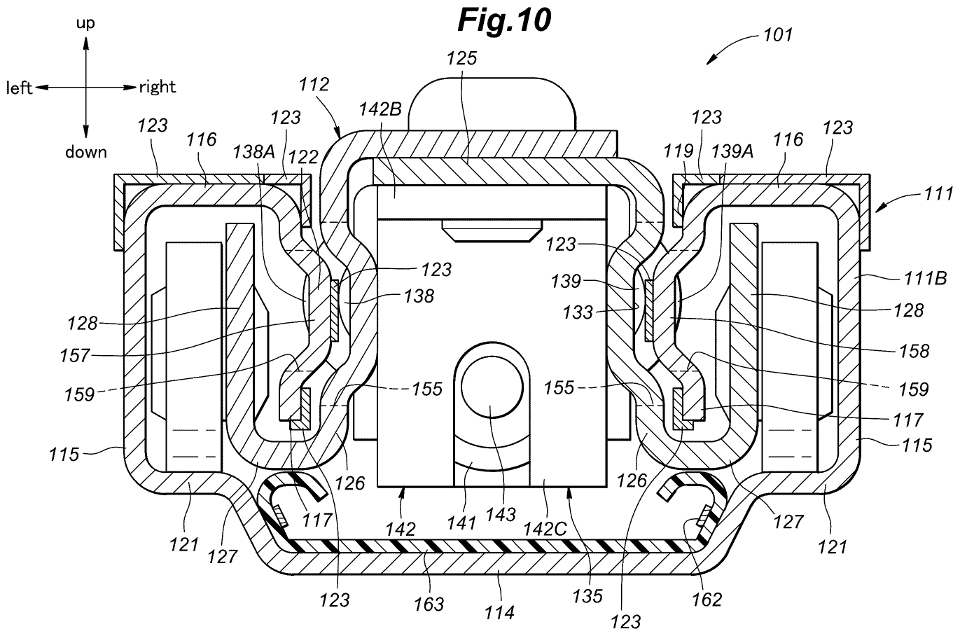

FIG. 10 is a sectional view of the rail 111 in the lap portion 111B. In the present embodiment, the form of the lap portion 111B differs from that of the front end portion 111A in that the lap portion 111B is provided with reinforcement structures 123. The other forms are the same as those of the front end portion 111A, and thus, they will be denoted by the same reference signs and the description thereof will be omitted.

Each reinforcement structure 123 is a metal member formed in a plate shape. The reinforcement structures 123 are preferably provided on the rail 111 by welding, for example. Some reinforcement structures 123 may be formed in a flat plate shape and be provided on the left and right protrusions 122. Such reinforcement structures 123 are preferably provided along the inner side surfaces of the left and right protrusions 122 that oppose each other. Also, some reinforcement structures 123 may have an L-shaped cross section and be provided on the left and right rail inner side walls 117. Such a reinforcement structure 123 is preferably provided along the lower portion and the inner side surface of the rail inner side wall 117 on each side. Also, some reinforcement structures 123 may have an L-shaped cross section and be provided on the left and right rail upper walls 116. Such a reinforcement structure 123 is preferably provided along the upper surface of the rail upper wall 116 and the inner side surface of the rail inner side wall 117 on each side. Such a reinforcement structure 123 is also preferably provided along the upper surface of the rail upper wall 116 and the outer side surface of the rail outer side wall 115 on each side. Further, some reinforcement structures 123 may have a U-shaped cross section, and such a reinforcement structure is preferably provided along the inner side surface of the rail upper wall 116, the upper surface of the rail upper wall 116, and the outer side surface of the rail outer side wall 115 on each side.

Preferably, the reinforcement structures 123 are provided on the rail 111 at symmetrical positions with respect to the left-right direction. The rail 111 may be provided with a pair of reinforcement structures 123 or multiple sets of reinforcement structures 123 at bilaterally symmetrical positions. Due to the reinforcement structures 123 provided, the stiffness of the lap portion 111B improves. Therefore, the rail 111 can be made hard to bend in the lap region LR.

In another embodiment, instead of being provided with the reinforcement structure 123, the lap portion 111B is preferably made of a heat-treated steel plate. For example, the lap portion 111B is preferably made of a steel plate having hardness and toughness enhanced by tempering.

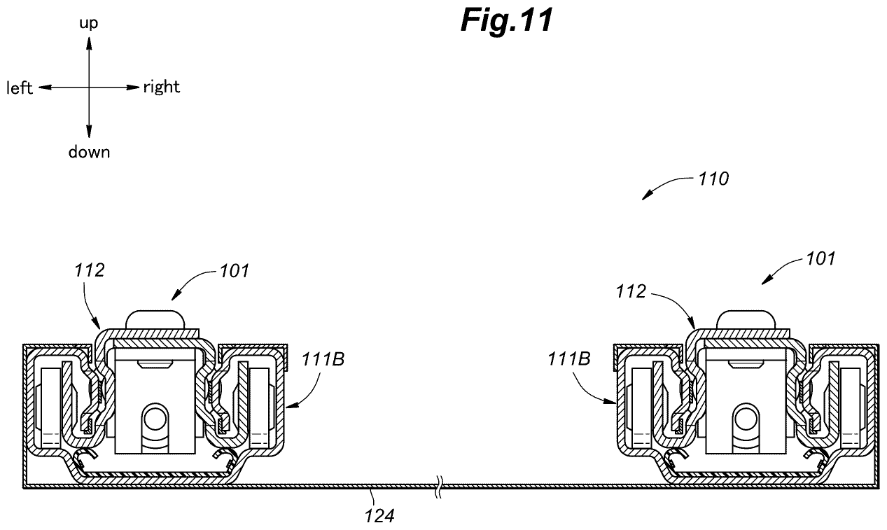

Also, as shown in FIG. 11, the lap portions 111B of the left and right electric slide rails 101 may be laterally connected by a coupling member 124. The coupling member 124 is preferably made of a metal member. The coupling member 124 can enhance the stiffness of the slide rail device 110.

As shown in FIGS. 9 and 10, the slider 112 includes a plate-shaped base portion 125 having vertically facing surfaces and positioned at the open end of the rail opening 119, left and right slider inner side walls 126 extending toward the rail bottom wall 114 or downward from the left and right side edges of the base portion 125, left and right slider lower walls 127 respectively extending laterally outward from the lower ends of the left and right slider inner side walls 126, and left and right slider outer side walls 128 extending upward from the laterally outer ends of the left and right slider lower walls 127. The left and right slider inner side walls 126 correspond to the third side wall and the fourth side wall of the claims. The base portion 125, the left and right slider inner side walls 126, the left and right slider lower walls 127, and the left and right slider outer side walls 128 extend in the front-rear direction.

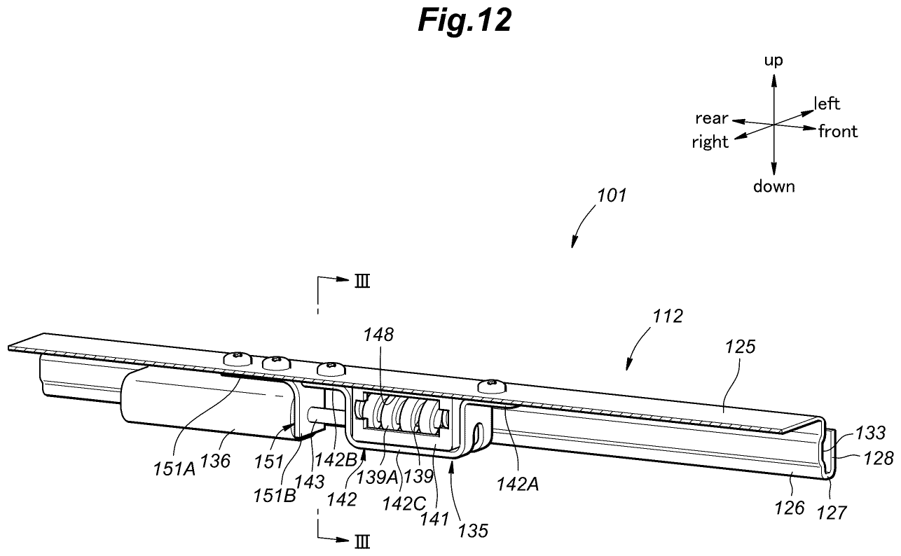

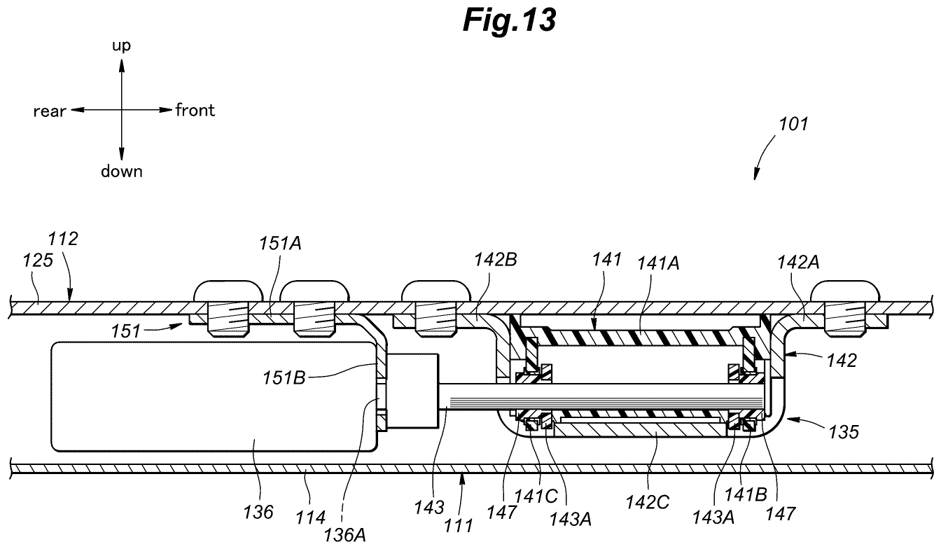

The slider 112 is formed by the base portion 125 and the left and right slider inner side walls 126 in a channel shape that opens toward the rail bottom wall 114 or downward. As shown in FIGS. 12 and 13, a screw assembly 135 and an electric motor 136 are supported on the lower surface of the base portion 125. The screw assembly 135 includes screw members 138, 139 supported by the slider 112 to be rotatable about an axis extending in the front-rear direction. The electric motor 136 is supported by the slider 112 and rotates the screw members 138, 139.

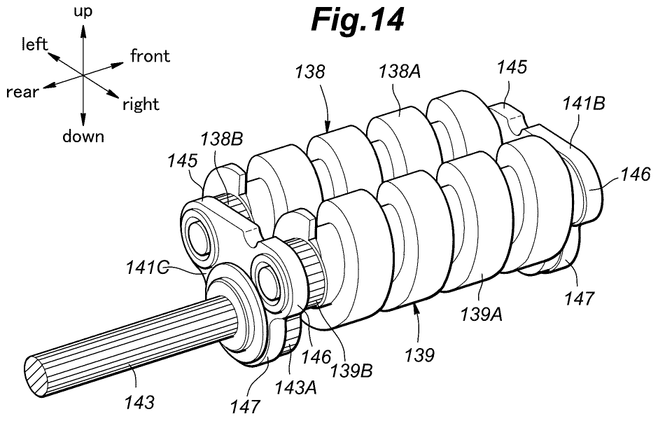

As shown in FIGS. 12 and 14, in the present embodiment, the screw members 138, 139 include a first screw member 138 and a second screw member 139. In another embodiment, the screw assembly 135 may include a single screw member. The first screw member 138 and the second screw member 139 are respectively provided with screw threads 138A, 139A on the outer peripheral surface of an intermediate part thereof with respect to the longitudinal direction. The number of screw threads 138A, 139A is preferably determined by the size of the electric slide rail 101 and the required strength in the longitudinal direction of the electric slide rail 101. For example, when it is desired to increase the required strength, it is preferable to increase the number of screw threads 138A, 139A. The screw assembly 135 includes a gear case 141 that rotatably supports the first screw member 138 and the second screw member 139 and a first bracket 142 for supporting the gear case 141 on the slider 112.

As shown in FIGS. 12 to 14, the gear case 141 is formed in the shape of a rectangular box elongated in the front-rear direction. The gear case 141 rotatably supports the first screw member 138, the second screw member 139, and a drive shaft 143 connected to a rotary shaft 136A of the electric motor 136. The first screw member 138, the second screw member 139, and the drive shaft 143 each extend in the front-rear direction, and are arranged in parallel with each other in the gear case 141. The gear case 141 includes a box-shaped outer case 141A forming an outer shell, and a front support member 141B and a rear support member 141C supported by the front end and the rear end of the outer case 141A, respectively. The front support member 141B is provided with a first bearing part 145 rotatably supporting the front end of the first screw member 138, a second bearing part 146 rotatably supporting the front end of the second screw member 139, and a third bearing part 147 rotatably supporting the drive shaft 143. The rear support member 141C is provided with a first bearing part 145 rotatably supporting the rear end of the first screw member 138, a second bearing part 146 rotatably supporting the rear end of the second screw member 139, and a third bearing part 147 rotatably supporting the drive shaft 143.

The first screw member 138 is disposed along the left side of the gear case 141, and the second screw member 139 is disposed along the right side of the gear case 141. The drive shaft 143 is positioned under an intermediate region between the first screw member 138 and the second screw member 139. The drive shaft 143 has a drive gear 143A located in the gear case 141. The first screw member 138 has a first gear 138B that meshes with the drive gear 143A. The second screw member 139 has a second gear 139B that meshes with the drive gear 143A. The drive gear 143A, the first gear 138B, and the second gear 139B may each consist of a spur gear. When the drive shaft 143 rotates, the first screw member 138 and the second screw member 139 rotate in the same direction as each other. The first gear 138B and the second gear 139B may be symmetrical to each other.

The gear case 141 has case openings 148 for exposing the first screw member 138 and the second screw member 139 on the respective sides. The screw threads 138A of the first screw member 138 pass through the case opening 148 formed on the left side of the gear case 141 and project to the left. Similarly, the screw threads 139A of the second screw member 139 pass through the case opening 148 formed on the right side of the gear case 141 and project to the right. The case openings 148 are formed in the outer case 141A.

The first bracket 142 extends in the front-rear direction and has a first joining part 142A provided at the front end thereof and a second joining part 142B provided at the rear end thereof. The first bracket 142 is joined to the lower surface of the base portion 125 of the slider 112 at the first joining part 142A and the second joining part 142B. The first bracket 142 has a support part 142C extending from the first joining part 142A to the second joining part 142B. The first bracket 142 is preferably a one-piece metal member including the first joining part 142A, the second joining part 142B, and the support part 142C.

The support part 142C includes a portion located below the first joining part 142A and the second joining part 142B. Due to the support part 142C, the first bracket 142 forms a closed structure in cooperation with the base portion 125. The gear case 141 is disposed between the base portion 125 of the slider 112 and the support part 142C. The first bracket 142 is formed by bending a metal plate. The first joining part 142A extends out forward from the front portion of the gear case 141, and the second joining part 142B extends out rearward from the rear portion of the gear case 141. The first joining part 142A and the second joining part 142B are preferably fastened to the base portion 125 by using fastening members such as screws and rivets. The distance between the fastening points of the first joining part 142A and the second joining part 142B is set to be greater than the front-rear length of the gear case 141.

Behind the first bracket 142, a second bracket 151 for supporting the electric motor 136 on the base portion 125 of the slider 112 is provided. The second bracket 151 has a joining part 151A joined to the base portion 125 and a support part 151B extending from the joining part 151A away from the base portion 125 or downward. The support part 151B extends orthogonally to the joining part 151A so that the second bracket 151 is formed in an L shape. The electric motor 136 is joined to the support part 151B at one end thereof. In the present embodiment, the electric motor 136 is disposed under the joining part 151A, and the second bracket 151 supports the end portion of the electric motor 136 on the side of the screw members 138, 139 in the manner of a cantilever.

The rear end of the drive shaft 14 projects rearward from the rear support member 141C of the gear case 141, and extends rearward to pass through a through hole formed in the first bracket 142. The rotary shaft 136A of the electric motor 136 is connected to the rear end of the drive shaft 143. The rotary shaft 136A and the drive shaft 143 are preferably joined to each other by coupling. Alternatively, the rotary shaft 136A and the drive shaft 143 may have fitting parts that are configured to engage with each other. The rotary shaft 136A of the electric motor 136 and the drive shaft 143 are arranged on the same straight line. The electric motor 136 is formed in a cylindrical shape and extends in the front-rear direction.

The screw assembly 135, the electric motor 136, the first bracket 142, and the second bracket 151 are disposed under the base portion 125 and between the left and right slider inner side walls 126. The left and right slider inner side walls 126 are each provided with a slider opening 155 located at a position corresponding to the screw assembly 135. The slider openings 155 are formed in recessed parts 133 of the slider inner side walls 126. The left parts of the screw threads 138A of the first screw member 138 pass through the case opening 148 on the left side of the gear case 141 and the slider opening 155 on the left slider inner side wall 126, and projects to the left of the left slider inner side wall 126. Similarly, the right parts of the screw threads 139A of the second screw member 139 pass through the case opening 148 on the right side of the gear case 141 and the slider opening 155 on the right slider inner side wall 126, and project to the right of the right slider inner side wall 126.

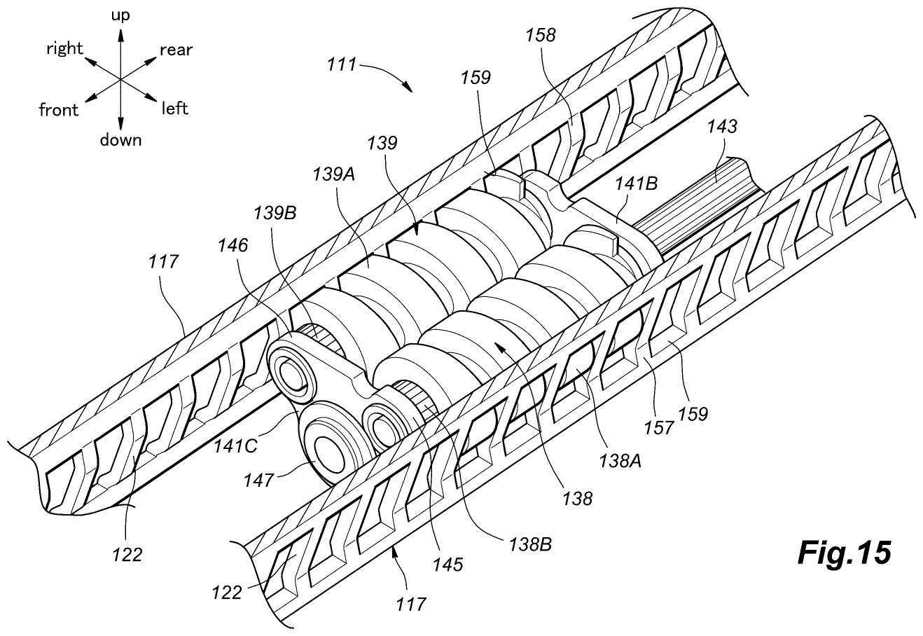

As shown in FIG. 15, the rail 111 is formed with screw engaging portions 157, 158 extending in the front-rear direction and engaging with the screw members 138, 139, respectively. FIG. 15 shows only the rail inner side walls 117 of the rail 111. The screw engaging portions 157, 158 include a first screw engaging portion 157 formed on the left rail inner side wall 117 and engaging with the screw threads 138A of the first screw member 138, and a second screw engaging portion 158 formed on the right rail inner side wall 117 and engaging with the screw threads 139A of the second screw member 139. The first screw engaging portion 157 and the second screw engaging portion 158 are formed on the protrusions 122 of the corresponding rail inner side walls 117. The first screw engaging portion 157 and the second screw engaging portion 158 each include a plurality of engagement holes 159 formed in the protrusion 122 to be arranged in the front-rear direction. The first screw member 138 engages, at the left parts of the screw threads 138A of the first screw member 138, with the engagement holes 159 of the first screw engaging portion 157, and rotates about an axis extending in the front-rear direction so as to move in the front-rear direction relative to the first screw engaging portion 157. Similarly, the second screw member 139 engages, at the right parts of the screw threads 139A of the second screw member 139, with the engagement holes 159 of the second screw engaging portion 158, and rotates about an axis extending in the front-rear direction so as to move in the front-rear direction relative to the second screw engaging portion 158.

The rotation of the electric motor 136 is transmitted to the first screw member 138 and the second screw member 139 via the rotary shaft 136A, the drive shaft 143, the drive gear 143A, the first gear 138B or the second gear 139B as the case may be. As a result, the first screw member 138 and the second screw member 139 rotate in the same direction. When the first screw member 138 and the second screw member 139 rotate, the first screw member 138 and the second screw member 139 move in the front-rear direction relative to the first screw engaging portion 157 and the second screw engaging portion 158 so that the slider 112 moves in the front-rear direction relative to the rail 111.

As shown in FIGS. 8 to 10, the electric slide rail 101 includes a power feeding device for supplying electric power to the electric motor 136. The power feeding device includes electrically conductive strips 162 extending in the front-rear direction inside the rail 111 and connected to a power supply 168, an electrically insulating plate 163 provided between the rail 111 and the electrically conductive strips 162, and electrically conductive contact terminals provided on the electric motor 136 to slidably contact the electrically conductive strips 162. In the present embodiment, the electrically insulating plate 163 is provided on the upper surface of the rail bottom wall 114, and the electrically conductive strips 162 are provided on the upper surface of the electrically insulating plate 163. The electrically conductive strips 162 are strip-shaped metal plates, are provided as a pair, one on the left and the other on the right, and each extend in the front-rear direction. The left and right electrically conductive strips 162 are arranged along the left and right side edges of the electrically insulating plate 163 extending in the front-rear direction, respectively.

The power feeding device is connected to the power supply 168 via the control device 166. The control device 166 is provided on the floor 103, for example. The control device 166 is an electronic control unit and is connected to the power supply 168, the left and right electrically conductive strips 162 of each electric slide rail 101, and an operation switch 167. The operation switch 167 is provided with a button corresponding to forward movement and a button corresponding to backward movement. The control device 166 adjusts the electric power supplied to the electrically conductive strips 162 according to the signal from the operation switch 167 and controls the rotational direction and the rotation amount of the electric motor 136. Thus, by operating the operation switch 167, the operator can activate the electric slide rail 101 and move the vehicle seat 102 in the front-rear direction relative to the floor 103. In another embodiment, the electric motor 136 may be controlled by a wireless signal from a wireless device, independent from the electric power supplied by the electrically conductive strips 162.

Next, control of the slide rail device 110 by the control device 166 will be described. In the present embodiment, the control device 166 executes the following seat control process when the electric motor 136 corresponding to the first seat starts rotating and the first slider starts moving.

In S1 of the seat control process, the control device 166 acquires the distance d between the rear end of the seatback 105 of the first seat and the front end of the seat cushion 104 of the second seat based on the detection result of the distance sensor 106. Upon completion of the acquisition of the distance d, the control device 166 executes S2.

In S2, the control device 166 determines whether the distance d acquired in S1 is greater than or equal to a predetermined threshold a. When the distance d is greater than or equal to the predetermined threshold a, the control device 166 executes S1 again. When the distance d is not greater than or equal to the predetermined threshold a, the control device 166 executes S3.

In S3, the control device 166 stops the movement of the first slider. Namely, by stopping the supply of electric power from the power feeding device, the control device 166 stops the rotation of the electric motor 136 and thereby stops the movement of the first slider. As a result, the movement of the first seat stops. When S3 is completed, the control device 166 ends the seat control process.

By executing the seat control process as above, the control device 166 can maintain the distance d between the first seat and the second seat to be greater than or equal to the predetermined threshold a. Thus, the interference between the first seat and the second seat can be prevented.

Next, the effects of the slide rail device 110 according to the present embodiment will be described. Since the stiffness of the rail 111 in the lap portion 111B is higher compared to the stiffness of the rail 111 in the both end portions (namely, the front end portion 111A and the rear end portion 111C), the lap portion 111B becomes hard to bend. Therefore, in the slide rail device 110, the first slider and the second slider can slidingly move in the lap portion 111B smoothly. Also, generation of abnormal noise when the first slider and the second slider slidingly move in the lap portion 111B can be suppressed.

Further, the reinforcement structures 123 are provided along at least one of the upper surfaces of the left and right rail upper walls 116, the outer side surfaces of the rail outer side walls 115, and the inner side surfaces of the rail inner side walls 117. According to this configuration, the rail 111 can be reinforced from at least two directions, and thus, the stiffness of the rail 111 can be enhanced reliably.

### Fifth Embodiment

Next, a slide rail device 110 according to the fifth embodiment will be described. The slide rail device 110 according to the fifth embodiment differs from the slide rail device 110 according to the fourth embodiment in that the lap portion 111B is not provided with the reinforcement structures 123 and that the shape of the engagement holes 159 in the lap portion 111B is different. In the following, the shape of the engagement holes 159 will be described, and the configurations similar to those of the slide rail device 110 according to the fourth embodiment will be denoted by the same reference signs and the description thereof will be omitted. Further, the structure of the lap portion 111B according to the fifth embodiment is also the same as the structure of the front end portion 111A according to the fourth embodiment, and thus, the description thereof will be omitted.

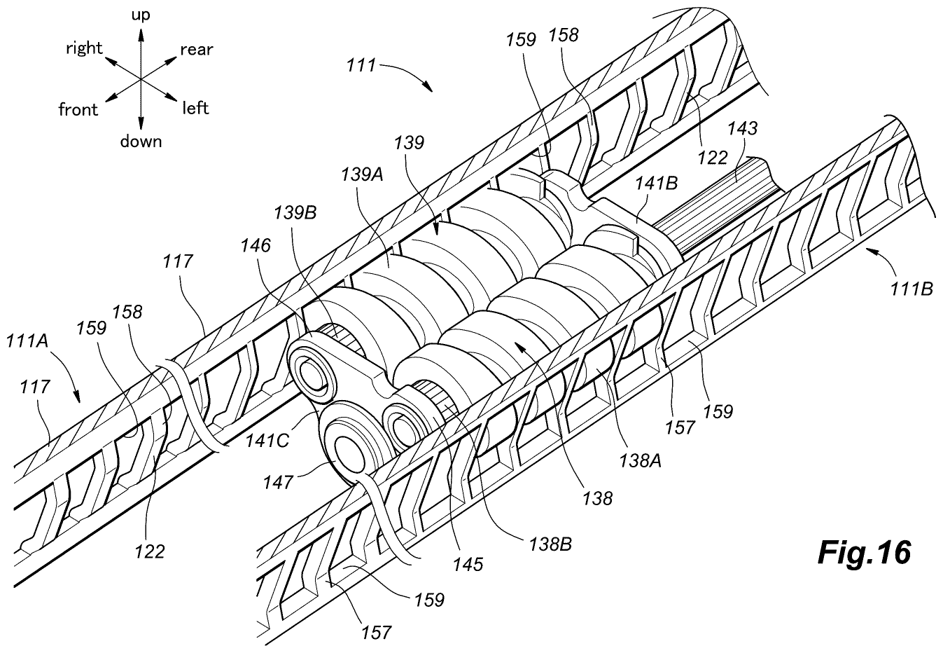

FIG. 16 shows the rail inner side walls 117 in the front end portion 111A and the lap portion 111B of the rail 111. The first screw engaging portion 157 and the second screw engaging portion 158 each include a plurality of engagement holes 159 formed in the protrusion 122 to be arranged in the front-rear direction. The engagement holes 159 provided in the lap portion 111B are each formed to have greater lengths in the front-rear direction and the up-down direction than the multiple engagement holes 159 provided in the front end portion 111A. Therefore, the engagement holes 159 in the lap portion 111B result in a greater gap at each engagement part of the engagement holes 159 with the first screw member 138 and the second screw member 139 than the engagement holes 159 in the front end portion 111A. Note that in another embodiment, the engagement holes 159 in the lap portion 111B may be formed such that one of the lengths in the front-rear direction and the up-down direction is greater than that of the engagement holes 159 provided in the front end portion 111A.

According to this configuration, by changing the size of the engagement holes 159, the degree of engagement of the engagement holes 159 with the first slider and the second slider can be reduced in the lap portion 111B. This allows the first slider and the second slider to slidingly move in the lap portion 111B smoothly. Also, variation of the dimensions of the slider 112 within tolerance can be dealt with.

In another embodiment, the engagement holes 159 in the lap portion 111B can be configured such that the degree of engagement with the first slider and the second slider the reduced by changing the angle at which each engagement hole 159 opens. For example, it is preferred if the length in the up-down direction of the engagement holes 159 in the lap portion 111B becomes longer from the outer side to the inner side of the lap portion 111B with respect to the width direction. Thereby, it is possible to reduce the degree of engagement of the engagement holes 159 with the first slider and the second slider while suppressing the reduction in the stiffness of the lap portion 111B.

### Sixth Embodiment

Next, a slide rail device 110 according to the sixth embodiment will be described. The slide rail device 110 according to the sixth embodiment differs from the slide rail device 110 according to the fourth embodiment in that the slide rail device 110 according to the sixth embodiment is applied to a car with three rows of seats. In the following, the configurations similar to those of the slide rail device 110 according to the fourth embodiment will be denoted by the same reference signs and the description thereof will be omitted.

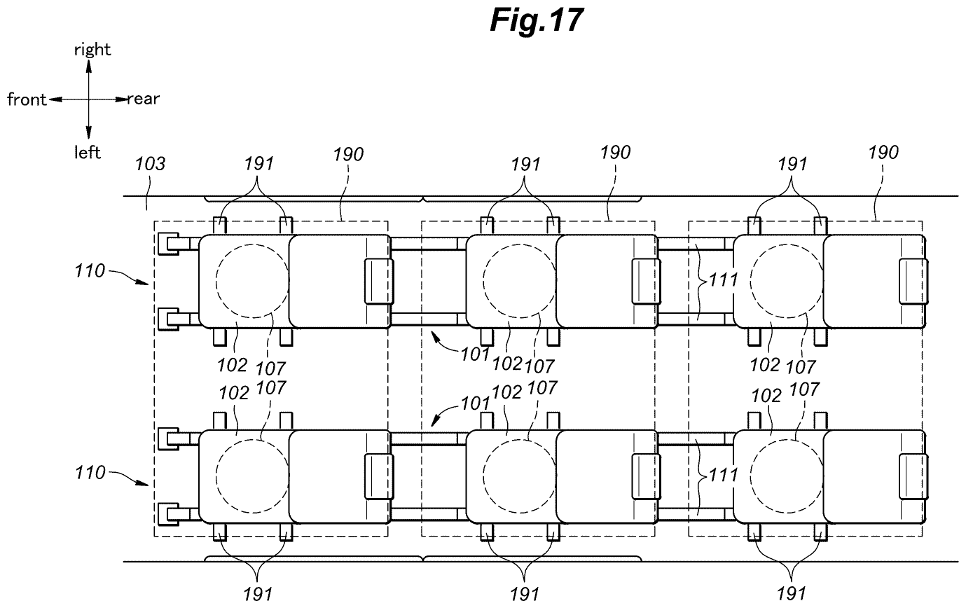

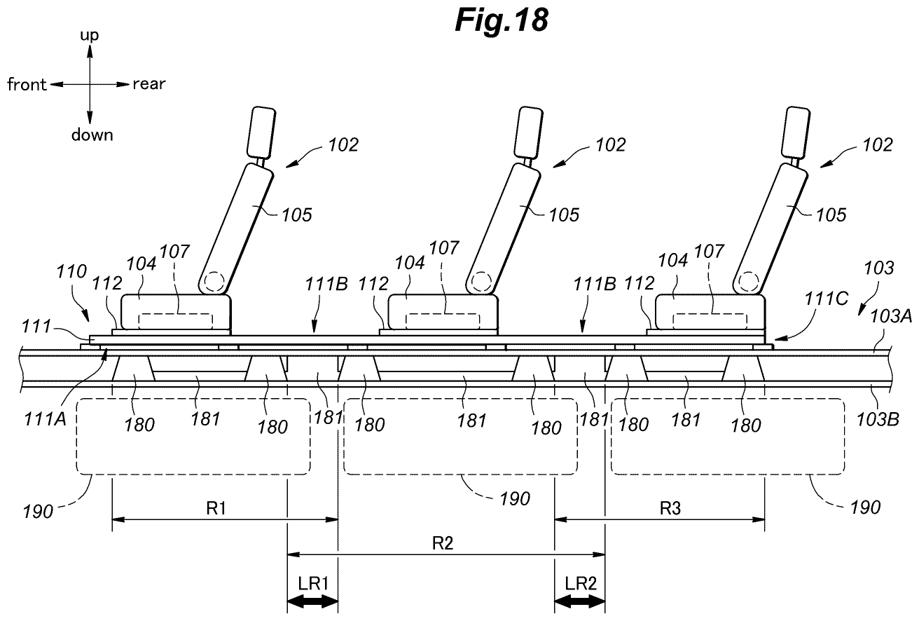

As shown in FIGS. 17 and 18, the floor 103 is provided with two slide rail devices 110. The two slide rail devices 110 are disposed to be laterally spaced from each other. The slide rail device 110 provided in a right side part of the car supports a first-row seat (first seat) used as the driver's seat, a second-row seat (second seat), and a third-row seat (third seat). The slide rail device 110 provided in a left side part of the car supports a first-row seat (first seat) used as the front passenger seat, a second-row seat (second seat), and a third-row seat (third seat).

Each rail 111 is provided with three sliders 112 arranged in the front-rear direction. In the following, the slider 112 corresponding to the first seat is defined as the first slider, the slider 112 corresponding to the second seat is defined as the second slider, and the slider 112 corresponding to the third seat is defined as the third slider.

The rail 111 includes a front end portion 111A (first rail portion) in which the first slider is movable, a lap portion 111B (hereinafter referred to as a first lap portion) which corresponds to a first lap region LR1 in which the movable range R1 of the first slider and the movable range R2 of the second slider overlap, a portion (second rail portion) in which only the second slider is movable, a lap portion 111B (hereinafter referred to as a second lap portion) which corresponds to a second lap region LR2 in which the movable range R2 of the second slider and the movable range R3 of the third slider overlap, and a rear end portion 111C (third rail portion) in which the third slider is movable. The first lap portion and the second lap portion may have the same shape. The first lap portion and the second lap portion may have different lengths in the front-rear direction. For example, the length of the first lap portion in the front-rear direction may be longer than the length of the second lap portion in the front-rear direction.

In the present embodiment, the floor 103 includes an upper floor panel 103A to which the slide rail devices 110 are joined and a lower floor panel 103B extending in the front-rear and left-right directions below the upper floor panel 103A. Between the upper floor panel 103A and the lower floor panel 103B, multiple beams 180 extending laterally are provided.

The beams 180 are joined to the upper floor panel 103A and the lower floor panel 103B. The beams 180 are arranged in the front-rear direction, and each of them preferably has a substantially triangular cross section. Each beam 180 may be composed of a solid metal block or may be formed by joining metal plates. The multiple beams 180 may be arranged side by side in the front-rear direction to form a truss-shaped cross section.

In the present embodiment, the beams 180 are disposed at intervals in the front-rear direction. The beams 180 are provided in positions corresponding to the boundary between the first rail portion and the first lap portion, the boundary between the first lap portion and the second rail portion, the boundary between the second rail portion and the second lap portion, and the boundary between the second lap portion and the third rail portion. Between each two beams 180 that are adjacent to each other in the front-rear direction, a floor reinforcement member 181 is provided.

The floor reinforcement members 181 are made of metal material and extend in the front-rear direction and laterally. The floor reinforcement members 181 are preferably provided in a part corresponding to an area between the pair of rails 111 with respect to the left-right direction. The floor reinforcement members 181 preferably include portions corresponding to the first rail portion, the first lap portion, the second rail portion, the second lap portion, and the third rail portion with respect to the front-rear direction.

Compared to the part of the floor reinforcement member 181 corresponding to the first rail portion, the second rail portion, or the third rail in the front-rear direction, the part of the floor reinforcement member 181 corresponding to the first lap portion or the second lap portion in the front-rear direction has a greater thickness in the up-down direction. The part of the floor reinforcement member 181 corresponding to the first lap portion or the second lap portion preferably connects the lower surface of the upper floor panel 103A and the upper surface of the lower floor panel 103B to each other.

Due to such a configuration, the stiffness of the floor 103 in portions corresponding to the lap regions LR1, LR2 can be enhanced. Therefore, the lap portions 111B can be made hard to bend.

Further, multiple batteries 190 for feeding power to the car may be provided under the lower floor panel 103B. The battery 190 may be disposed to correspond to the first rail portion, the second rail portion, and the third rail portion with respect to the front-rear direction. The batteries 190 may be also disposed in regions corresponding to the first lap portion and the second lap portion with respect to the front-rear direction.

Also, each seat 102 may be provided to be slidingly movable in the left-right direction along lateral rails 191 that extend laterally.

Concrete embodiments have been described in the foregoing, but the present invention can be modified in various ways without being limited to the above embodiments.

Though the first slider and the second slider were driven by the electric motors 136, one of the first slider and the second slider may be driven by the electric motor 136 and the other of the first slider and the second slider may be manually operated to slide.

Each seat 102 may be provided with a rotation angle sensor for detecting a rotation angle of the seat 102. The control device 166 may determine the rotational direction of the electric motor 136 in the seat control process based on the detection result of the rotation angle sensor. For example, the control device 166 may reverse the rotational direction of the electric motor 136 when the rotation angle of the seat 102 is 180°. Also, the control device 166 may change the threshold a in the seat control process based on the detection result of the rotation angle sensor. For example, the control device 166 may set the threshold α to 0 when the rotation angle of the seat 102 is 180°. Thereby, a seat arrangement in which the seat cushions 104 of the two seats 102 side by side in the front-rear direction are connected may be realized. In this case, preferably, the distance sensors 106 are provided at the front end of the seat cushion 104 and the headrest of the seat 102 in addition to the rear end of the seat cushion 104.

Each seat 102 may be provided with a reclining device for pivoting the seatback 105 relative to the seat cushion 104 and a reclining angle sensor for detecting a reclining angle of the seatback 105. The control device 166 may perform the seat control process based on the detection result of the reclining angle sensor.

Each seat 102 may be provided with an ottoman pivotably connected to the front end of the seat cushion 104 and a rotation angle sensor for detecting a rotation angle of the ottoman. The control device 166 may perform the seat control process based on the rotation angle of the ottoman detected by the rotation angle sensor.

When manufacturing the rail 111, the front end portion 111A, the rear end portion 111C, and the lap portion 111B may be manufactured separately and thereafter they may be assembled. Alternatively, after preparation of a single rail 111, the reinforcement structures 123 may be provided on a portion corresponding to the lap region LR so that the rail 111 has the front end portion 111A, the rear end portion 111C, and the lap portion 111B. After the preparation of a single rail 111, the size of the engagement holes 159 in the portion corresponding to the lap region LR may be changed so that the rail 111 has the front end portion 111A, the rear end portion 111C, and the lap portion 111B.

### Seventh Embodiment

The seat 102 supported by the slide rail device 110 according to the fourth embodiment is provided with the rotating device 107. In the present embodiment, a mounting structure between the rotating device 107 and the slide rail device 110 will be described. In the following, the configurations similar to those of the slide rail device 110 according to the fourth embodiment will be denoted by the same reference signs and the description thereof will be omitted.

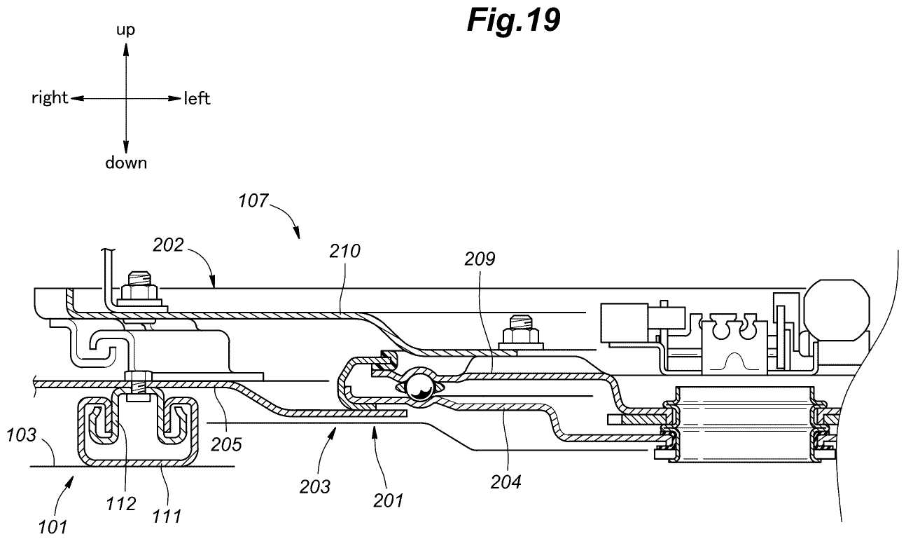

As shown in FIG. 19, the rotating device 107 is provided above a pair of left and right electric slide rails 101 (only one of the electric slide rails 101 is shown) and below the seat cushion 104 (FIG. 8). The rotating device 107 includes a base part 201 and a rotating part 202.

The base part 201 includes a base plate 203 having vertically facing surfaces and extending laterally. In the present embodiment, the base plate 203 includes a disc-shaped center plate 204 provided at the center in the left-right direction and side plates 205 respectively joined to the left edge and the right edge of the center plate 204. The base plate 203 is preferably formed of a metal plate. In another embodiment, the center plate 204 and the left and right side plates 205 may be formed of a continuous metal plate.

The left and right end portions of the base plate 203 pass above the electric slide rails 101 and extend more laterally outward than the left and right electric slide rails 101, respectively. The base plate 203 is joined to the sliders 112. The base plate 203 is supported by the slide rail devices 110 to be movable in the front-rear direction relative to the floor 103.

The rotating part 202 is provided on the seat cushion 104 (FIG. 8) and is rotatably supported by the base part 201. The rotating part 202 includes a rotary plate 209 rotatably supported on the upper surface of the base plate 203. The rotary plate 209 rotates relative to the base part 201 by being driven by an electric actuator (not shown in the drawings). Preferably, the rotation of the rotary plate 209 can be selectively prohibited by a rotation lock device (not shown in the drawings). Further, the rotating part 202 includes a fixing bracket 210 that joins the rotary plate 209 to a frame forming a skeleton of the seat cushion 104 (FIG. 8). The rotary plate 209 and the fixing bracket 210 are formed of metal plates. With the rotary plate 209 rotating relative to the base plate 203, the seat 102 (FIG. 8) rotates relative to the floor 103.

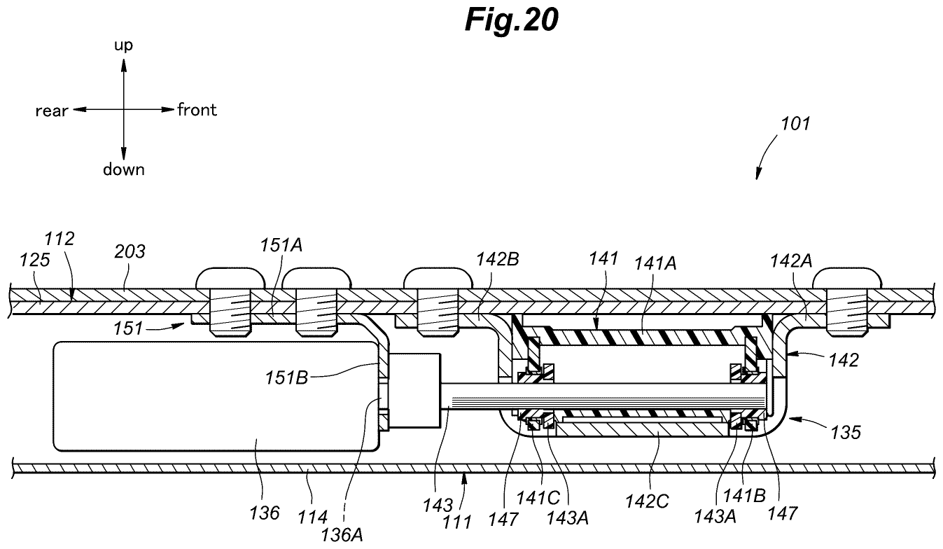

As shown in FIG. 20, the base plate 203 is joined to the base portion 125 of the slider 112. In the present embodiment, the base plate 203 is joined to a part of the base portion 125 above the drive gear 143A and the electric motor 136. Also, in the present embodiment, the base plate 203 is fastened to the slider 112 together with the first bracket 142 supporting the drive gear 143A and the second bracket 151 supporting the electric motor 136. Thereby, the stiffness of the base portion 125 for mounting the first bracket 142 and the second bracket 151 improves.

In another embodiment, the base plate 203 may be fastened to the slider 112 separately from the first bracket 142 and the second bracket 151. Also, the size of the rotating part 202 may be reduced so that the rotating part 202 may be provided between the left and right electric slide rails 101 with respect to the left-right direction.

### Eighth Embodiment

Next, a mounting structure between the rotating device 107 and the slide rail device 110 according to the eighth embodiment will be described. The mounting structure according to the eighth embodiment differs from the mounting structure according to the seventh embodiment with respect to the positions where the rotating device 107 and the slide rail device 110 are joined to each other. In the following, the positions where the rotating device 107 and the slide rail device 110 are joined to each other will be described, and the configurations similar to those of the mounting structure according to the seventh embodiment will be denoted by the same reference signs and the description thereof will be omitted.

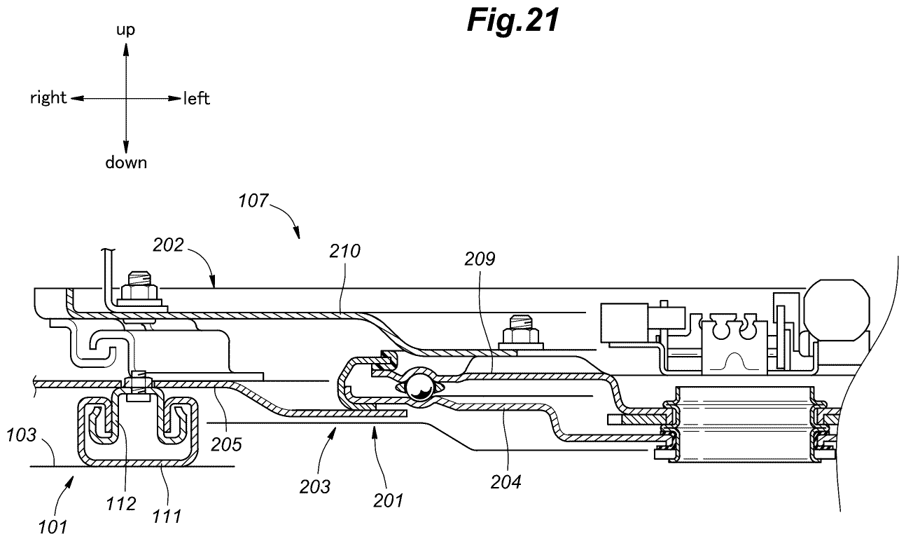

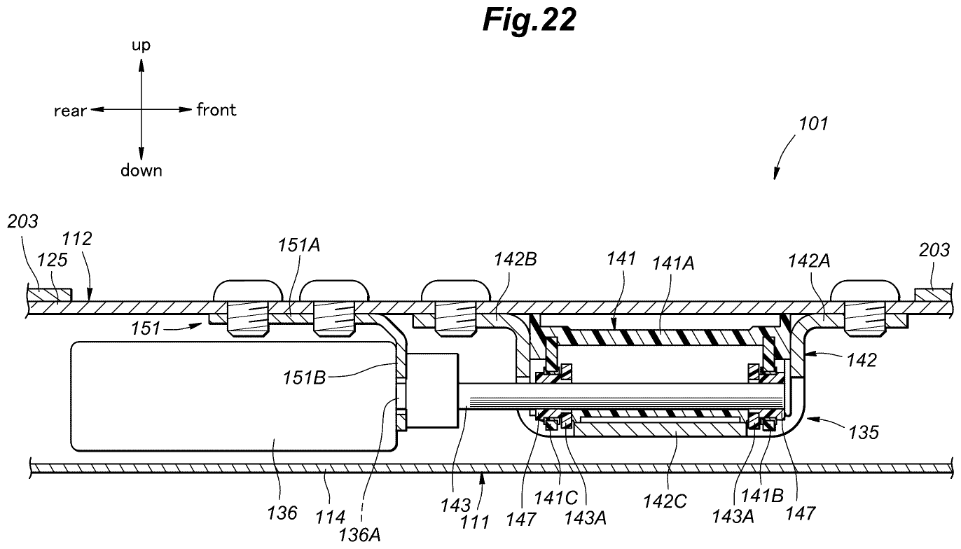

As shown in FIGS. 21 and 22, the base plate 203 is joined to parts of the base portion 125 avoiding an area above the drive gear 143A and the electric motor 136. Thereby, it is possible to suppress reduction in the stiffness of the slider 112. Also, the worker can check the drive gear 143A and the electric motor 136 from above.

In the present embodiment, the base plate 203 is fastened to the slider 112 separately from the first bracket 142 and the second bracket 151. In another embodiment, the base plate 203 may be fastened to the slider 112 together with the first bracket 142 and the second bracket 151.

### Ninth Embodiment

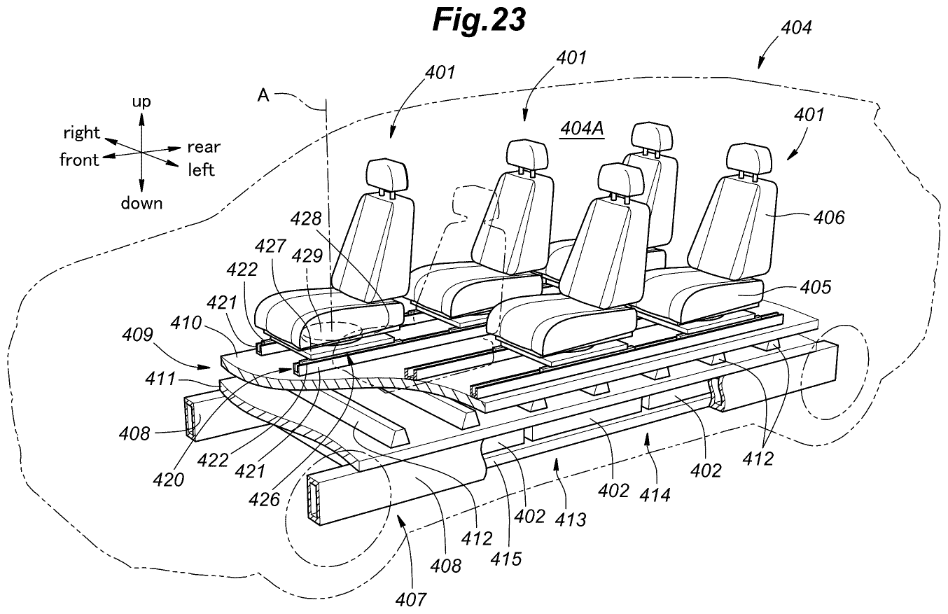

In the following, a mounting structure for car seats 401 according to the present invention will be described with reference to the drawings. As shown in FIG. 23, multiple car seats 401 are provided in a car cabin 404A of an electric car 404 which is driven by electric power supplied from batteries 402. Each car seat 401 includes a seat cushion 405 for supporting the buttocks of the occupant and a seatback 406 extending upward from a rear portion of the seat cushion 405 to support the back of the occupant. In the present embodiment, the car 404 is a minivan or the like and includes three rows of seats.

In the following, the car seats 401 will be simply referred to as the seats 401. Further, description will be made with the travel direction of the car 404 being defined as the front-rear direction, and the left-right and up-down directions being defined accordingly.

The car 404 includes a car frame 407 made of metal and forming a skeleton of the car 404. The car frame 407 includes a pair of left and right side sills 408 and a floor 409 provided on the left and right side sills 408. The left and right side sills 408 each extend in the front-rear direction and are disposed to be laterally spaced from each other. The left and right side sills 408 form a lower portion of the car 404.

The floor 409 is joined to each of the left and right side sills 408. The floor 409 includes an upper floor panel 410 and a lower floor panel 411 that oppose each other, and multiple beams 412 provided between the upper floor panel 410 and the lower floor panel 411.

Each of the upper floor panel 410 and the lower floor panel 411 is made of metal and has a plate shape. The upper floor panel 410 and the lower floor panel 411 are disposed to be spaced from each other such that their surfaces face in the up-down direction. Preferably, the lower floor panel 411 is joined to the upper sides of the left and right side sills 408 by welding or the like.

Note that in another embodiment, multiple cross members not shown in the drawings may be provided below the lower floor panel 411 to be connected to the left and right side sills 408. Each cross member is made of metal and has a plate shape, and the cross members are disposed to extend laterally and to be spaced from each other in the front-rear direction such that their surfaces face in the up-down direction. Due to the cross members, the stiffness of the side sills 408 improves. The lower surface of the lower floor panel 411 may be in contact with the upper surface of each of the cross members.

Each of the multiple beams 412 has a trapezoidal shape in cross-sectional view and extends laterally. The multiple beams 412 are disposed to be spaced from each other in the front-rear direction. Preferably, the lower surface of each of the multiple beams 412 is in contact with and joined to the upper surface of the lower floor panel 411. Also preferably, the upper surface of each of the multiple beams 412 is in contact with and joined to the lower surface of the upper floor panel 410. Thereby, the upper floor panel 410 is supported by each of the multiple beams 412.

Note that the shape of each of the multiple beams 412 is not particularly limited. For example, each of the multiple beams 412 may have a hollow rectangular shape in cross-sectional view. Alternatively, each of the multiple beams 412 may be a channel member having a concave shape in cross-sectional view.

In the car 404, a battery unit 413 including multiple batteries 402 is joined to each of the left and right side sills 408. Specifically, the battery unit 413 is provided under the floor 409. Each of the multiple batteries 402 has a rectangular cuboid shape and is provided in the car 404 such that the surfaces thereof face in the up-down direction. The battery unit 413 includes a battery support part 414 for supporting the batteries 402.

The battery support part 414 is composed of a pair of upper and lower plate-shaped members 415. Each plate-shaped member 415 is provided such that the surfaces thereof face in the up-down direction. The lower plate-shaped member 415 is joined to each of lower portions of the laterally inner sides of the left and right side sills 408. The upper plate-shaped member 415 is joined to each of upper portions of the laterally inner sides of the left and right side sills 408. Thereby, a space is defined between the lower plate-shaped member 415 and the upper plate-shaped member 415. The multiple batteries 402 are disposed in this space. In the present embodiment, three batteries 402 are supported by the battery support part 414. In this state, the upper surface of the upper plate-shaped member 415 of the battery support part 414 may be in contact with the lower surface of the lower floor panel 411.

Note that in another embodiment, each plate-shaped member 415 may have a hat shape with a recessed central portion in cross-sectional view. By disposing the upper and lower plate-shaped members 415 such that the recessed portions thereof oppose each other, a battery support part 414 having a space in the central portion may be formed. In this case, the left end portions of the plate-shaped members 415 contact each other. Similarly, the right end portions of the plate-shaped members 415 contact each other. The contacting left end portions are preferably joined to the lower side of the left side sill 408 and the contacting right end portions are preferably joined to the lower side of the right side sill 408 by means of bolts or the like not shown in the drawings.

Each of the multiple seats 401 is provided on the floor 409 via a slide rail device 420. The slide rail device 420 is a device for moving each of the seats 401 in the front-rear direction. In the present embodiment, the slide rail devices 420 are provided on the left and right. Each of the left and right slide rail devices 420 supports three seats 401 arranged in the front-rear direction. Thus, the car 404 is provided with three rows of seats.

The slide rail device 420 includes rails 421 provided on the upper floor panel 410 and multiple sliders 422 movably supported on the rails 421. Preferably, each rail 421 is formed by press forming a metal plate and has a channel-shaped cross section. The rails 421 extend in the front-rear direction such that the groove opening faces upward. Also, each of the left and right rails 421 is a long rail, and each rail 421 is provided with three sliders 422.

Each of the multiple sliders 422 is formed by fastening together multiple metal plates that are press-formed or roll-formed. In another embodiment, each slider 422 may be formed of a single metal plate that is press-formed or roll-formed. The length of each slider 422 in the front-rear direction is set to be smaller than the length of the rail 421 in the front-rear direction. Each slider 422 is provided with multiple wheels not shown in the drawings to be rotatable.

Each of the multiple sliders 422 is received in the groove of the corresponding rail 421 and is thereby connected thereto. At this time, an upper portion of each of the multiple sliders 422 protrudes upward from the groove opening of the corresponding rail 421. Also, when each of the multiple sliders 422 is received in the groove of the corresponding rail 421, each of the multiple wheels provided on the slider 422 contacts the bottom portion of the rail 421. Thereby, each of the multiple sliders 422 becomes movable in the front-rear direction relative to the corresponding rail 421.

Each of the multiple sliders 422 is joined to the corresponding seat 401. Thereby, when the slider 422 moves in the front-rear direction relative to the rail 421, the seat 401 joined to the slider 422 also moves in the front-rear direction.

Each seat 401 is provided with a rotating device 426 for rotating the seat 401 relative to the floor 409. The rotating device 426 may be a known device that includes a lower member 427 joined to the sliders 422, an upper member 428 supported by the lower member 427 to be rotatable about a rotation axis A, and a rotation drive mechanism 429 for rotating the upper member 428 relative to the lower member 427. The lower member 427 has a plate shape having vertically facing surfaces.

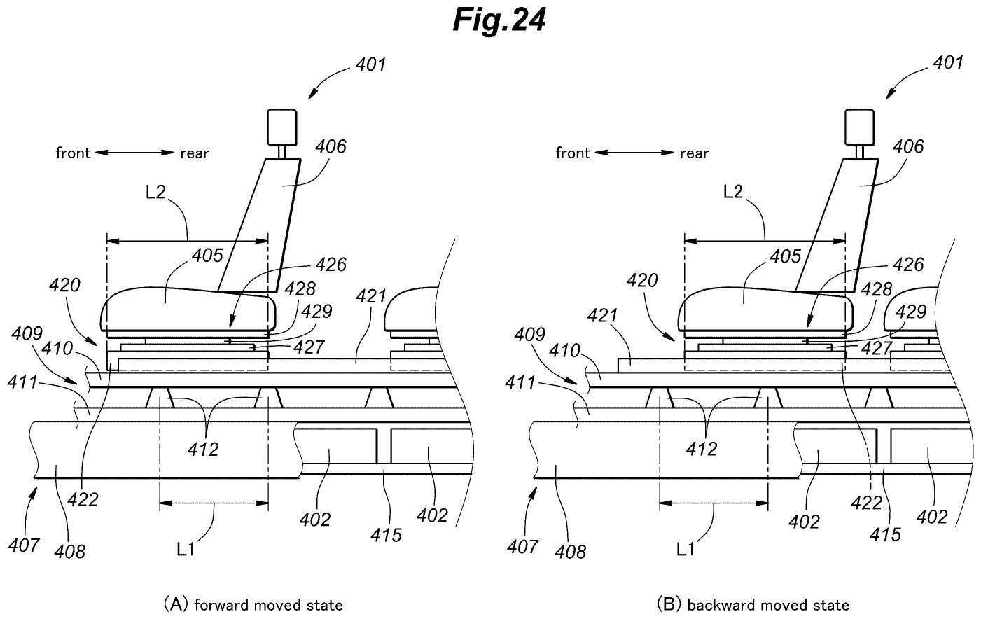

As shown in FIG. 24, each rail 421 is disposed to straddle the multiple beams 412 as seen from above. The spacing L1 between the multiple beams 412 is shorter than the length L2 of each of the multiple sliders 422.

For the sliders 422 that are adjacent to each other in the front-rear direction, at least one beam 412 is disposed in a section from the front end of the front slider 422 to the rear end of the rear slider 422 as seen in side view. More preferably, for the sliders 422 that are adjacent to each other in the front-rear direction, at least one beam 412 is disposed in a section from the rear end of the front slider 422 to the rear end of the rear slider 422 as seen in side view. Due to these, no matter what positions each seat 401 is in, each corresponding slider 422 overlaps with one of the multiple beams 412 as seen from above.

When each seat 401 is moved in the front-rear direction, a part of each corresponding slider 422 overlaps with at least one beam 412 as seen from above. For example, as shown in FIG. 24 (A), when the seat 401 is moved to a forward position, each corresponding slider 422 overlaps two beams 412 as seen from above. As shown in FIG. 24 (B), when the seat 401 is moved to a rearward position, each corresponding slider 422 overlaps with one beam 412 as seen from above. Thus, even when the seat 401 is moved, each corresponding slider 422 overlaps with one of the multiple beams 412 as seen from above.

With reference to FIG. 23 again, the mounting structure for the seats 401 is composed of the multiple seats 401 joined to the floor 409 via the slide rail device 420, the side sills 408 supporting the floor 409, and the battery unit 413 mounted to the side sills 408.

The rails 421 are connected to the upper floor panel 410 forming a part of the floor 409. The upper floor panel 410 is connected to the lower floor panel 411 via the multiple beams 412. At this time, each rail 421 is disposed to straddle the multiple beams 412 as seen from above. The lower floor panel 411 is joined to the upper sides of the left and right side sills 408. The battery unit 413 is joined to the lower sides of the left and right side sills 408. Due to these, the load of the battery unit 413 acts on the upper floor panel 410 via the left and right side sills 408, the lower floor panel 411, and the multiple beams 412. The upper floor panel 410 is joined to the lower floor panel 411 via the multiple beams 412. Thereby, the floor 409 becomes hard to bend downward. Namely, the upper floor panel 410 becomes hard to bend downward even when the load of the battery unit 413 acts on the floor 409 via the left and right side sills 408. This suppresses bending of the rails 421. Thus, the movement of the seats 401 becomes smooth.

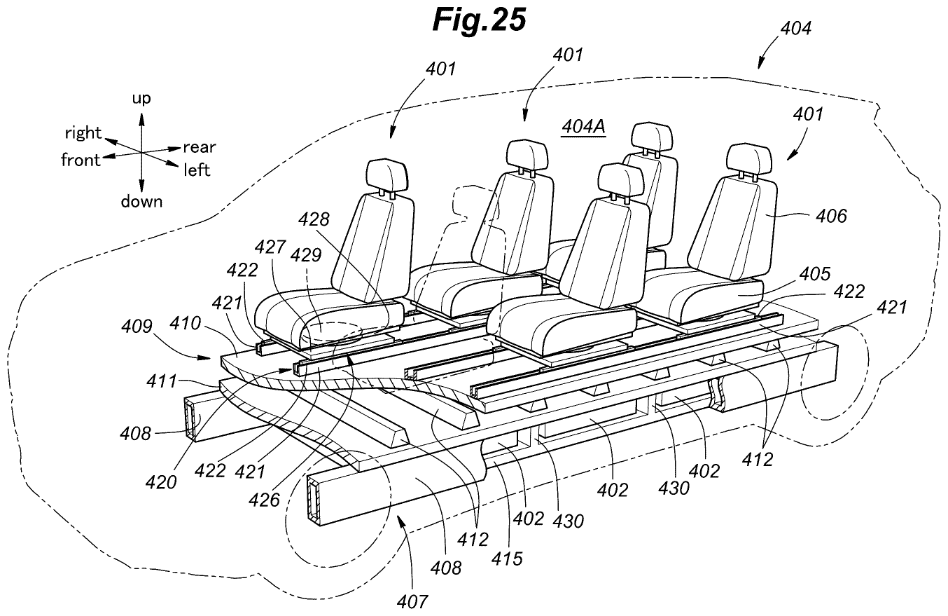

As shown in FIGS. 24 and 25, no matter what positions each seat 401 is in, each corresponding slider 422 overlaps with one of the multiple beams 412 as seen from above. In addition, even when the seat 401 is moved, each corresponding slider 422 overlaps with one of the multiple beams 412 as seen from above. Thus, due to the beams 412 overlapping with the sliders 422, the upper floor panel 410 becomes hard to bend downward even when a downward force such as the load of the seats 401 or the load of the occupants acts on the floor 409 via the seats 401. This also makes the rails 421 hard to bend, and the movement of the seats 401 becomes smooth.

### Tenth Embodiment

The mounting structure for the seats 401 according to the tenth embodiment differs from the mounting structure for the seats 401 according to the ninth embodiment with respect to only the configuration of the battery unit 413. The configurations similar to those of the mounting structure for the seats 401 according to the ninth embodiment will be denoted by the same reference signs and the description thereof will be omitted.

As shown in FIG. 25, the battery unit 413 is provided with multiple partition walls 430. The multiple partition walls 430 each has a plate shape and are disposed to be spaced in the front-rear direction such that the surfaces thereof face in the front-rear direction. Each of the multiple partition walls 430 is provided to partition the space defined by the pair of plate-shaped members 415 of the battery support part 414. In the present embodiment, two partition walls 430 are respectively disposed in spaces between the three batteries 402. The partition walls 430 prevent contact between the batteries 402 due to vibrations of the car 404 or the like. Therefore, damage to the batteries 402 is suppressed.

### Eleventh Embodiment

The mounting structure for the seats 401 according to the eleventh embodiment differs from the mounting structure for the seats 401 according to the tenth embodiment with respect to only the configuration of the slide rail device 420. The configurations similar to those of the mounting structure for the seats 401 according to the tenth embodiment will be denoted by the same reference signs and the description thereof will be omitted.

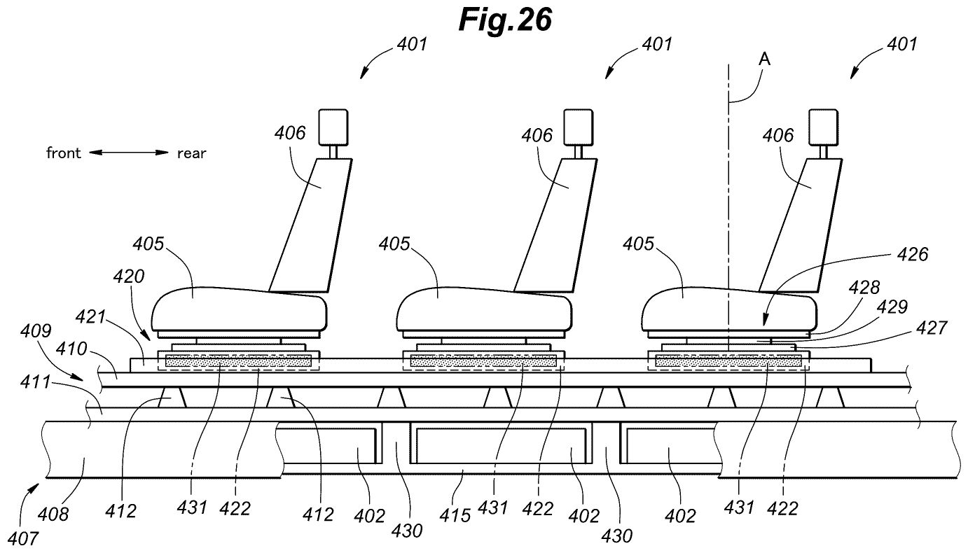

As shown in FIG. 26, the slide rail device 420 is an electric slide rail device that moves the multiple sliders 422 with electric power supplied from the batteries 402. For example, the slide rail device 420 may be a known electric slide rail device including rails 421 each formed with a screw engaging portion and multiple sliders 422 each including a screw member engaging with the screw engaging portion and an electric motor 431 for rotating the screw member.

Since the electric slide rail device includes the electric motors 431, it is heavier compared to the slide rail device 420 of the tenth embodiment. Namely, the load of the seats 401 having the electric slide rail device becomes larger. No matter what positions each seat 401 is in, each corresponding slider 422 overlaps with one of the multiple beams 412 as seen from above. In addition, even when the seat 401 is moved, each corresponding slider 422 overlaps with one of the multiple beams 412 as seen from above. Thus, due to the beams 412 overlapping with the sliders 422, the upper floor panel 410 becomes hard to bend downward even when a downward force such as the load of the seats 401 or the load of the occupants acts on the floor 409 via the seats 401. This also makes the rails 421 hard to bend, and the movement of the seats 401 becomes smooth.

### Twelfth Embodiment

The mounting structure for the seats 401 according to the twelfth embodiment differs from the mounting structure for the seats 401 according to the tenth embodiment with respect to only the configuration of the floor 409. The configurations similar to those of the mounting structure for the seats 401 according to the tenth embodiment will be denoted by the same reference signs and the description thereof will be omitted.

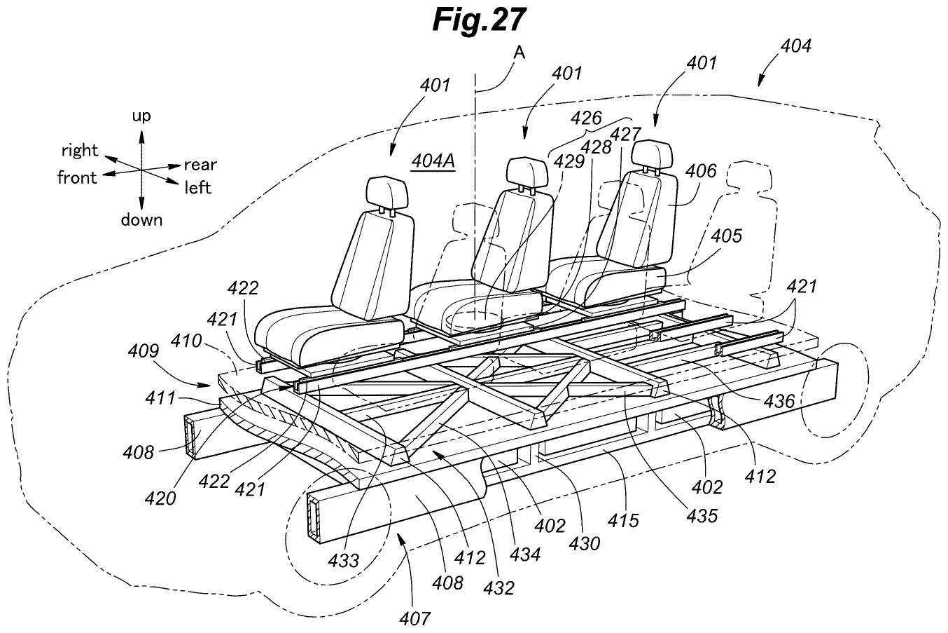

As shown in FIG. 27, for each two beams 412 that are adjacent to each other in the front-rear-direction, the floor 409 is provided with multiple coupling members 432 that couple the front beam 412 to the rear beam 412. The shape of each of the multiple coupling members 432 is not particularly limited, but preferably, each coupling member 432 is made of the same material and has the same shape as each beam 412. Namely, the upper surface of each of the multiple coupling members 432 is in contact with the lower surface of the upper floor panel 410. Thereby, the upper floor panel 410 is also supported by each of the multiple coupling members 432. Alternatively, each of the multiple coupling members 432 may have a plate shape with a thickness smaller than the thickness of each beam 412 and may couple the lower portions of the beams 412.

The multiple coupling members 432 include multiple central coupling parts 433, multiple first coupling parts 434, multiple second coupling parts 435, and multiple third coupling parts 436. Each of the multiple central coupling parts 433 extends in the front-rear direction and couples the central portions of the beams 412. More specifically, each of the multiple central coupling parts 433 is provided in a position overlapping with an area between the left slide rail device 420 and the right slide rail device 420 as seen from above.

Each of the multiple first coupling parts 434 connects an end portion of a front one of two beams 412 that are adjacent to each other in the front-rear direction to a central portion of a rear one of the two beams 412. Each of the multiple second coupling parts 435 connects a central portion of two beams 412 that are adjacent to each other in the front-rear direction to an end portion of a rear one of the two beams 412. The first coupling parts 434 and the second coupling parts 435 disposed to couple the same beams 412 that are adjacent to each other in the front-rear direction are arranged to intersect each other. Each of the multiple third coupling parts 436 extends in the front-rear direction to couple a front one and a rear one of two beams 412 that are adjacent to each other in the front-rear direction.

The first coupling parts 434, the second coupling parts 435, and the third coupling parts 436 may be selectively provided as appropriate. In the present embodiment, as seen from above, the first coupling parts 434 are provided between the beams 412 disposed one behind the other to be overlappingly located below the seat 401 in the first-row from the front. Also, as seen from above, the first coupling parts 434 and the second coupling parts 435 are provided between the beam 412 disposed one behind the other to be overlappingly located below the seat 401 in the second row from the front. Further, as seen from above, the third coupling parts 436 are provided between the beams 412 disposed one behind the other to be overlappingly located below the seat 401 in the third row from the front.

Note that in another embodiment, as seen from above, only the first coupling parts 434 may be provided between the beams 412 disposed one behind the other to be overlappingly located below each seat 401. Also, as seen from above, only the second coupling parts 435 may be provided between the beams 412 disposed one behind the other to be overlappingly located below each seat 401. Further, as seen from above, only the third coupling parts 436 may be provided between the beams 412 disposed one behind the other to be overlappingly located below each seat 401. Alternatively, the first coupling parts 434, the second coupling parts 435, and the third coupling parts 436 may be provided in combination as appropriate.

The multiple coupling members 432 improve the stiffness of the corresponding beams 412. Therefore, the upper floor panel 410 more effectively becomes hard to bend downward even when the load of the battery unit 413 acts on the floor 409 via the left and right side sills 408. This suppresses bending of the rails 421. Therefore, the movement of the seats 401 becomes smooth.

Each of the multiple central coupling parts 433 forms a load path in the front-rear direction. This improves the bending stiffness in the front-rear direction. Therefore, damage to the floor 409 due to collision of the car 404 is suppressed.

### Thirteenth Embodiment

The mounting structure for the seats 401 according to the thirteenth embodiment differs from the mounting structure for the seats 401 according to the tenth embodiment with respect to only the configuration of the floor 409. The configurations similar to those of the mounting structure for the seats 401 according to the tenth embodiment will be denoted by the same reference signs and the description thereof will be omitted.

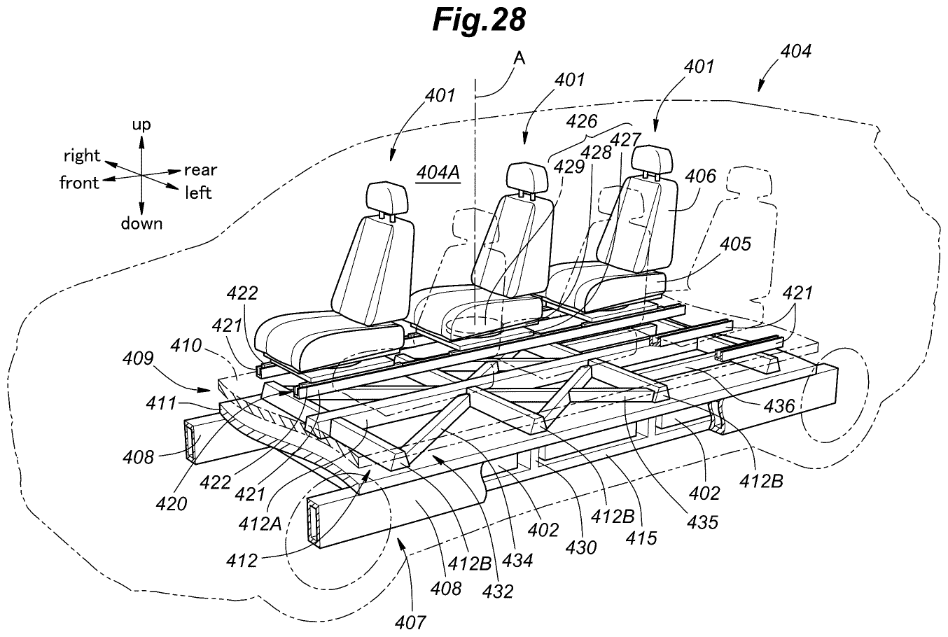

As shown in FIG. 28, the beams 412 include a first beams 412A extending in the front-rear direction and multiple second beams 412B extending leftward and rightward from the first beam 412A. The shape of the first beam 412A and the shape of each of the multiple second beams 412B are not particularly limited, but preferably, each of the first beam 412A and the multiple second beams 412B has an upper surface contacting the lower surface of at least the upper floor panel 410. Due to the upper surface of the first beam 412A and the upper surface of each of the multiple second beams 412B contacting the lower surface of the upper floor panel 410, the upper floor panel 410 is supported by the first beam 412A and each of the second beams 412B. The first beam 412A is provided in a position overlapping with an area between the left slide rail device 420 and the right slide rail device 420 as seen from above. Specifically, the first beam 412A is preferably provided on a laterally central portion of the lower floor panel 411. The multiple second beams 412B are disposed to be spaced from each other in the front-rear direction.

The floor 409 is provided, for each two second beams 412B located on the laterally same side and adjacent to each other in the front-rear-direction, with multiple coupling members 432 that couple the front second beam 412B and the rear second beam 412B. The shape of each of the multiple coupling members 432 is not particularly limited, but preferably, each coupling member 432 is made of the same material and has the same shape as the first beam 412A and each of the multiple second beams 412B. Namely, the upper surface of each of the multiple coupling members 432 is in contact with the lower surface of the upper floor panel 410. Thus, the upper floor panel 410 is also supported by the multiple coupling members 432. Alternatively, each of the multiple coupling members 432 may have a plate shape with a thickness smaller than the thickness of the first beam 412A and the thickness of each of the multiple second beams 412B, and may couple the lower portions of the second beams 412B.

The multiple coupling members 432 include multiple first coupling parts 434, multiple second coupling parts 435, and multiple third coupling parts 436. Each of the multiple first coupling parts 434 connects a right end portion of a front one of two second beams 412B that are located on the laterally same side and adjacent to each other in the front-rear-direction to a left end portion of a rear one of the two second beams 412B. Each of the multiple second coupling parts 435 connects a left end portion of a front one of two second beams 412B that are located on the laterally same side and adjacent to each other in the front-rear-direction to a right end portion of a rear one of the second beams 412B. The first coupling parts 434 and the second coupling parts 435 disposed to couple the same second beams 412B that are located on the same side and adjacent to each other in the front-rear direction are arranged to intersect each other. Each of the multiple third coupling parts 436 extends in the front-rear direction to connect a central portion of a front one of two second beams 412B located on the laterally same side and adjacent to each other in the front-rear-direction to a central portion of a rear one of the two second beams 412B.

The first coupling parts 434, the second coupling parts 435, and the third coupling parts 436 may be selectively provided as appropriate. In the present embodiment, as seen from above, the first coupling parts 434 are provided between the second beams 412B disposed one behind the other on the laterally same side to be overlappingly located below the seat 401 in the first-row from the front. Also, as seen from above, the first coupling parts 434 and the second coupling parts 435 are provided between the second beams 412B disposed one behind the other on the laterally same side to be overlappingly located below the seat 401 in the second row from the front. Further, as seen from above, the third coupling parts 436 are provided between the second beam 412B disposed one behind the other on the laterally same side to be overlappingly located below the seat 401 in the third row from the front.

Note that in another embodiment, as seen from above, only the first coupling parts 434 may be provided between the second beams 412B disposed one behind the other on the laterally same side to be overlappingly located below each seat 401. Also, as seen from above, only the second coupling part s435 may be provided between the second beams 412B disposed one behind the other on the laterally same side to be overlappingly located below each seat 401. Further, as seen from above, only the third coupling parts 436 may be provided between the second beams 412B disposed one behind the other on the laterally same side to be overlappingly located below each seat 401. Alternatively, the first coupling parts 434, the second coupling parts 435, and the third coupling parts 436 may be provided in combination as appropriate.

The first beam 412A forms a load path in the front-rear direction. This improves the bending stiffness in the front-rear direction. Further, since the first beam 412A is provided on the laterally central portion of the lower floor panel 411, the bending stiffness in the front-rear direction improves even further. Therefore, damage to the floor 409 due to collision of the car 404 is suppressed.

The multiple coupling members 432 improve the stiffness of the corresponding second beams 412B. Therefore, the upper floor panel 410 becomes hard to bend downward even when the load of the battery unit 413 acts on the floor 409 via the left and right side sills 408. This suppresses bending of the rails 421. Therefore, the movement of the seats 401 becomes smooth.

### Fourteenth Embodiment

The mounting structure for the seats 401 according to the fourteenth embodiment differs from the mounting structure for the seats 401 according to the tenth embodiment with respect to only the configuration of the floor 409. The configurations similar to those of the mounting structure for the seats 401 according to the tenth embodiment will be denoted by the same reference signs and the description thereof will be omitted.

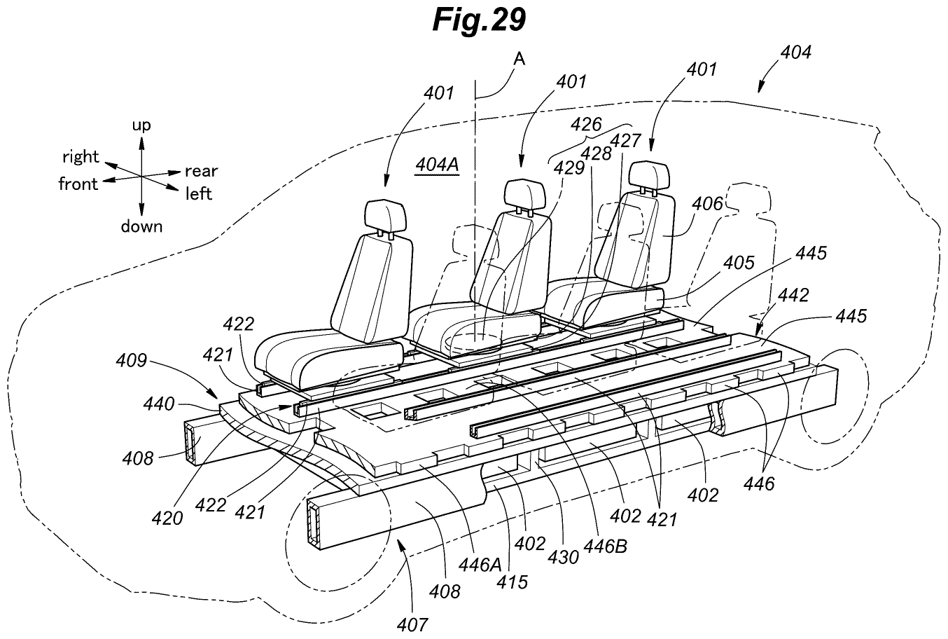

As shown in FIG. 29, the floor 409 includes a panel member 440 joined to each of the left and right side sills 408 and a reinforcement member 442 provided on the panel member 440. The panel member 440 is made of metal, has a plate shape, and is disposed such that the surfaces thereof face in the up-down direction.

The reinforcement member 442 includes multiple first reinforcement members 445 extending in the front-rear direction and multiple second reinforcement members 446 extending in the left-right direction to intersect with the first reinforcement members 445. Each reinforcement member 445, 446 may be made of metal and may have a hollow rectangular shape in cross-sectional view. Alternatively, each reinforcement member 445, 446 may be a channel member that is concave in cross-sectional view. Each reinforcement member 445, 446 has surfaces facing in the up-down direction.

In the present embodiment, two first reinforcement members 445 are provided. The two first reinforcement members 445 are disposed to be laterally spaced from each other. On the right first reinforcement member 445, the slide rail device 420 supporting the three seats 401 on the right side is provided. On the left first reinforcement member 445, the slide rail device 420 supporting the three seats 401 on the left side is provided.

Each of the multiple second reinforcement members 446 includes second reinforcement member end portions 446A respectively provided on left and right end portions of the panel member 440 and a second reinforcement member central portion 446B disposed between the two first reinforcement members 445. Each of the left and right second reinforcement member end portions 446A is joined to the laterally outer side edge of the corresponding first reinforcement member 445. The second reinforcement member central portion 446B joins the laterally inner side edges of the two first reinforcement members 445 to each other.

The left and right second reinforcement member end portions 446A and the second reinforcement member central portion 446B are laterally arranged on the same straight line, and thus, as seen from above, the reinforcement member 442 has a grid shape in which each of the two first reinforcement members 445 and each of the multiple second reinforcement members 446 intersect each other.

In the present embodiment, the vertical height of each of the two first reinforcement members 445 is the same as the vertical height of each of the multiple second reinforcement members 446, and the upper surface of each of the multiple second reinforcement members 446 is disposed on the same plane as the upper surface of each of the two first reinforcement members 445, but the present invention is not limited to this. The thickness of each of the multiple second reinforcement members 446 may be smaller than the thickness of each of the two first reinforcement members 445. In this case, each of the left and right second reinforcement member end portions 446A and the second reinforcement member central portion 446B are preferably joined to upper portions or lower portions of the corresponding side edges of the two first reinforcement members 445.

Each of the left and right slide rail devices 420 supporting the multiple seats 401 is provided on the reinforcement member 442 of the floor 409. Thereby, the reinforcement member 442 becomes hard to bend downward even when the load of the battery unit 413 acts on the floor 409 via the left and right side sills 408. Therefore, the rails 421 also become hard to bend, and the movement of the seats 401 becomes smooth.

### Fifteenth Embodiment

The mounting structure for the seats 401 according to the fifteenth embodiment differs from the mounting structure for the seats 401 according to the fourteenth embodiment with respect to only the configuration of the reinforcement member 442. The configurations similar to those of the mounting structure for the seats 401 according to the fourteenth embodiment will be denoted by the same reference signs and the description thereof will be omitted.

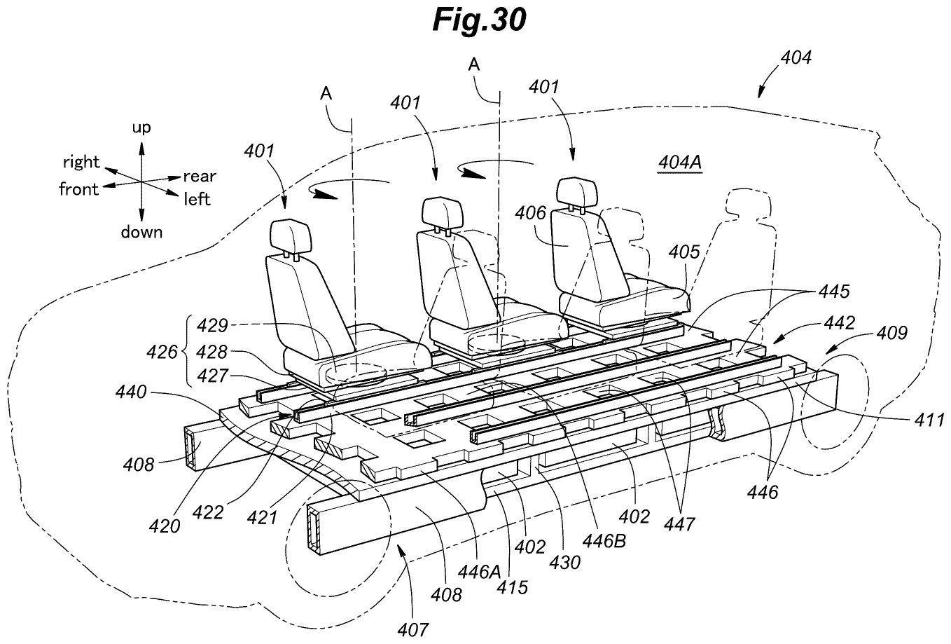

As shown in FIG. 30, each of the two first reinforcement members 445 is provided with multiple void parts 447. Each of the multiple void parts 447 vertically penetrates the corresponding first reinforcement member 445, such that the void parts 447 are spaced from each other in the front-rear direction. Due to the void parts 447, each of the two first reinforcement members 445 is lightweighted.

Note that in another embodiment, the second reinforcement members 446 also may be provided with the void parts 447. This further reduces the weight of the reinforcement member 442. Also, a reinforcement bead not shown in the drawings may be disposed around each void part 447. This improves the durability of a part around each void part 447.

### Sixteenth Embodiment

The mounting structure for the seats 401 according to the sixteenth embodiment differs from the mounting structure for the seats 401 according to the fifteenth embodiment with respect to only the configuration of the slide rail device 420 and the seats 401. The configurations similar to those of the mounting structure for the seats 401 according to the fifteenth embodiment will be denoted by the same reference signs and the description thereof will be omitted.

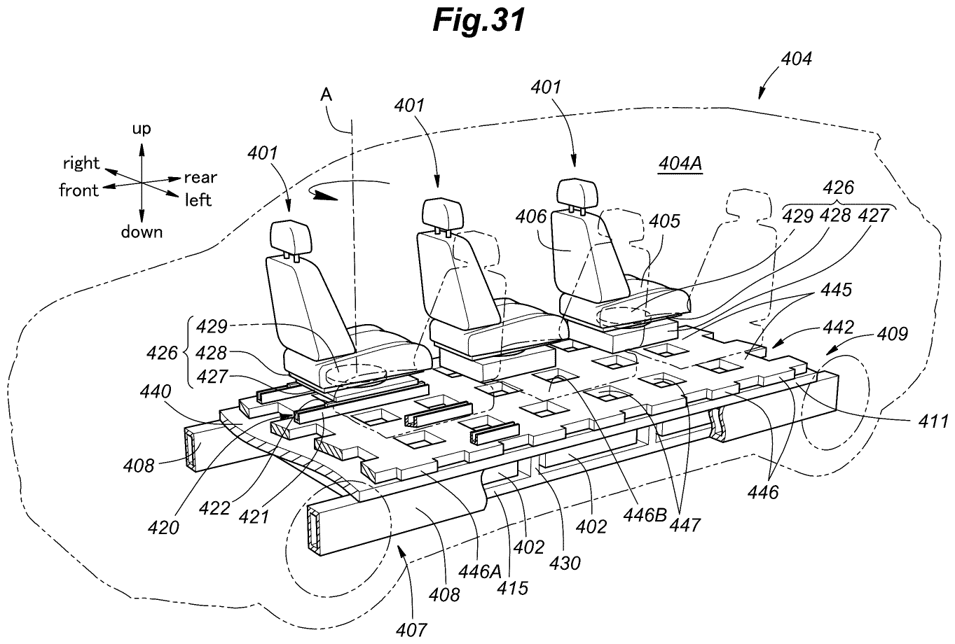

As shown in FIG. 31, the rails 421 are provided on the corresponding first reinforcement members 445 so as to support the seats 401 in the first row from the front. The lower member 427 provided on each of the seats 401 in the second row and the third row from the front is provided on the corresponding first reinforcement member 445 via a mounting part not shown in the drawings. The shape of the mounting part is not particularly limited, but is preferably formed to achieve a preferred condition such as that the height of each seat 401 in the second row and the third row from the front is equal to the height of each seat 401 in the first row from the front.

In this way, on each first reinforcement member 445, the seat 401 provided with the slide rail device 420 (the seat 401 in the first row from the front) and the seats 401 not provided with the slide rail device 420 (the seats 401 in the second row and the third row from the front) are mounted. The reinforcement member 442 of the floor 409 becomes hard to bend downward not only against the load of the battery unit 413 acting thereon via the left and right side sills 408 but also against the load of the seats 401 not provided with the slide rail device 420 (the seats 401 in the second row and the third row from the front). This also makes the rails 421 hard to bend, and the movement of the seats 401 in the first-row from the front becomes smooth.

Concrete embodiments have been described in the foregoing, but the present invention can be modified in various ways without being limited to the above embodiments. In each embodiment, each seat 401 is provided with the rotating device 426 for rotating the seat 401, but each seat 401 does not have to be provided with the rotating device 426. For example, in the fourteenth embodiment to the sixteenth embodiment, two first reinforcement members 445 are disposed on the left and right, but the number of first reinforcement members 445 disposed is not limited, and three first reinforcement members 445 arranged laterally may be provided. In this case, a console box or a center seat may be provided on the first reinforcement member 445 disposed at the center. The embodiments may be combined such that the upper floor panel 410 is formed with void parts 447.

### Overview of Embodiment of the Invention

In the following, an embodiment of the present invention will be described with reference to the drawings. Note that in the embodiment described below, various limitations technically preferred to carry out the present invention are added, but the technical scope of the present invention is not limited to the following embodiment and illustrated example.

The present embodiment is a vehicle seat. Vehicles provided with the vehicle seat shown in the following may include any vehicle that a person gets in and uses to travel, such as a watercraft, an aircraft, and a car, but in the present embodiment, a car seat for a car, particularly an automobile, will be described as an example. In the present embodiment, particularly, a vehicle seat 501 that is switchable between a use position in which an occupant or a person to be seated can be seated on the vehicle seat and a movement position will be described as an example.

The vehicle seat 501 includes a seat body, a rail device 503, a support mechanism 504, and a retaining mechanism 505. The rail device 503 enables the seat body to move along a predetermined direction. The support mechanism 504 supports the seat body on the rail device 503 to be movable between a use position in which the person to be seated can be seated on the seat body and a movement position which is moved from the use position. The retaining mechanism 505 retains the seat body in the use position.

The seat body is provided with a seat cushion for supporting the thighs and buttocks of a person, a seatback having a lower end portion supported on the seat cushion and serving as a backrest, a headrest provided on an upper end portion of the seatback, a seat frame, and a reclining mechanism for tilting the seatback relative to the seat cushion. Further, the seat frame is provided with a cushion frame forming a skeleton of the seat cushion, a seatback frame forming a skeleton of the seatback which has a lower end portion supported on the seat cushion and serves as a backrest, and a headrest frame forming a skeleton of the headrest. The cushion frame, the seatback frame, and the headrest frame are provided with cushion pads, and these cushion pads are covered with skins to form the seat body.

In the following description of the vehicle seat 501, the known configurations of the seat body will not be shown in the drawings and will not be described in detail. The configurations of the rail device 503, the support mechanism 504, the retaining mechanism 505, and the surroundings thereof, which are characteristic configurations of the vehicle seat 501, will be described in detail with reference to the drawings.

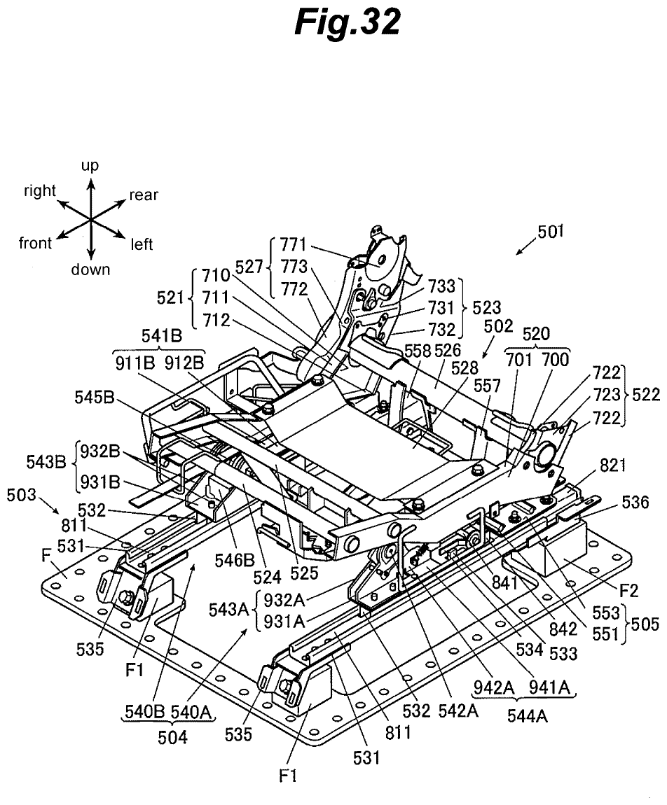

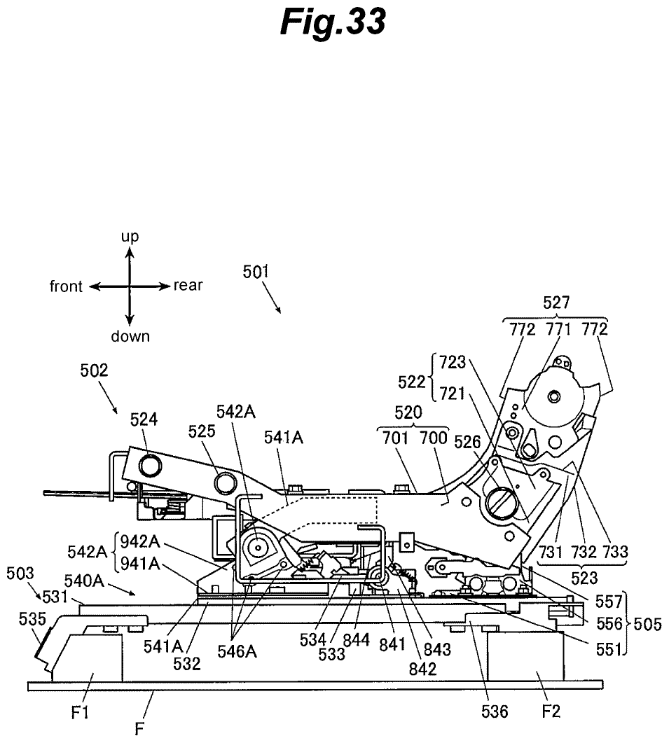

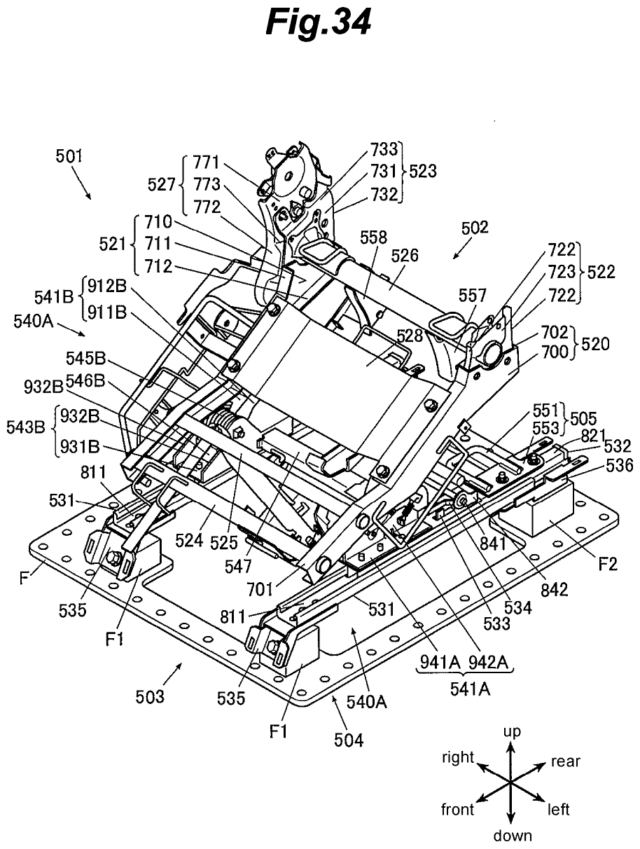

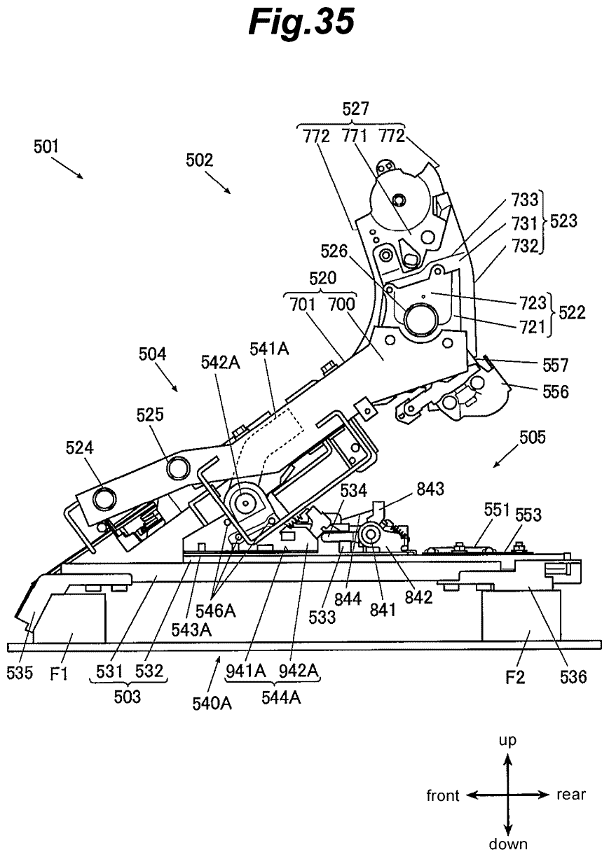

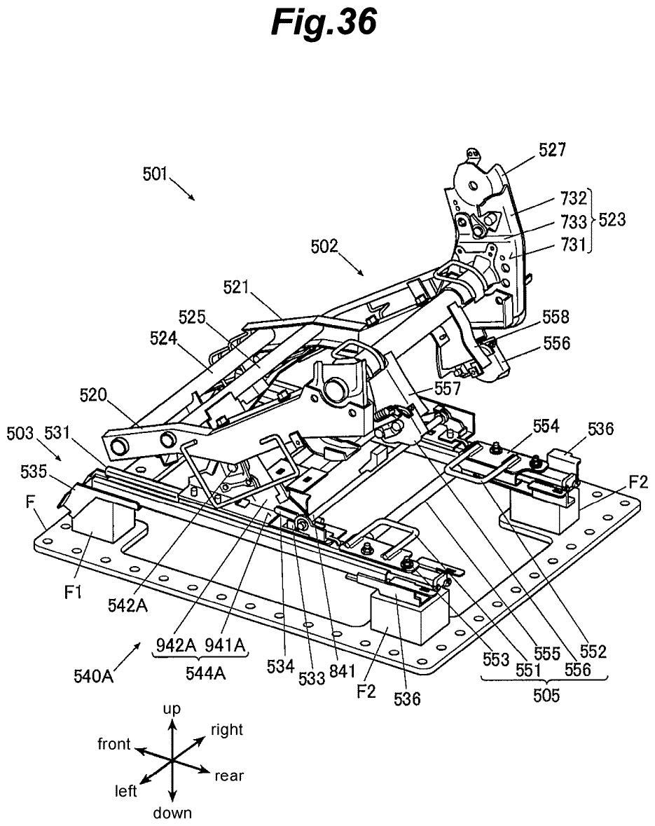

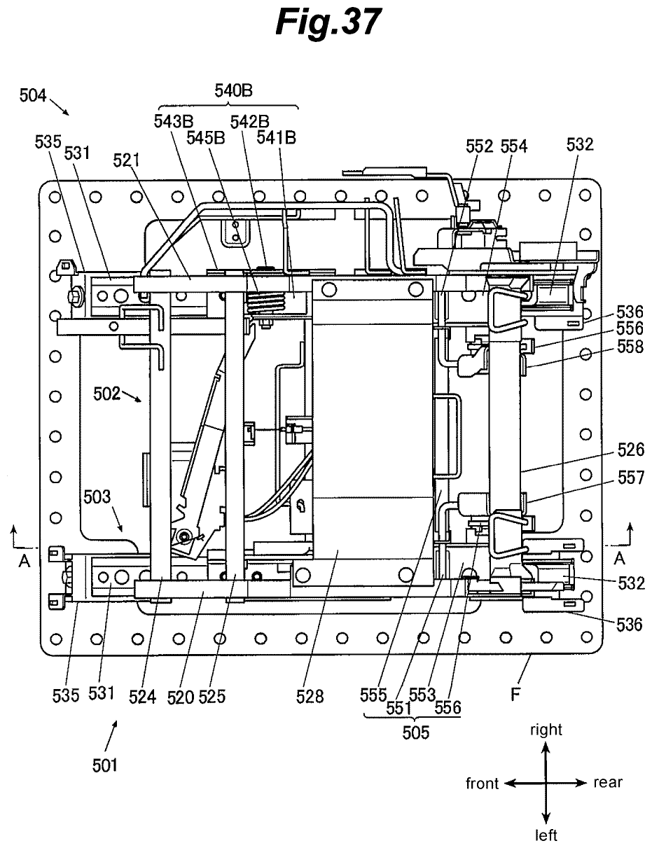

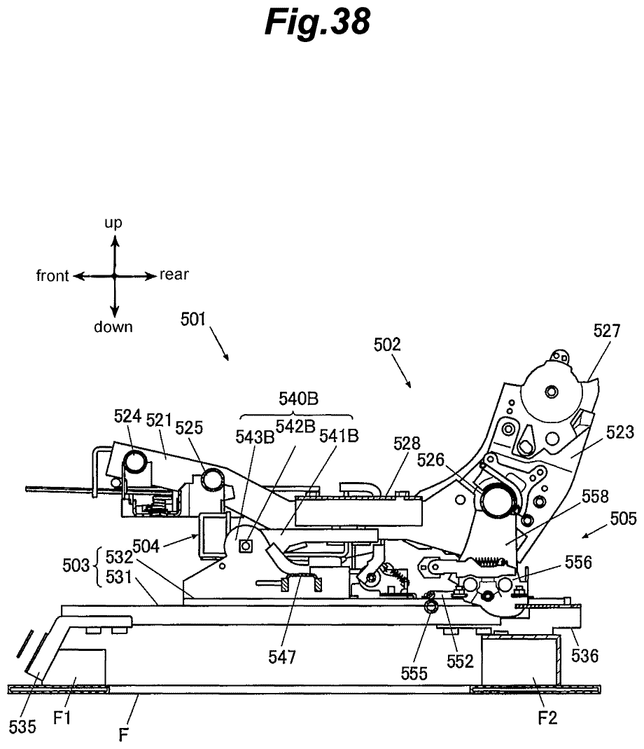

FIG. 32 is a perspective view of the vehicle seat 501 according to the embodiment when the seat body is in the use position, FIG. 33 is a side view of the same, FIG. 34 is a perspective view of the vehicle seat 501 when the seat body is in the movement position, and FIG. 35 is a side view of the same. Further, FIG. 36 is a perspective view of the vehicle seat 501 in the movement position as viewed from a direction different from FIG. 32, FIG. 37 is a plan view of the vehicle seat 501 in the use position, and FIG. 38 is a sectional view taken along line A-A in FIG. 37. Note that in each drawing of the present embodiment, the up, down, left, right, front, and rear directions indicate the directions in a state in which the seat is mounted to the car, and the forward movement direction of the car is defined as “front,” the direction opposite thereto is defined as “rear,” and the lefthand side and righthand side in the state when the seat faces forward are defined as “left” and “right,” respectively. Note that in the following description of the vehicle seat 501, unless particularly mentioned, the arrangement, orientation, and direction of each part will be described with an assumption that the seat body is in the use position.

### [Cushion Frame]

As shown in FIGS. 32 to 38, the cushion frame 502 includes left and right cushion side frames 520, 521 disposed to be spaced from each other, left and right pipe frame support brackets 522, 523 coupled to rear end portions of the respective cushion side frames 520, 521, pipe frames 524, 525 coupling the left and right cushion side frames 520, 521, and a pipe frame 526 coupling the left and right pipe frame support brackets 522, 523.

As shown in FIGS. 32 and 33, the left and right cushion side frames 520, 521 are each formed to have an open cross-section structure such that substantially U-shaped cross sections thereof are open inward toward each other. The left cushion side frame 520 includes a flat plate-shaped web 700 forming a left side surface of the cushion frame 502 and flanges 701, 702 integrally formed on upper and lower edges of the web 700. The right cushion side frame 521 includes a flat plate-shaped web 710 forming a right side surface of the cushion frame 502 and flanges 711, 712 integrally formed on upper and lower edges of the web 710. The left and right cushion side frames 520, 521 are each formed by press-working a single metal plate.

The left and right webs 700, 710 are in a flat plate shape extending along the front-rear and up-down directions and have the same shape in side view. An overall shape of each of the left and right webs 700, 710 in side view is elongated in substantially the front-rear direction. A front end portion of each of the left and right webs 700, 710 has a vertical width somewhat narrower than the other portion and extends somewhat obliquely upward than the forward direction. Also, a rear end portion of each of the left and right webs 700, 710 has a shape that is cut along an obliquely downward direction. Further, at the center of this cut part, a clearance part consisting of an arc-shaped notch for avoiding a later-described pipe frame 526 is formed. In the front end portion and the rear end portion of each of the left and right webs 700, 710, the aforementioned flanges 701, 702, 711, 712 are not formed.

Further, a part on the side of the front end portion of each of the left and right webs 700, 710 is bent midway so that the obliquely upward inclination angle is somewhat reduced in the portion forward of the bent portion. Circular through holes are formed in the front end portions and the bent portions of the left and right webs 700, 710, and the left end portions and the right end portions of the pipe frames 524, 525 are inserted therein. The pipe frames 524, 525 each couple the front portions of the left and right cushion side frames 520, 521. The pipe frames 524, 525 and the left and right webs 700, 710 are joined by welding or the like, for example, but they may be coupled to each other by other joining methods. The pipe frames 524, 525 are directed in the left-right direction to be in parallel with each other. Note that in the following description, “joined by welding or the like” means that the joining method is exemplified by welding but may be other than welding.

On a part of the right side surface (inner side surface) of the web 700 in a rear end portion of the left cushion side frame 520, the pipe frame support bracket 522 is provided. Also, though not shown in the drawings, on a part of the left side surface (outer side surface) of the web 700 in the rear end portion of the cushion side frame 520, a seatback support bracket is provided.

The pipe frame support bracket 522 extends obliquely upward toward the rear from the rear end portion of the cushion side frame 520, which is not formed with the flanges 701, 702, so as to pass between the flange 701 and the flange 702. The pipe frame support bracket 522 has a substantially U-shaped cross section with an open side facing leftward, and is formed by press-working a single metal plate.

The pipe frame support bracket 522 includes a flat plate-shaped web 721 extending along the front-rear and up-down directions and flanges 722 erected leftward from the front edge and the rear edge of the web 721. Further, an upper end portion of the pipe frame support bracket 522 is formed with a substantially rectangular convex part 723 that bulges leftward. Due to the front and rear flanges 722 and the convex part 723, the pipe frame support bracket 522 is configured to enhance the stiffness and to suppress bending in the left-right direction.

The pipe frame support bracket 522 is fixed to the rear end portion of the cushion side frame 520 by fastening members such as multiple bolts. Note that the structure may be made such that the outer side surfaces of the front and rear flanges 722 of the pipe frame support bracket 522 respectively contact the inner side surfaces of the flanges 701, 702 of the cushion side frame 520 and are joined to the same by welding or the like at multiple positions. The cushion side frame 520 and the pipe frame support bracket 522 each have a substantially U-shaped cross section and are integrally joined to each other such that their open sides face each other. Thereby, the cushion side frame 520 and the pipe frame support bracket 522 form a rectangular tubular structure having a closed cross-section structure, and the stiffness is highly enhanced.

Further, the pipe frame support bracket 522 is formed with a circular hole to penetrate the lower end portion of the convex part 723 in the left-right direction, and the left end portion of the pipe frame 526 is inserted therein. The pipe frame 526 and the pipe frame support bracket 522 are joined to each other by welding or the like, for example, but may be coupled to each other by other joining methods. The part raised from the web 721 due to the convex part 723 has an enhanced stiffness due to deformation of the plate surface. Therefore, by joining the left end portion of the pipe frame 526 to the circular hole provided in the lower end portion of the convex part 723, the pipe frame 526 can be supported with high strength.

On the right side (outer side surface) of the web 710 in the rear end portion of the right cushion side frame 521, a pipe frame support bracket 523 is provided, and further, on the right side thereof, a seatback support bracket 527 is provided.

The pipe frame support bracket 523 and the seatback support bracket 527 extend obliquely upward toward the rear from the rear end portion of the web 710.

The seatback support bracket 527 has a substantially U-shaped cross section that is open rightward, and includes a flat plate-shaped web 771 extending along the front-rear and up-down directions and flanges 772 erected leftward from the front edge and the rear edge of the web 771. The seatback support bracket 527 is formed by press-working a single metal plate.

The pipe frame support bracket 523 and the seatback support bracket 527 extend in the same direction from the rear end portion of the right cushion side frame 521, but the seatback support bracket 527 extends more upward. Further, the upper end portions of the seatback support bracket 527 as well as a left seatback support bracket not shown in the drawings are coupled to the right lower end portion and the left lower end portion of the seatback frame not shown in the drawings. The left seatback support bracket and the right seatback support bracket 527 support the lower end portion of the seatback frame to be pivotable about an axis extending along the left-right direction.

Between the seatback frame and each of the left and right seatback support brackets, a well-known reclining mechanism not shown in the drawings is provided. The left and right reclining mechanisms each include a pivot shaft extending in the left-right direction and a spiral spring for urging the seatback frame forward. The spiral spring has one end portion held on the seatback support bracket and the other end portion held on the seatback frame. The reclining mechanisms include a fixing mechanism for fixing the seatback in a standing state at a predetermined angle. With an operate of an operation lever not shown in the drawings, the reclining mechanisms are released from the fixed state, and the spiral springs can cause the seatback frame to rotate forward relative to the left and right seatback support brackets so that the seatback frame is folded to the cushion frame 502 side.

The seatback support bracket 527 has a step 773 along substantially the front-rear direction and is formed such that the upper half of the web 771 is depressed rightward. The stiffness of the seatback support bracket 527 is enhanced by the deformation due to the step 773 in the web 771 and each flange 772.

The pipe frame support bracket 523 includes a flat plate-shaped web 731 extending along the front-rear and up-down directions and a flange 732 erected rightward from the rear edge of the web 731. The pipe frame support bracket 523 is formed by press-working a single metal plate. The lower portion of the web 731 has a left surface contacting the right surface of the web 710 of the cushion side frame 521. Also, the right surface of the web 731 is in contact with a lower portion of the left surface of the web 771 of the seatback support bracket 527.

The pipe frame support bracket 523 is fixed, together with the seatback support bracket 527, to the rear end portion of the cushion side frame 521 by means of fastening members such as multiple bolts passing through the webs 710, 731, 771. Note that the contact parts between the webs 710, 731, 771 may be joined by welding or the like. Also, the front surface of the flange 732 of the pipe frame support bracket 523 may be brought into contact with and joined to the rear surface of the rear flange 772 of the seatback support bracket 527 by welding or the like at multiple positions.

The web 731 of the pipe frame support bracket 523 has a step 733 along which the upper end portion of the web 731 is depressed rightward. Further, the upper end portion of the web 731 is bifurcated, and each tip end portion is joined to the left surface of the upper half of the web 771 of the seatback support bracket 527, which is depressed rightward due to the step 773. The step 733 in the pipe frame support bracket 523 is positioned higher than the step 773 in the seatback support bracket 527. Thereby, the web 731 of the pipe frame support bracket 523 and the web 771 of the seatback support bracket 527 in cooperation form a quadrangular prism-shaped structure extending in the front-rear direction and having a closed cross-sectional shape. Therefore, the connection body of the pipe frame support bracket 523 and the seatback support bracket 527 has a high stiffness and can firmly support the seatback and the pipe frame 526.

Further, circular holes are respectively formed in the central portion of the web 731 of the pipe frame support bracket 523 and the formation position of the step 773 in the web 771 of the seatback support bracket 527 to penetrate therethrough such that the circular holes overlap each other as seen in the left-right direction, and the right end portion of the pipe frame 526 is inserted therein. The pipe frame 526 is joined to the pipe frame support bracket 523 and the seatback support bracket 527 by welding or the like, for example, but they may be the coupled to each other by other joining methods. By joining the right end portion of the pipe frame 526 to the circular holes provided in the position where the stiffness is enhanced by the deformation due to the step 773 in the web 771 and where the stiffness is enhanced by the quadrangular prism-shaped structure formed by the webs 731, 771, the pipe frame 526 can be supported with high strength.

With the left and right cushion side frames 520, 521 and the three pipe frames 524 to 526 mentioned above, the cushion frame 502 forms a substantially rectangular frame body as seen in the plan view. Further, the cushion frame 502 is provided with a pressure receiving member 528 suspended by the left and right cushion side frames 520, 521 between the second pipe frame 525 from the front and the pipe frame 526 behind it. The pressure receiving member 528 is a member for receiving the load of the person seated on the vehicle seat 501.

The pressure receiving member 528 is a rectangular sheet member made of resin and elongated in the left-right direction. Each of the flanges 701, 711 on the upper sides of the left and right cushion side frames 520, 521 is integrally formed with mounting pieces (not shown in the drawings) for the pressure receiving member 528 at two positions arranged in the front-rear direction such that the mounting pieces protrude inward in the left-right direction the inner side. The pressure receiving member 528 is fixed to the mounting pieces at two front and rear positions on the left end portion thereof and two front and rear positions on the right end portion thereof by means of fastening members such as bolts. The central portion of the pressure receiving member 528 flexes downward compared to the left and right end portions thereof coupled to the left and right cushion side frames 520, 521. The cushion pad of the seat cushion is disposed on this pressure receiving member 528.

Note that the mounting of the pressure receiving member 528 to the cushion frame 502 is not limited to that using fastening members, and other methods such as a method using adhesion or a method providing locking members for locking may be used. Also, the pressure receiving member 528 may be attached to the pipe frame 524 to 526 as a member elongated in the front-rear direction. Further, the pressure receiving member 528 is not limited to a sheet member made of resin, and any material that can take a sheet shape or a planar shape may be used. For example, a net, a wire bent into a planar shape, a spring member deployed into a planar shape, or the like may be used.

### [Rail Device]

The rail device 503 is disposed, with respect to the up-down direction, between the cushion frame 502 and a floor member F of the vehicle body on which the vehicle seat 501 is installed. As shown in FIGS. 32 and 33, the rail device 503 mainly includes a pair of left and right lower rails 531 fixed to the floor member F of the vehicle body, a pair of left and right upper rails 532 supported by the respective lower rails 531 to be relatively movable, a restraining member 533 for restraining the pair of upper rails 532 in an unmovable manner, and an operation lever 534 for releasing the restraining state of the restraining member 533.

The front end portion and the rear end portion of each lower rail 531 are fixed, via mounting brackets 535, 536, to block-shaped bases F1, F2 provided one behind the other on the upper surface of the floor member F of the vehicle body. Each lower rail 531 is fixed to extend along the front-rear direction.

The front mounting bracket 535 is composed of an elongated metal plate having a rear half extending substantially horizontally and a front half inclined to extend obliquely downward toward the front. On the left and right edges of the mounting bracket 535, flanges erected upward are provided. The lower surface of the front half of the mounting bracket 535 makes an installation surface that contacts an inclined surface on the front side of the base F1, and the upper surface of the rear half of the mounting bracket 535 makes a placement surface on which the lower rail 531 is placed. The mounting bracket 535 is fixed to the base F1 by a fastening member such as a bolt penetrating through the front half thereof. Further, the inner width between the left and right flanges of the mounting bracket 535 substantially matches the outer width of the lower rail 531. Therefore, the lower rail 531 can be fitted between the flanges. The front end portion of the lower rail 531 is fixed to the floor member F by a fastening member such as a bolt penetrating through the mounting bracket 535 and the lower rail 531. Either one of the through hole on the mounting bracket 535 and the through hole on the lower rail 531 through which the fastening member for coupling the mounting bracket 535 and the lower rail 531 to each other is passed may be formed as an elongated hole extending along the front-rear direction, so that the mounting position of the lower rail 531 may be adjustable in the front-rear direction. The through hole through which the fastening member for fixing the mounting bracket 535 to the base F1 may be formed as an elongated hole extending along the inclined surface, so that the installation height of the lower rail 531 may be adjustable.

The rear mounting bracket 536 is composed of an elongated metal plate extending along the front-rear direction and having flanges erected upward from both left and right sides. The lower surface of the rear half of the mounting bracket 536 makes a substantially horizontal installation surface placed on the upper surface of the base F2, and the upper surface of the front half of the same makes a substantially horizontal placement surface on which the lower rail 531 is placed. The mounting bracket 536 is fixed to the base F2 by a fastening member such as a bolt penetrating through the rear half thereof. Further, the inner width between the left and right flanges of the mounting bracket 536 substantially matches the outer width of the lower rail 531. Therefore, the lower rail 531 can be fitted between the flanges. The rear end portion of the lower rail 531 is fixed to the floor member F by a fastening member such as a bolt penetrating through the mounting bracket 536 and the lower rail 531. Either one of the through hole on the mounting bracket 536 and the through hole on the lower rail 531 through which the fastening member for coupling the mounting bracket 536 and the lower rail 531 to each other is passed may be formed as an elongated hole extending along the front-rear direction, so that the mounting position of the lower rail 531 may be adjustable in the front-rear direction. Alternatively, the through hole through which the fastening member for fixing the mounting bracket 536 to the base F2 is passed may be formed as an elongated hole extending along the front-rear direction, so that the mounting position of the lower rail 531 may be adjustable in the front-rear direction.

The lower rail 531 is an elongated member having an open cross-sectional shape that is open upward over the entire length. The lower rail 531 is formed by press-working a single metal plate. The lower rail 531 has a substantially U-shaped cross section over the entire length. Namely, the lower rail 531 includes a long strip-shaped bottom plate portion 811 and left and right side wall portions erected upward from both left and right sides of the bottom plate portion 811. On the upper end portion of each of the left and right side wall portions, a bent-back part that extends inward from the upper end portion and further is bent back downward is formed over the entire length.

The upper rail 532 is an elongated member having an open cross-sectional shape that is open downward over the entire length. The upper rail 532 is formed by press-working a single metal plate. The upper rail 532 has a substantially inverted U-shaped cross section over the entire length. Namely, the upper rail 532 includes a long strip-shaped top plate portion 821 and left and right side wall portions depending downward from both left and right sides of the top plate portion 821. On the lower end portion of each of the left and right side wall portions, a bent-back part that extends outward from the lower end portion and further is bent back upward is formed over the entire length.

When the upper rail 532 is inserted inside the lower rail 531 from one end of the lower rail 531, the top plate portion 821 protrudes upward from between the left and right side wall portions of the lower rail 531 over the entire length. Also, inside the lower rail 531, the left and right bent-back parts of the upper rail 532 are restrained from above by the left and right bent-back parts of the lower rail 531, so that the upper rail 532 is prevented from being disengaged upward from the lower rail 531 while the upper rail 532 can slidingly move in the front-rear direction.

The restraining member 533 and the operation lever 534 constitute a slide restraining mechanism for figure restricting the slide of the seat body in the front-rear direction. The restraining member 533 and the operation lever 534 are individually installed at a middle position in the front-rear direction of each of the top plate portions 821 of the left and right upper rails 532. The operation lever 534 is an elongated member having a pivoting end portion that receives an operation input extending toward the front, and the restraining member 533 is provided on a middle portion in the longitudinal direction of the operation lever 534 and extends downward. The restraining member 533 and the operation lever 534 are composed of one integrated member. The rear end portions of the left and right operation levers 534 are respectively fixed to left and right end portions of an interlocking shaft 841 that extends along the left-right direction. The left and right end portions of the interlocking shaft 841 are pivotably supported by left and right shaft brackets 842 fixedly provided at middle positions in the front-rear direction of the top plate portions 821 of the left and right upper rails 532, respectively. Thus, when one of the left and right operation levers 534 is operated to pivot, both undergo pivoting motion in an interlocking manner due to the interlocking shaft 841.

The restraining member 533 is loosely inserted in a rectangular elongated hole formed in the top plate portion 821 of the upper rail 532, and the lower end portion thereof can contact the bottom plate portion 811 of the lower rail 531. The bottom plate portion 811 is formed with fitting holes at a constant interval in the front-rear direction, and the lower end portion of the restraining member 533 can be inserted in each of the fitting holes. Therefore, when the restraining member 533 contacts the bottom plate portion 811 from above, it restricts the sliding of the upper rail 532 in the front-rear direction relative to the lower rail 531. Note that the configuration for the restraining member 533 to restrict the sliding of the upper rail 532 in the front-rear direction is not limited to the above-described example, and any configuration that restricts the sliding of the upper rail 532 may be adopted.

On the laterally central portion of the interlocking shaft 841, an input arm 843 extending upward from the interlocking shaft 841 is fixed by fastening, for example. A tension wire 844 for applying a forward tensile force to the input arm 843 is connected to an upward extending pivoting end portion of the input arm 843. Thereby, a downward pressing force is applied from the interlocking shaft 841 to the restraining members 533, and the restraining members 533 can restrict the sliding of the upper rails 532 in the front-rear direction. Further, by making one of the left and right operation levers 534 pivot in the pull-up direction against the tensile force of the tension wire 844, the restraining state by the left and right restraining members 533 can be released.

### [Support Mechanism]

The support mechanism 504 includes a left support mechanism 540A supporting the left side of the cushion frame 502 on the left upper rail 532 and a right support mechanism 540B supporting the right side of the cushion frame 502 on the right upper rail 532.

The left support mechanism 540A is provided on the front end upper surface of the top plate portion 821 of the left upper rail 532. The left support mechanism 540A includes a support arm 541A, a support shaft 542A, a first support bracket 543A, and a second support bracket 544A.

The first support bracket 543A includes a base plate portion 931A placed on and fixed to the front end upper surface of the top plate portion 821 of the left upper rail 532 and a side wall portion 932A erected vertically from the right end portion of the base plate portion 931A. The second support bracket 544A includes a base plate portion 941A fixed to the front end upper surface of the top plate portion 821 of the left upper rail 532 via the base plate portion 931A of the first support bracket 543A and a side wall portion 942A erected vertically from the right end portion of the base plate portion 941A. The first support bracket 543A and the second support bracket 544A are each formed by press-working a single metal plate.

The base plate portion 931A of the first support bracket 543A has a rectangular shape elongated in the front-rear direction, and the right end portion thereof extends more rightward than the right end portion of the top plate portion 821. Therefore, the side wall portion 932A is erected at a position more to the right than the right end of the top plate portion 821. The side wall portion 932A has an upper end protruding in an arc shape such that the laterally central portion is the highest in side view. At the center of this arc-shaped protruding part, a circular hole for supporting the right end portion of the support shaft 542A is formed such that the circular hole penetrates through the arc-shaped protruding part in the left-right direction. The side wall portion 932A is formed with a flange erected rightward and extending from the upper end arc-shaped portion to the rear end portion. Due to this flange, the stiffness around the circular hole is enhanced, bending of the side wall portion 932A is suppressed, and the support strength of the support shaft 542A is enhanced.

The base plate portion 941A of the second support bracket 544A has a rectangular shape elongated in the front-rear direction and has a lateral width narrower than the base plate portion 931A mentioned above. The base plate portion 941A is overlappingly placed on the base plate portion 931A, and the first support bracket 543A and the second support bracket 544A are fixed on the top plate portion 821 of the upper rail 532 by fastening members such as multiple bolts penetrating through the base plate portion 941A, the base plate portion 931A, and the top plate portion 821 of the upper rail 532.

The side wall portion 942A has substantially the same shape as the side wall portion 932A described above, as seen in side view. The side wall portion 942A is positioned to the left of the side wall portion 932A to oppose the side wall portion 932A at a fixed distance in a parallel relationship. The side wall portion 942A is formed, at the center of the arc-shaped protruding part thereof, with a circular hole for supporting the left end portion of the support shaft 542A such that the circular hole penetrates through the side wall portion 942A in the left-right direction. Around the circular hole, a protruding part that protrudes rightward on the right surface of the side wall portion 942A and is recessed rightward on the left surface of the same is formed. Due to this protruding part, the stiffness around the circular hole is enhanced, bending of the side wall portion 942A is suppressed, and the support strength of the support shaft 542A is enhanced.

Further, coupling pins 546A suspended by the side wall portion 932A and the side wall portion 942A that oppose each other are provided at three positions around the lower side of the support shaft 542A. Each coupling pin 546A has left and right end portions respectively fixed to the side wall portions 932A, 942A by joining such as crimping or welding, and maintains the lateral distance between the side wall portions 932A, 942A to be constant. Due to the coupling by the coupling pins 546A, the stiffness of each side wall portion 932A, 942A is enhanced, bending of each side wall portion 932A, 942A is suppressed, and the support strength of the support shaft 542A is enhanced.

Further, of the three coupling pins 546A, the coupling pin 546A positioned in front of the support shaft 542A also functions as a stopper which, when the rear end portion of the cushion frame 502 pivotably supported by the later-described support arm 541A pivots upward, contacts the front end portion of the support arm 541A to restrict the upward pivot so that the angle shown in FIGS. 34 and 35 is not exceeded.

The support arm 541A is formed of a thick metal plate having an elbow-like shape in side view. The support arm 541A extends obliquely upward toward the rear from the base end portion supported by the support shaft 542A and is bent at a bent portion in the middle, so that the pivoting end portion opposite from the base end portion extends substantially horizontally. The pivoting end portion of the support arm 541A is coupled to the right surface of the web 700 at the middle portion in the front-rear direction of the cushion side frame 520 by fastening members such as multiple bolts via a spacer block not shown in the drawings. Further, the base end portion of the support arm 541A is formed with a circular hole in which the support shaft 542A is inserted such that the circular hole penetrates through the base end portion in the left-right direction. The base end portion of the support arm 541A is pivotably supported by the support shaft 542A at a position between the side wall portions 932A, 942A of the first and second support brackets 543A, 544A. Note that the support arm 541A may be pivotably supported by making the support shaft 542A pivotable relative to the first and second support brackets 543A, 544A, or the support arm 541A may be pivotably supported on the support shaft 542A.

With the first support bracket 543A and the second support bracket 544A having the respective side wall portions 932A, 942A disposed on the right side of the upper rail 532, the left support mechanism 540A allows the components of the support mechanism 540A to be offset so as not to interfere with the left cushion side frame 520. Further, the first support bracket 543A and the second support bracket 544A are arranged such that the respective base plate portions 931A, 941A are disposed to overlap each other and the respective side wall portions 932A, 942A are coupled to each other by the coupling pins 546A so as to keep the mutual distance constant. Due to these structures, the left support mechanism 540A can support the left side of the seat body from the position offset more to the right than the upper rail 532, with high support stiffness and with high strength.

The right support mechanism 540B is provided on the front end upper surface of the top plate portion 821 of the right upper rail 532. The right support mechanism 540B includes a support arm 541B, a support shaft 542B, a support bracket 543B, and a raising spring 545B.

The support bracket 543B includes a base plate portion 931B placed on and fixed to the front end upper surface of the top plate portion 821 of the right upper rail 532 and a pair of side wall portions 932B erected vertically from both left and right end portions of the base plate portion 931B. The support bracket 543B has an open cross-sectional shape that is open upward. The support bracket 543B is formed by press-working a single metal plate.

The base plate portion 931B of the support bracket 543B has a rectangular shape elongated in the front-rear direction and has a lateral width that is wider than the top plate portion 821 of the upper rail 532. The support bracket 543B is placed on the top plate portion 821 such that the top plate portion 821 is positioned at the center of the base plate portion 931B with respect to the left-right direction. The support bracket 543B is fixed to the upper rail 532 by fastening members such as multiple bolts penetrating through the base plate portion 931B and the top plate portion 821.

Each of the pair of side wall portions 932B has an upper end protruding in an arc shape such that the laterally central portion is the highest in side view. At the center of the arc-shaped protruding parts of the side wall portions 932B, circular holes for individually supporting the left and right end portions of the support shaft 542B are formed such that the circular holes penetrate through the respective arc-shaped protruding parts in the left-right direction.

The support arm 541B includes a base plate portion 911B and a pair of side wall portions 912B erected vertically from both left and right end portions of the base plate portion 911B, and has an open cross-sectional shape that is open upward. The support arm 541B is formed by press-working a single metal plate.

When the seat body is in the use position, the front end portion of the base plate portion 911B is inclined downward and the portion other than the front end portion is in a flat plate shape extending substantially horizontally. The lower flange 712 of the cushion side frame 521 is integrally formed with a mounting piece (not shown in the drawings) that extends laterally inward. The flat plate-shaped part of the base plate portion 911B is coupled to the mounting piece extending from the flange 712 at two positions in the front-rear direction by fastening members such as bolts.

The pair of side wall portions 912B each have an elongated rectangular shape in side view except for the front end portion, and the front end portion has a substantially arc shape in side view. At the center of the arc-shaped part of each side wall portion 912B, a circular hole in which the support shaft 542B is inserted is formed such that the circular hole penetrates through the arc-shaped part in the left-right direction.

The lateral width of the support arm 541B substantially matches the distance between the mutually opposing surfaces of the pair of side wall portions 932B of the support bracket 543B. The front end portion of the support arm 541B is stored between the pair of side wall portions 932B of the support bracket 543B, and the support bracket 543B and the support arm 541B are coupled to each other by the support shaft 542B. The support shaft 542B extends parallel to the left-right direction. The support arm 541B pivots about the support shaft 542B together with the right cushion side frame 521. Note that the support arm 541B may be pivotably supported by making the support shaft 542B pivotable relative to the support bracket 543B, or the support arm 541B may be pivotably supported on the support shaft 542B.

The raising spring 545B is a so-called torsion coil spring, and the coil part is supported by the support shaft 542B in an inserted manner. One end portion of the wire forming the raising spring 545B is coupled to the support bracket 543B and the other end portion of the same is coupled to the support arm 541B. The raising spring 545B applies an elastic force in a direction in which the pivoting end portion of the support arm 541B, namely, the rear end portion of the cushion frame 502 is raised upward.

On the front side of the raising spring 545B inside the support bracket 543B, a block member 546B for holding one end portion of the raising spring 545B is provided. This block member 546B also functions as a stopper which, when the rear end portion of the cushion frame 502 pivots upward due to the raising spring 545B, contacts the front end portion of the support arm 541B to restrict the upward pivot so that the angle shown in FIGS. 34 and 35 is not exceeded.

Further, a coupling frame 547 is suspended between the side wall portion 932A of the first support bracket 543A of the left support mechanism 540A and the left side wall portion 932B of the support bracket 543B of the right support mechanism 540B. The coupling frame 547 is a frame member which includes a top plate portion parallel to the left-right and front-rear directions and a pair of front and rear side plate portions parallel to the left-right and up-down directions and which has an open cross-sectional shape that is open downward. The coupling frame 547 extends along the left-right direction. The coupling frame 547 has plate-shaped protrusions at both left and right end portions, where the plate-shaped protrusions are formed by extending the top plate portion and the pair of side plate portions leftward and rightward. Further, the side wall portion 932A and the side wall portion 932B are respectively formed with slit-shaped openings in which the plate-shaped protrusions are inserted. The coupling frame 547 is assembled in a state in which the plate-shaped protrusions on the both end portions are respectively inserted in the openings of the side wall portion 942A and the side wall portion 932B. The plate-shaped protrusions of the coupling frame 547 may be joined to the side wall portion 942A and the side wall portion 932B by welding or the like. Since the coupling frame 547 couples the first support bracket 543A of the left support mechanism 540A and the support bracket 543B of the right support mechanism 540B to each other, the load of the seat body is distributed to and received by the support mechanisms 540A, 540B, whereby the seat body can be supported with high support strength.

In the support mechanism 504, the support shaft 542A of the left support mechanism 540A and the support shaft 542B of the right support mechanism 540B are coaxial to each other, and therefore, the seat body can be pivotably supported in a favorable manner. Also, due to the aforementioned pivoting, the support mechanism 504 allows the seat body to pivot within the range from the use position in which the person to be seated can be seated on the seat body to the movement position in which the rear end portion of the seat body is lifted up. The movement position of the seat body is a position in which the pivoting is restrained by the coupling pin 546A and the block member 546B described above. The use position of the seat body is a position retained by the retaining mechanism 505 described later. The support mechanism 504 is always urged by the raising spring 545B to pivot the seat body toward the movement position. The seat body is retained in the use position by the retaining mechanism 505, and when released by the retaining mechanism 505, can be switched to the movement position.

### [Retaining Mechanism]

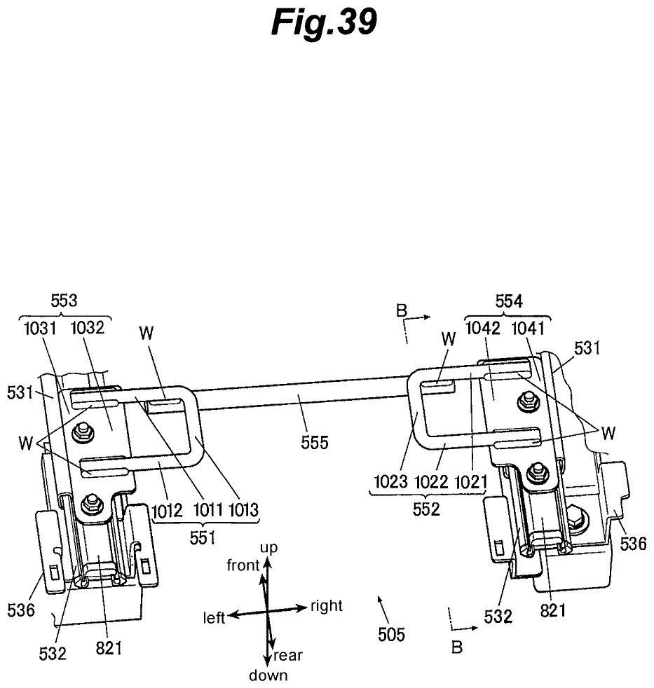

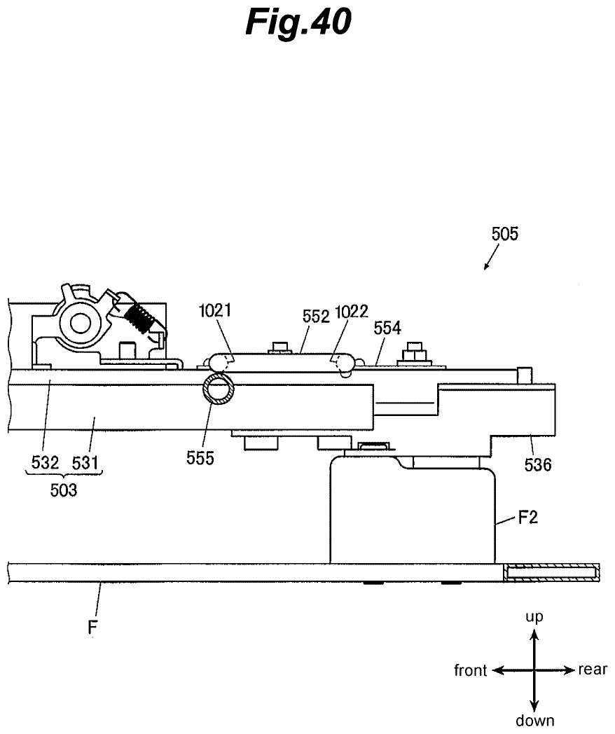

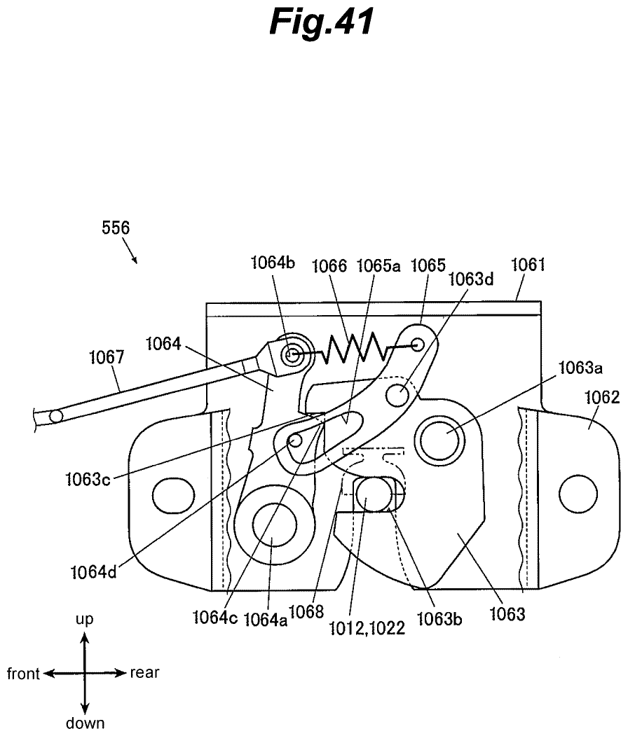

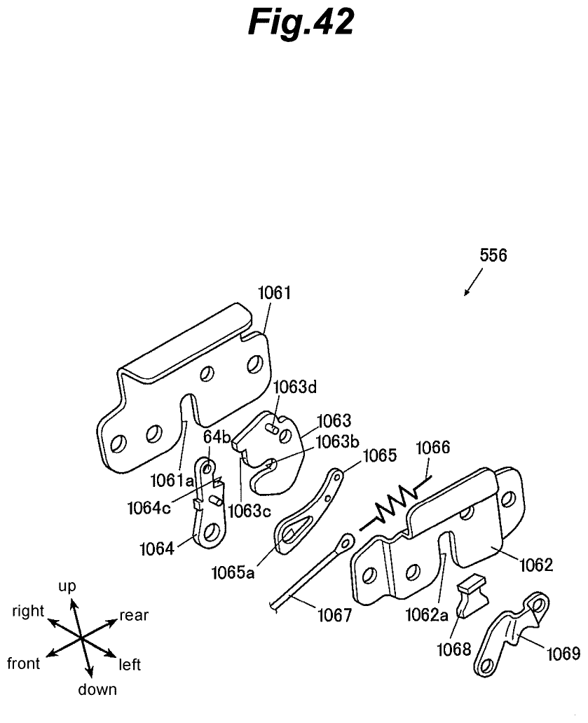

The retaining mechanism 505 includes left and right strikers 551, 552, left and right striker support brackets 553, 554, a coupling member 555, and left and right lock devices 556, 556. FIG. 39 is a perspective view of a part around the left and right strikers 551, 552, and FIG. 40 is a sectional view taken along line B-B in FIG. 39. Also, FIGS. 41 and 42 are a side view and an exploded perspective view of the lock device 556, respectively. In FIGS. 39 and 40, a reference sign W denotes a joint by welding or the like.

As shown in FIGS. 39 and 40, the left and right strikers 551, 552 are individually mounted, via the striker support brackets 553, 554, to parts in the vicinity of the rear ends of the upper surfaces of the top plate portions 821 of the left and right upper rails 532. Each of the left and right strikers 551, 552 is composed of a wire formed in a substantially U-shape and having a high stiffness.

The left striker 551 is disposed such that the U-shaped opening faces leftward, and one end portion 1011 and the other end portion 1012 of the wire, which extend toward the opening, are joined to the upper surface of the left striker support bracket 553 by welding or the like. Also, the striker 551 is supported such that a coupling part 1013 which corresponds to the bottom part of the U shape is disposed more to the right than (laterally inward of) the right end portion of the striker support bracket 553. Similarly, the right striker 552 is disposed such that the U-shaped opening faces leftward, and one end portion 1021 and the other end portion 1022 of the wire, which extend toward the opening, are joined to the upper surface of the right striker support bracket 554 by welding or the like. Also, the striker 552 is supported such that a coupling part 1023 which corresponds to the bottom part of the U shape is disposed more to the left than (laterally inward of) the left end portion of the striker support bracket 554. Thus, the left and right strikers 551, 552 have the coupling parts 1013, 1023 protruding in directions toward each other.

The striker 551, 552 are respectively disposed on the left and right upper rails 532, such that the one end portion 1011, 1021 and the other end portion 1012, 1022 of the wire are parallel to the left-right direction. Further, the one end portion 1011, 1021 and the other end portion 1012, 1022 of the wire of each striker 551, 552 are arranged one behind the other. The end portion 1012, 1022, which is positioned on the rear side, of the wire of each striker 551, 552 has a part extending more laterally inward than the striker support bracket 553, 554, and this part is held and released by the corresponding lock device 556, 556.

The left and right striker support brackets 553, 554 are each formed of a single flat metal plate. Each of the left and right striker support brackets 553, 554 has a placement part 1031, 1041 placed on the top plate portion 821 of the upper rail 532 and an extension part 1032, 1042 extending laterally inward from the placement part 1031, 1041. The placement part 1031, 1041 of each of the left and right striker support brackets 553, 554 is somewhat longer than the extension part 1032, 1042 in the front-rear direction. For example, the rear end of the placement part 1031, 1041 extends more rearward than the extension part 1032, 1042.

The one end portion 1011, 1021 and the other end portion 1012, 1022 of the wire of each of the left and right strikers 551, 552 extend across the placement part 1031, 1041 and the extension part 1032, 1042 of the striker support bracket 553, 554 and are placed on the upper surface thereof. Further, substantially entire parts of the one end portion 1011, 1021 and the other end portion 1012, 1022 of the wire of each of the left and right strikers 551, 552 that overlap with the striker support bracket 553, 554 as seen in the plan view are joined to the striker support bracket by welding or the like. With the substantially the entire parts overlapping with the striker support bracket 553, 554 being joined, each striker 551, 552 is joined to the striker support bracket 553, 554 with high strength and has high support strength against the load received from the seat body.

Each of the left and right striker support brackets 553, 554 is fixed, at the placement part 1031, 1041 thereof, to the top plate portion 821 of each upper rail 532 by fastening members such as two bolts arranged to interpose the rear-side end portion 1012, 1022 of the striker 551, 552 in the front-rear direction. The part of each of the left and right striker support brackets 553, 554 corresponding to the end portion 1012, 1022 configured to engage with each lock device 556, 556 is particularly likely to receive the load of the seat body, and the striker support bracket 553, 554 is fixed to the upper rail 532 by two fastening members arranged to sandwich the end portion 1012, 1022. Thereby, each of the left and right striker support brackets 553, 554 has high support strength against the load received from the seat body.

The coupling member 555 extends in the left-right direction and couples the left and right strikers 551, 552 to each other. Specifically, an upper portion of the outer circumference of the left end portion of the coupling member 555 is joined by welding or the like to a lower portion of the outer circumference of a part of the front-side end portion 1011 of the left striker 551 that extends more rightward than the right end portion of the striker support bracket 553. Further, an upper portion of the outer circumference of the right end portion of the coupling member 555 is joined by welding or the like to a lower portion of the outer circumference of a part of the front-side end portion 1021 of the right striker 552 that extends more leftward than the left end portion of the striker support bracket 554.

The coupling member 555 consists of a pipe member having a circular closed cross-sectional shape. The left and right strikers 551, 552 are supported by the respective striker support brackets 553, 554 in a cantilever manner. By coupling them with the coupling member 555, the left and right strikers 551, 552 are united to be brought into a both-end supported state, whereby the load can be distributed to left and right so that it is possible to support the load from the seat body with high strength. Also, since the coupling member 555 has a closed cross-sectional shape, the bending stiffness is high and the deformation can be suppressed, whereby the support strength of the left and right strikers 551, 552 can be maintained high. Note that the cross-sectional shape of the coupling member 555 is not limited to circular, and may be other shapes such as polygonal. Note, however, in the case of the circular closed cross-sectional shape, bending deformation can be effectively suppressed against a load from any direction, and this is preferred.

The coupling member 555 is joined to the lower portion of the outer circumference of the end portion 1011, 1021 of each of the left and right strikers 551, 552, but may be joined to the front portion of the outer circumference or the upper portion of the outer circumference of the end portion 1011, 1021 so long as it does not interfere with the surrounding configuration. In the case where the coupling member 555 is joined to the front portion of the outer circumference of each end portion 1011, 1021, the striker support brackets 553, 554 may be configured to extend more forward and the coupling member 555 may be configured to extend longer in the left-right direction to be also joined to the upper surfaces of the striker support brackets 553, 554. Thereby, the support strength of the left and right strikers 551, 552 can be further enhanced.

The left and right lock devices 556, 556 are supported by the pipe frame 526 in the rear portion of the cushion frame 502 via respective mounting brackets 557, 558 in a depending manner. The left and right mounting brackets 557, 558 are disposed in positions where they can respectively hold the rear-side end portions 1012, 1022 of the left and right strikers 551, 552 from directly above when the seat body is in the use position. Each of the left and right mounting brackets 557, 558 has an open cross-sectional shape as seen from above, and includes a mounting surface part for the lock device 556 extending along the front-rear and up-down directions and flanges erected laterally from the front end portion and the rear end portion of the mounting surface part. The left and right mounting brackets 557, 558 are each formed by press-working a single metal plate. Also, the left and right mounting brackets 557, 558 are mounted to the pipe frame 526 such that their open sides face each other. The front and rear flanges of the left and right mounting brackets 557, 558 extend more upward than the mounting surface part, and the inner surfaces of the upward extension parts are joined to the outer peripheral surface of the pipe frame 526 by welding or the like.

Since the left and right lock devices 556, 556 have the same structure, one lock device 556 will be described. As shown in FIGS. 41 and 42, the lock device 556 includes a support plate 1061, a cover body 1062, a latch member 1063, a rachet member 1064, a lever member 1065, a spring 1066, a release lever 1067, a load receiving member 1068, and a fixing bracket 1069.

The support plate 1061 is formed of a flat metal plate that extends along the front-rear and up-down directions in the state in which the lock device 556 is supported by the mounting bracket 557 or 558. The support plate 1061 has a substantially rectangular shape in side view, and the front end portion and the rear end portion thereof are provided with mounting arms extending forward and rearward, respectively. The front and rear mounting arms are provided with through holes, in which fastening members such as bolts not shown in the drawings are inserted so that the mounting arms are mounted to a lower end portion of the mounting surface part of the mounting bracket 557 or 558.

An upper end portion of the support plate 1061 is formed with a flange erected leftward by bending. At a middle part in the front-rear direction of a lower end portion of the support plate 1061, an upward notch 1061a is formed. The end portion 1012 or 1022 of the striker 551 or 552 is inserted from below in this notch 1061a, and is held in the bottom of the notch 1061a.

The cover body 1062 is formed of a flat metal plate that extends along the front-rear and up-down directions in the state in which the lock device 556 is supported by the mounting bracket 557 or 558. The cover body 1062 has a substantially rectangular shape in side view and includes side wall portions erected rightward from the front end portion and the rear end portion thereof, respectively. From the right ends of the side wall portions, mounting arms extend forward and rearward, respectively. The front and rear mounting arms of the cover body 1062 can overlap with the front and rear mounting arms of the support plate 1061, and the front and rear mounting arms of the cover body 1062 are also formed with through holes through which the fastening members can be inserted. Thus, by disposing the cover body 1062 on the left side of the support plate 1061 and inserting the fastening members in the respective through holes in the state in which the front and rear mounting arms of the support plate 1061 overlap with the front and rear mounting arms of the cover body 1062, these can be mounted to the lower end portion of the mounting surface part of the mounting bracket 557 or 558 in the overlapping state. Also, since the cover body 1062 has the front and rear side wall portions, a gap can be formed between the support plate 1061 and the cover body 1062 according to the length of the side wall portions, and the components of the lock device 556 can be disposed therein.

An upper end portion of the cover body 1062 is formed with a flange that is erected leftward by bending and whose left tip end portion is further bent to extend upward. The upper end of the flange of the cover body 1062 contacts the lower surface of the flange of the support plate 1061. At a middle part in the front-rear direction of a lower end portion of the cover body 1062, an upward notch 1062a is formed. This notch 1062a is provided in a position that is aligned with the notch 1061a of the support plate 1061 as seen in the left-right direction, and the width and the depth thereof also match those of the notch 1061a of the support plate 1061. The end portion 1012 or 1022 of the striker 551 or 552 is inserted in the notch 1061a of the support plate 1061 and the notch 1062a of the cover body 1062 simultaneously from below. Then, the end portion 1012 or 1022 of the striker 551 or 552 is held due to the components of the lock device 556 disposed between the support plate 1061 and the cover body 1062.

FIG. 41 shows a locked state in which the lock device 556 holds the end portion 1012 or 1022 of the striker 551 or 552. The latch member 1063 is pivotably supported by a laterally extending support shaft 1063a between the support plate 1061 and the cover body 1062. The latch member 1063 is formed with a notch 1063b that can be caused to overlap with the notches 1061a, 1062a of the support plate 1061 and the cover body 1062 by pivoting. When the notch 1063b of the latch member 1063 faces downward, the end portion 1012 or 1022 of the striker 551 or 552 can be inserted therein. Then, when the latch member 1063 pivots clockwise in FIG. 41 and the notch 1063b faces forward, the locked state in which the end portion 1012 or 1022 of the striker 551 or 552 is held is achieved.

A part above the notch 1063b of the latch member 1063 in the locked state posture is provided with a recess 1063c which is engaged by an engagement protrusion 1064c of the rachet member 1064. Further, an upper end portion of the latch member 1063 in the locked state posture is provided with a support protrusion 1063d for pivotably supporting the lever member 1065. The support protrusion 1063d protrudes leftward.

The rachet member 1064 is disposed adjacent to and in front of the latch member 1063 and a lower end portion thereof is pivotably supported by a support shaft 1064a extending in the left-right direction. An upper end portion of the rachet member 1064 is formed with a through hole 1064b to which the front end portion of the spring 1066 is connected, and is urged toward the latch member 1063 by a tensile force of the spring 1066. Also, together with the spring 1066, a rear end portion of the release lever 1067 is connected to the upper end portion of the rachet member 1064. The release lever 1067 extends forward from the upper end portion of the rachet member 1064, and receives a release operation of manually pulling forward a front end portion of the release lever 1067 not shown in the drawings.

A middle portion of the rachet member 1064 in the up-down direction is formed with an engagement protrusion 1064c that protrudes rearward. This engagement protrusion 1064c is urged by the spring 1066 in a direction to intrude into the recess 1063c of the latch member 1063 and, so long as the intrusion state is maintained, restricts the pivoting of the latch member 1063 in the direction to release the locked state (counterclockwise in FIG. 41). Further, in the vicinity of the engagement protrusion 1064c of the rachet member 1064, an interlocking protrusion 1064d for adding rotation to the lever member 1065 is provided. The interlocking protrusion 1064d protrudes leftward.

The lever member 1065 is pivotably supported by the support protrusion 1063d of the latch member 1063 as mentioned above. The lever member 1065 has one end portion extending upward and connected to the rear end portion of the spring 1066 mentioned above. The other end portion of the lever member 1065 extends forward in a curved manner. The other end portion of the lever member 1065 is formed with an elongated hole 1065a, in which the interlocking protrusion 1064d of the rachet member 1064 is loosely inserted. When the rachet member 1064 pivots such that the upper end portion moves forward, the interlocking protrusion 1064d slides along the upper inner edge of the elongated hole 1065a of the lever member 1065 and causes the lever member 1065 to pivot in the direction opposite from the rachet member 1064.

The load receiving member 1068 is mounted on the left surface of the cover body 1062 by the fixing bracket 1069. The load receiving member 1068 is supported by the fixing bracket 1069 to be slightly movable up and down in an arrangement in which the lower end portion thereof is positioned somewhat lower than the bottom of the notch 1062a of the cover body 1062. Further, the arrangement is set such that when the load receiving member 1068 is moved upward, the upper end thereof contacts the lower surface of the flange of the cover body 1062. Therefore, when the end portion 1012 or 1022 of the striker 551 or 552 is inserted into the notch 1062a, the end portion 1012 or 1022 comes into contact with the lower end portion of the load receiving member 1068, and the upper end portion of the load receiving member 1068 comes into contact with the lower surface of the flange of the cover body 1062. Since the upper end portion of the flange of the cover body 1062 is in contact with the lower surface of the flange of the support plate 1061, the collision load from the end portion 1012 or 1022 is transmitted to the entirety of the cover body 1062 and the support plate 1061 through the load receiving member 1068, whereby it is possible to distribute the load.

Now, description will be made of an unlock operation and a lock operation of the lock device 556 having the above-described configuration. As mentioned above, FIG. 41 shows a state in which the lock device 556 locks the end portion 1012 or 1022 of the striker 551 or 552. In this state, if the release lever 1067 is pulled forward, the upper end portion of the rachet member 1064 pivots forward, and the engagement protrusion 1064c is pulled out of the recess 1063c of the latch member 1063. Thereby, the latch member 1063 becomes able to pivot in the direction to make the notch 1063b face downward. On the other hand, the pivoting of the rachet member 1064 causes, via the interlocking protrusion 1064d, the lever member 1065 to pivot in the direction opposite from the rachet member 1064. Accordingly, the upper end portion of the rachet member 1064 and the upper end portion of the lever member 1065 move away from each other, and the spring 1066 is expanded to store energy.

When the lever member 1065 pivots in the aforementioned direction, the latch member 1063 is urged by the tensile force of the spring 1066 via the support protrusion 1063d to pivot in the same direction as the pivoting of the rachet member 1064 (counterclockwise in FIG. 41). Consequently, when the upper end portion of the rachet member 1064 is pulled out of the recess 1063c and the restricted state is released, the latch member 1063 pivots to the state in which the notch 1063b faces downward. In this way, the lock device 556 can be brought into the unlock state in which the end portion 1012 or 1022 of the striker 551 or 552 can be pulled out downward.

If the pulling of the release lever 1067 is stopped in this state, the outer edge of a part of the engagement protrusion 1064c lower than the rachet member 1064 contacts the flat outer edge at the upper end of the latch member 1063 in FIG. 41 with spring pressure, whereby the state in which the notch 1063b of the latch member 1063 faces downward can be held.

On the other hand, to achieve the locked state, the rear end portion of the cushion frame 502 is caused to pivot downward, so that the end portion 1012 or 1022 of the striker 551 or 552 is pushed into the notches 1061a, 1062a of the support plate 1061 and the cover body 1062 and the notch 1063b of the latch member 1063. Thereby, against the tensile force of the spring 1066, the latch member 1063 pivots clockwise in FIG. 41, and when the end portion 1012 or 1022 of the striker 551 or 552 reaches the vicinity of the bottom of the notches 1061a, 1062a, the engagement protrusion 1064c of the rachet member 1064 enters the recess 1063c of the latch member 1063, so that the pivoting is restricted in the state in which the notch 1063b of the latch member 1063 faces forward. Thereby, the locked state in which the end portion 1012 or 1022 of the striker 551 or 552 cannot move downward from the notches 1061a, 1062a of the support plate 1061 and the cover body 1062.

### [Operation of Vehicle Seat]

In the vehicle seat 501 having the above-described configuration, when the left and right lock devices 556 are operated to release the locked state of the left and right strikers 551, 552 in the state in which the seat body is the use position, the cushion frame 502 urged by the raising spring 545B of the support mechanism 504 pivots in the direction in which the rear end portion of the seat cushion is lifted up, so that the vehicle seat 501 takes the forward leaning posture as the movement position. At this time, if the operation lever 534 of the rail device 503 is operated to release the restraining state by the restraining members 533, the entire seat body can be moved forward. Thereby, the vehicle seat 501 can retreat forward to secure a wide space behind the vehicle seat 501. For example, in a case where there is another vehicle seat disposed just behind the vehicle seat 501, it is possible to easily get on and off this another vehicle seat. Also, in a case where there is a luggage placement space just behind the vehicle seat 501, it is possible to easily put the luggage in and out of the placement space.

When the vehicle seat 501 is to be returned to the original state, the seat body is returned to the original position by the rail device 503, and the operation lever 534 is operated to return the restraining members 533 to the restraining state. Further, when the rear end portion of the seat cushion is pushed down against the raising spring 545B, the end portions 1012, 1022 of the left and right strikers 551, 552 enter the notches 1061a, 1062a of the left and right lock devices 556 and are held by the respective latch members 1063, so that the seat body is held in the use position.

Note that the rail device 503 may be provided with a spring or the like to always urge, with spring pressure, the seat body in the direction to move forward, and the release operation of the left and right lock devices 556 and the release operation of the locked state by the restraining members 533 of the rail device 503 may be interlocked by a wire or the like. Thereby, upon performance of the release operation of the lock devices 556 or the release operation of the locked state by the restraining members 533, pivoting of the seat body to the forward leaning posture and forward movement of the seat body can be performed simultaneously.

### [Manufacturing Method for Vehicle Seat]

Here, a manufacturing method for the above-described vehicle seat 501 will be described in process order. The manufacturing method includes a step of preparing the pair of lower rails 531 to be fixed on the floor member F serving as the floor of the vehicle, a step of preparing the pair of upper rails 532, a step of preparing the left and right lock devices 556, 556, a step of preparing the pair of strikers 551, 552 to be engaged by and released from the left and right lock devices 556, 556, a step of providing the pair of strikers 551, 552 on the pair of upper rails 532 so as to extend in directions toward each other, and a step of coupling the pair of strikers 551, 552 to each other by the coupling member 555.

Each of the left and right lower rails 531 prepared in the step of preparing the lower rails 531 is mounted to the floor member F with the front and rear mounting brackets 535, 536. This step of mounting the lower rails 531 may be performed before the step of coupling the strikers 551, 552 to each other by the coupling member 555.

The left and right upper rails 532 prepared by the step of preparing the upper rails 532 are respectively fitted to the left and right lower rails 531 by inserting them through one end portions of the respective lower rails 531. This fitting step of the upper rails 532 may be performed before or after the mounting step of the lower rails 531.

In the step of providing the pair of strikers 551, 552 on the pair of upper rails 532, the strikers 551, 552 are respectively provided on the upper rails 532 via the respective striker support brackets 553, 554.

After the fitting process of the upper rails 532, a step of mounting the restraining member 533 and the operation lever 534 on each upper rail 532, a step of mounting the support mechanisms 540A, 540B to the respective upper rails 532, etc. are performed. Further, after the step of mounting the support mechanisms 540A, 540B, a step of mounting the seat frame including the cushion frame 502 to the support mechanisms 540A, 540B, a step of mounting the left and right lock devices 556 to the cushion frame 502, etc. are performed. Further, a step of attaching the cushion pad and the cover is performed before or after the step of mounting the seat frame.

### Technical Effects of the Embodiment of the Invention

In the vehicle seat 501 described above, the strikers 551, 552 are provided as a pair on both sides in the left-right direction of the cushion frame 502, and the pair of strikers 551, 552 extend inward in the left-right direction and are coupled to each other by the coupling member 555. Therefore, the load received from the seat body can be distributed to the two strikers 551, 552, and the support stiffness of the strikers 551, 552 can be improved with a simple configuration. Further, though the strikers 551, 552 are individually supported on the left and right upper rails 532 in a cantilever manner, the left and right strikers 551, 552 are united by the coupling member 555 to be brought into a both-end supported state, and thus, the support stiffness can be further improved.

Further, since the coupling member 555 is configured as a separate member from the strikers 551, 552, it is possible to use the existing strikers 551, 552. Also, during attachment of the coupling member 555, it is easy to adjust the arrangement and the assembly can be carried out easily. Further, this is advantageous in securing an attachment space of the coupling member 555.

Further, since the coupling member 555 has a closed cross-sectional shape, the coupling member 555 itself has a high stiffness, and it is possible to effectively improve the support stiffness of the left and right strikers 551, 552. Also, the coupling member 555 enables weight reduction.

Further, since the coupling member 555 has a cylindrical shape, it has a high stiffness in any radial direction, and it is possible to further improve the support stiffness of the left and right strikers 551, 552.

Further, the pair of strikers 551, 552 are respectively provided on the left and right upper rails via the striker support brackets 553, 554 each of which supports a part of the corresponding striker in the extension direction, and thus, compared to the case where the strikers 551, 552 are directly joined to the upper rails 532, it is easy to optimize the joining method and the shape, whereby it is possible to further improve the support stiffness of the strikers 551, 552.

### Other Examples of Retaining Mechanism

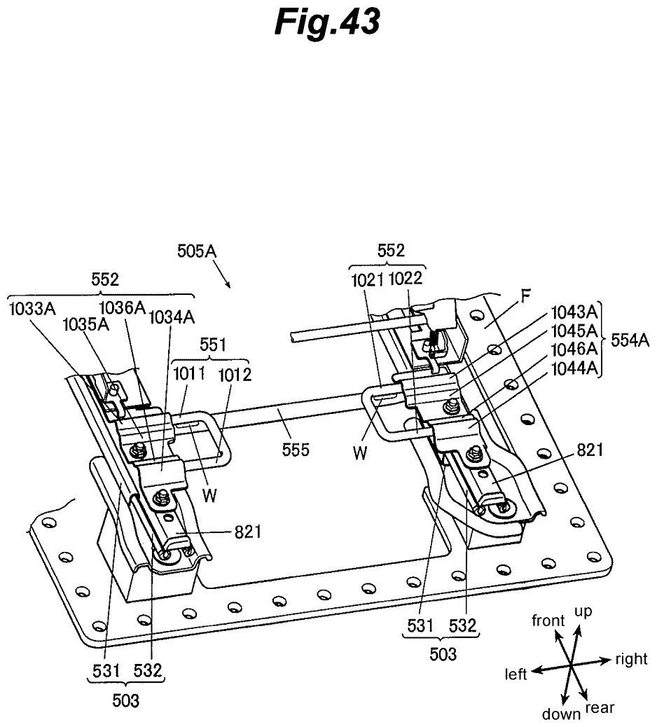

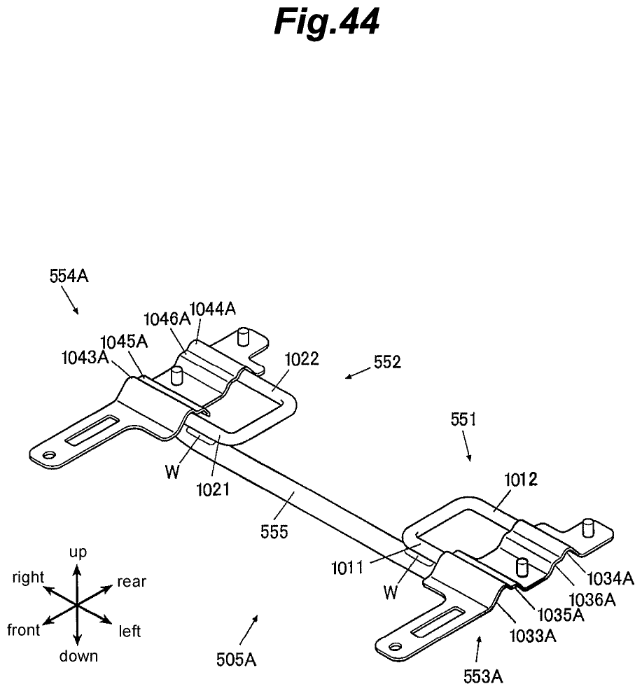

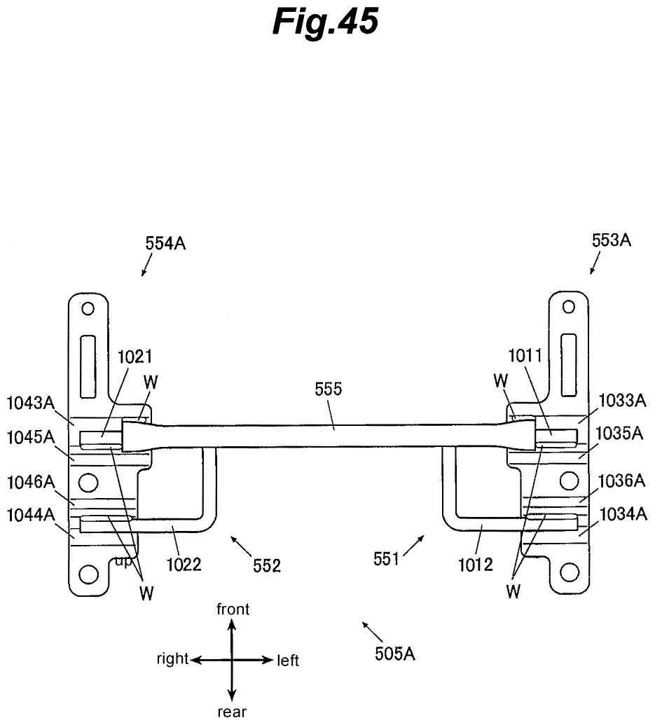

An embodiment in which the strikers 551, 552 are joined to the upper surfaces of the striker support brackets 553, 554 has been exemplarily shown, but the present invention is not limited to this. FIG. 43 is a perspective view showing a retaining mechanism 505A as another example in which the support structure for the strikers 551, 552 is different, FIG. 44 is a perspective view showing the strikers 551, 552 and other striker support brackets 553A, 554A, and FIG. 45 is a bottom view of the same. In FIGS. 43 to 45, the reference sign W denotes a joint by welding or the like.

As seen in the retaining mechanism 505A shown in FIG. 43, the left and right strikers 551, 552 may be disposed on the side of the lower surfaces of left and right striker support brackets 553A, 554A and between the respective striker support brackets 553A, 554A and the upper surfaces of the top plate portions 821 of the respective upper rails 532. The left striker support bracket 553A is formed on the plate surface thereof with two raised parts 1033A, 1034A each consisting of a strip-shaped protrusion extending along the left-right direction such that the two raised parts 1033A, 1034A are arranged one behind the other. The front raised part 1033A is provided with a strip-shaped protrusion 1035A having a lower protrusion height to be connected to the rear side thereof. Similarly, the rear raised part 1034A is provided with a strip-shaped protrusion 1036A having a lower protrusion height on the front side thereof. The right striker support bracket 554A is formed on the plate surface thereof with two raised parts 1043A, 1044A each consisting of a strip-shaped protrusion extending along the left-right direction such that the raised parts 1043A, 1044A are arranged one behind the other. The front raised part 1043A is provided with a strip-shaped protrusion 1045A having a lower protrusion height to be connected to the rear side thereof. Similarly, the rear raised part 1044A is provided with a strip-shaped protrusion 1046A having a lower protrusion height on the front side thereof. The strip-shaped protrusions 1035A, 1036A, 1045A, 1046A increase the stiffness of the raised parts 1033A, 1034A, 1043A, 1044A due to the uneven surface structure provided thereby.

As shown in FIG. 45, the end portions 1011, 1012 of the left striker 551 are respectively joined to the lower surfaces of the raised parts 1033A, 1034A of the striker support bracket 553A. As shown in FIG. 45, the end portions 1012, 1022 of the right striker 552 are respectively joined to the lower surfaces of the raised parts 1043A, 1044A of the striker support bracket 554A.

Also, as shown in FIG. 44, parts of the coupling member 555 in the vicinity of the left and right ends thereof are respectively joined by welding or the like to the lower sides of the outer circumferences of the front-side end portions 1011, 1021 of the left and right strikers 551, 552. Further, the tips of the left and right end portions of the coupling member 555 respectively extend to the lower sides of the striker support brackets 553A, 554A. The tip of the left end portion of the coupling member 555 is compressed flat and is interposed between the end portion 1011 of the striker 551 and the top plate portion 821 of the upper rail 532 inside the raised part 1033A of the striker support bracket 553A. Similarly, the tip of the right end portion of the coupling member 555 is compressed flat and is interposed between the end portion 1021 of the striker 551 and the top plate portion 821 of the upper rail 532 inside the raised part 1043A of the striker support bracket 554A. As shown in FIG. 45, the left and right end portions of the coupling member 555 are also joined by welding or the like to the lower surfaces of the raised parts 1033A, 1043A of the striker support brackets 553A, 554A, respectively.

In this way, the strikers 551, 552 are disposed between the respective striker support brackets 553A, 554A and the respective upper rails 532, whereby movement or deformation of the end portions 1011, 1021 in the direction away from the striker support brackets 553A, 554A, and detachment of joints is suppressed. Thus, the support strength of the strikers 551, 552 can be improved. Further, the coupling member 555 is joined not only to the strikers 551, 552 but also to the striker support brackets 553A, 554A, and therefore, it is possible to couple the left and right strikers 551, 552 to each other with high strength and to further improve the support stiffness of the left and right strikers 551, 552.

Regarding the manufacturing method of the vehicle seat 501 provided with the retaining mechanism 505A shown in FIG. 43 to FIG. 45, in the step of providing the pair of strikers 551, 552 on the pair of upper rails 532, the pair of strikers 551, 552 are joined by welding to the lower sides of the raised parts 1033A, 1043A provided in the respective striker support brackets 553A, 554A. Also, in the step of coupling the pair of strikers 551, 552 to each other by the coupling member 555, the coupling member 555 is also joined by welding or the like to the pair of striker support brackets 553A, 554A.

### [Solution 1]

A manufacturing method for a vehicle seat in which a seat body including a seatback serving as a backrest and a seat cushion serving as a seating part can be switched between a use position in which a person to be seated can be seated on the seat body and a movement position that is moved from the use position, the manufacturing method comprising: a step of preparing a pair of lower rails to be fixed to a floor of a vehicle; a step of preparing a pair of upper rails to be movably supported by the lower rails; a step of preparing a lock device to be provided on the seat body for switching between the use position and the movement position; a step of preparing a pair of strikers to be provided on a side of the upper rails to be engaged with and released from the lock devices when switching between the use position and the movement position; a step of providing the pair of strikers on the pair of upper rails so as to extend in directions toward each other; and a step of coupling the pair of strikers to each other by the coupling member.

Since Solution 1 includes a step of coupling the pair of strikers to each other by the coupling member, a vehicle seat in which the pair of strikers are in a both-end supported state and have high support stiffness can be favorably manufactured.

### [Solution 2]

The manufacturing method for a vehicle seat according to Solution 1, wherein in the step of providing the pair of strikers on the pair of upper rails, each of the strikers is provided on the upper rail via a striker support bracket.

In Solution 2, since each striker is provided on the upper rail via the striker support bracket, a vehicle seat in which the support stiffness of the pair of strikers is high can be favorably manufactured.

### [Solution 3]

The manufacturing method for a vehicle seat according to Solution 2, wherein in the step of coupling the pair of strikers to each other by the coupling member, the coupling member is also joined to the pair of striker support brackets.

In Solution 3, since the coupling member is also joined to the pair of striker support brackets, a vehicle seat in which the support stiffness of the pair of strikers is high can be favorably manufactured.

### [Solution 4]

The manufacturing method for a vehicle seat according to Solution 2, wherein in the step of providing the pair of strikers on the pair of upper rails, the pair of strikers are joined to lower sides of raised parts provided in the respective striker support brackets.

In Solution 4, since the pair of strikers are joined to the lower sides of the raised parts provided in the respective striker support brackets, a vehicle seat in which the support stiffness of the pair of strikers is high can be favorably manufactured.

### LIST OF REFERENCE NUMERALS

3A: right side sill
3B: left side sill
4: central member
7: cross member
9: floor
9A: upper floor panel
9B: lower floor panel
11: recessed groove
12A: right battery
12B: left battery
23A: right battery connection part
23B: left battery connection part
23C: central battery connection part
29: hook
41: seat
42: console box (article)
51: seat support part
52: first rail
53 first slider
61: article support part
62: second rail
63: second slider

1. A seat mounting structure, comprising:
a right side sill and a left side sill that extend in a front-rear direction;
a central member extending in the front-rear direction between the right side sill and the left side sill;
a plurality of cross members provided to be spaced from each other in the front-rear direction and each extending laterally and joined to the central member, the right side sill, and the left side sill;
a floor provided on the central member and the plurality of cross members and joined to the right side sill and the left side sill;
a plurality of right battery connection parts joined to the right side sill;
a plurality of left battery connection parts joined to the left side sill;
a plurality of central battery connection parts joined to the central member;
a plurality of right batteries extending laterally and joined to the right battery connection parts and the central battery connection parts;
a plurality of left batteries extending laterally and joined to the left battery connection parts and the central battery connection parts; and
a seat mounted on an upper surface of the floor via a seat support part,
wherein the seat support part is provided between the right battery connection parts and the central battery connection parts or between the left battery connection parts and the central battery connection parts.

2. The seat mounting structure according to claim 1, wherein the seat support part comprises a first rail joined to the floor and a first slider slidably supported by the first rail and joined to the seat, and
the first rail crosses at least three of the cross members.

3. The seat mounting structure according to claim 2, wherein the first rail is received in a recessed groove provided on the floor and extending in the front-rear direction.

4. The seat mounting structure according to claim 3, wherein the floor comprises a lower floor panel extending along a bottom portion of the recessed groove and an upper floor panel extending along an upper portion of the recessed groove.

5. The seat mounting structure according to claim 1, wherein at least one of left and right end portions of the seat is disposed above the plurality of right battery connection parts or the plurality of central battery connection parts.

6. The seat mounting structure according to claim 1, wherein a front end portion of the seat support part is disposed more rearward than front end portions of the right batteries and the left batteries.

7. The seat mounting structure according to claim 1, wherein the right battery connection parts, the left battery connection parts, and the central battery connection parts comprise hooks for supporting the right batteries and the left batteries.

8. The seat mounting structure according to claim 1, wherein an article is mounted on the floor via a pair of article support parts,
the pair of article support parts are respectively disposed on both sides of the plurality of central battery connection parts with respect to a left-right direction, and
one of the article support parts is provided between the seat support part and the plurality of central battery connection parts with respect to the left-right direction.

9. The seat mounting structure according to claim 8, wherein the pair of article support parts each include a second rail joined to the floor and a second slider slidably supported by the second rail and joined to the article, and
the second rail crosses at least three of the cross members.

10. The seat mounting structure according to claim 8, wherein each of front end portions of the pair of article support parts is disposed more rearward than front end portions of the right batteries and the left batteries.
